(19) United States
(12) Patent Application Publication
(10) Pub. No.: US 2008/0252527 A1
(43) Pub. Date: Oct. 16, 2008

(54) Method and apparatus for acquiring local position and overlaying information

(76) Inventor: Juan Carlos Garcia, Philadelphia, PA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/080,662

(22) Filed: Apr. 3, 2008

Related U.S. Application Data
(60) Provisional application No. 60/909,726, filed on Apr. 3, 2007.
(60) Provisional application No. 61/020,840, filed on Jan. 14, 2008.

(51) Int. Cl. G01S 5/02

(52) U.S. Cl. 342/450

(57) ABSTRACT

A method and system for determining relative position information among at least a subset of a plurality of devices and objects is disclosed. The relative position information is based on at least one of sensor data and respective information attributes corresponding to the plurality of devices and objects.

### CROSS-REFERENCE TO RELATED APPLICATIONS

This application claims priority from U.S. Provisional Patent Application No. 60/909,726 filed Apr. 3, 2007, titled Sphere of Influence System and Methods by inventor Juan Carlos Garcia. This provisional application is incorporate herein by reference in its entirety.

### FIELD

The present specification relates generally to acquiring relative position of objects and more specifically acquiring relative position information including but not limited to object attributes.

### BACKGROUND

Methods for these types of positioning reference applications can generally be classified according to the methodologies of position acquisition. The majority of today's location based systems utilize Global Positioning System (GPS) technology and a wide area network integrating backend map server services. GPS requires a minimum of three Medium Earth Orbit satellites to provide approximate latitude and longitude of a remote transceiver.

### DESCRIPTION OF DRAWINGS

For a better understanding of the embodiments, reference should be made to the following detailed description taken in conjunction with the accompanying drawings, in which:

FIG. 1 illustrates a high level processing overview block diagram according to some embodiments;

FIG. 2 illustrates a block diagram of the object managed local information according to some embodiments;

FIG. 3 illustrates a block diagram of the object managed remote information according to some embodiments;

FIG. 4 illustrates a block diagram of the mobile device managed remote information according to some embodiments;

FIG. 5 illustrates a block diagram of the object managed local and remote information according to some embodiments;

FIG. 6 illustrates a block diagram of both the object managed local information and mobile device managed remote information according to some embodiments;

FIG. 7 illustrates a block diagram of both the object managed local/remote information and mobile device managed remote information according to some embodiments;

FIG. 8 illustrates a block diagram of components providing relative position and orientation according to some embodiments;

FIG. 9 illustrates a block diagram of positioning process according to some embodiments;

FIG. 10 illustrates a perspective view of a 5-nodes network with 2 blockages between pairs of nodes according to some embodiments;

FIG. 11 shows a synthesizing sensor error compensation method according to some embodiments;

FIG. 12 illustrates a block diagram of process flow in positioning two-nodes network according to some embodiments;

FIG. 13 illustrates a walking pattern showed by motion sensor according to some embodiments;

FIG. 14 illustrates a circle intersection representation of positioning when two moving objects are present according to some embodiments;

FIG. 15 illustrates a trigonometry representation of transformed positioning problem according to some embodiments;

FIG. 16 depicts the four possible walking vectors computed by new and old circle intersections of two moving objects according to some embodiments;

FIG. 17 illustrates a block diagram of process flow in positioning multi-nodes networks according to some embodiments;

FIG. 18 illustrates a set up of pseudo coordinate system from ranges of 5 nodes according to some embodiments;

FIG. 19 illustrates the comparison of moving vector between pseudo and real coordinate system according to some embodiments;

FIG. 20 illustrates the elimination of wrong topology by comparing moving directions according to some embodiments;

FIG. 21 illustrates an overview for processing different sensor types according to some embodiments;

FIG. 22 illustrates a block diagram of process flow to determine and display friends relationships according to some embodiments;

FIG. 23 shows directionality routing provided by Spotcast when navigating through two perpendicular hallways according to some embodiments;

FIG. 24 illustrates an example of track file database according to some embodiments;

FIG. 25 illustrates a 2-d view of user display according to some embodiments;

FIG. 26 illustrates a 3-d view of user display according to some embodiments;

FIG. 27 illustrates a view of common friends relationships on user interface according to some embodiments;

FIG. 28 illustrates a view of relationships and range only display within AOI according to some embodiments;

FIG. 29 illustrates a display of relative positions of nearby objects on mobile device according to some embodiments;

FIG. 30 illustrates the new oriented display of relative positions of nearby objects on mobile device after rotating the device according to some embodiments;

FIG. 31 illustrates a display of personal information profile and privacy setting according to some embodiments;

FIG. 32 illustrates a display of tagged object information profile and privacy setting according to some embodiments;

FIG. 33 illustrates a block diagram of current implementation of PixieEngine according to some embodiments;

FIG. 34 shows an implementation designed to integrate with existing devices over the Bluetooth wireless connection according to some embodiments;

FIG. 35 illustrates a view of communication between mobile device and the PixieEngine according to some embodiments;

FIG. 36 illustrates a demonstration of physically attaching the Stick-on to existing mobile devices according to some embodiments;

FIG. 37 illustrates a front and back view of mounted stick-on device according to some embodiments;

FIG. 38 illustrates a view of communication between two PixieEngines attached to mobile devices according to some embodiments;

FIG. 39 shows how the system implements both local peer-to-peer mesh network and a wide area network according to some embodiments;

FIG. 40 illustrates an example of information Spotcast according to some embodiments;

FIG. 41 illustrates an example of Spotcast provided information shown on mobile device

FIG. 42 illustrates an example of ultralite Spotcast, compared in size with quarter dollar according to some embodiments;

FIG. 43 illustrates an example of directional Spotcast according to some embodiments;

FIG. 44 illustrates an example of Spotcast provided directional information shown on mobile device according to some embodiments;

FIG. 45 illustrates an example of fence Spotcast according to some embodiments;

FIG. 46 shows the general category of red and black side of the PixieEngine according to some embodiments;

FIG. 47 shows the detailed category and functions of red and black side of the PixieEngine according to some embodiments;

FIG. 48 illustrates a display of match-making and sale/trade relationships within AOI according to some embodiments;

FIG. 49 shows a Spotcast attached to a movie poster inside a movie theater providing streaming service to a mobile handset according to some embodiments;

FIG. 50 shows a traditional retailing kiosk appliance according to some embodiments;

FIG. 51 illustrates a an example of using Spotcast to perform interactive purchasing according to some embodiments;

FIG. 52 shows a person with a PixieEngine walking in front of and active display advertisement according to some embodiments;

FIG. 53 shows the person vector of movement and turned towards the displayed advertisement according to some embodiments;

FIG. 54 illustrates a user interface showing local resources allowed to utilize within AOI according to some embodiments;

FIG. 55 shows a user mobile device interact with static Spotcast either from local network or incorporating internet service of the device according to some embodiments;

FIG. 56 shows both the object managed local/remote information and mobile device managed local/remote information according to some embodiments;

FIG. 57 shows a headset display of user generated icon overlaid with existing display according to some embodiments;

FIG. 58 shows a user gesturing “Hello” in the air and visualize on-screen according to some embodiments;

FIG. 59 illustrates the user display of attached gesture “Hello” to gesturer's icon according to some embodiments;

FIG. 60 illustrates a headset display with attached gesture “Hello” to gesturer's icon according to some embodiments;

FIG. 61 illustrates a highlighted view of the gestured “Hello” overlaid on existing display according to some embodiments;

FIG. 62 illustrates a date/time mode display of Temporal Calendar according to some embodiments;

FIG. 63 illustrates a SOI mode display of Temporal Calendar according to some embodiments;

FIG. 64 shows a scenario of uploading Temporal Calendar into a server for additional storage according to some embodiments;

FIG. 65 illustrates an overview of the system enabling delayed interaction through Temporal Calendar according to some embodiments;

FIG. 66 illustrates an example of hierarchical visualization applied to a crowded area according to some embodiments;

FIG. 67 illustrates an example of specific privileges package incorporated with hierarchy according to some embodiments;

FIG. 68 illustrates an example of rating display with different icons chosen by users according to some embodiments;

FIG. 69 illustrates an example of a visually impaired navigating himself in an airport, according to some embodiments;

FIG. 70 illustrates a graphical display of deviations in degrees to intended path when object is traversing according to some embodiments;

FIG. 71 illustrates a graphical display of objects and events within AOI when object is traversing according to some embodiments;

FIG. 72 illustrates a user display of tracked child with her trail overlaid show her position to present fence perimeter according to some embodiments;

FIG. 73 illustrates a user display of tracked pet within predefined complex containment according to some embodiments;

FIG. 74 shows obscurity caused by objects to installed Spotcast according to some embodiments;

FIG. 75 shows reduced obscurity by two installed Spotcasts according to some embodiments;

FIG. 76 illustrates a display of configuration of fence Spotcasts placed to provide reliable coverage around the building according to some embodiments;

FIG. 77 illustrates an embodiment of tracking proximity of object from the defined fence lines according to some embodiments;

FIG. 78 illustrates an example of rectangular overlay encompassing safe area inside according to some embodiments;

FIG. 79 illustrates an example of circular overlay encompassing safe area inside according to some embodiments;

FIG. 80 illustrates an example of rectangular overlay encompassing safe area outside according to some embodiments;

FIG. 81 illustrates an embodiment of multi-zone environment with unsafe zones within a safe zone area according to some embodiments;

FIG. 82 illustrates an example of pet collar integrated with PixieEngine and alarm according to some embodiments;

FIG. 83 shows communication between Fence Spotcast and PixieEngine on pet collar, and process flow for event behavior activation according to some embodiments;

FIG. 84 shows the user walking the fence line to define containment with multiple segments according to some embodiments;

FIG. 85 displays three different application user interface on mobile devices according to some embodiments;

FIG. 86 displays four scenarios of a dog in the safe zone which triggers different alarms according to some embodiments;

FIG. 87 displays two scenarios of a dog in the outside unsafe zone which triggers different alarms according to some embodiments;

FIG. 88 displays two scenarios of a dog in the inside unsafe zone which triggers different alarms according to some embodiments;

FIG. 89 illustrates an overview of Spotcast connected to internet sending message to the appropriate remote party according to some embodiments;

FIG. 90 shows an example of creating and editing the fence overlay geometry with a device such as a computer according to some embodiments;

FIG. 91 shows a user interface comprising: a scenario of activating an icon which leads to a highlighted profile display, a personal note attached to a user icon and a Starbucks advertisement announcement according to some embodiments;

FIG. 92 illustrates the highlighted profile display led to by operations according to some embodiments;

FIG. 93 shows a user interface comprising: a directional indicator of baggage claim from far away and an area advertisement announcement to the top corner according to some embodiments;

FIG. 94 illustrates a closer display of directional indicator when different form is shown according to some embodiments;

FIG. 95 illustrates a block diagram of process flow in positioning 3-d network according to some embodiments;

FIG. 96 depicts the initial triangle formed by a moving 3-d network according to some embodiments;

FIG. 97 shows the initial plane formed in the 3-d network by continuous observation of movement according to some embodiments;

FIG. 98 shows the second plane formed in the 3-d network compared with the first one according to some embodiments;

FIG. 99 shows the third plane formed in the 3-d network compared with the previous two to determine horizontally according to some embodiments;

FIG. 100 illustrate the functioning height of excluded zone 1 or 2 according to some embodiments; and

FIG. 101 displays a view of indoor Spotcast configuration for excluded zone 3 and its certain functioning height according to some embodiments.

Like reference numerals refer to corresponding parts throughout the drawings.

### DETAILED DESCRIPTION

Reference will now be made in detail to embodiments, examples of which are illustrated in the accompanying drawings. In the following detailed description, numerous specific details are set forth in order to provide a thorough understanding of the embodiments. However, it will be apparent to one of ordinary skill in the art that the embodiments may be practiced without these specific details. In other instances, well-known methods, procedures, components, and circuits have not been described in detail so as not to unnecessarily obscure aspects of the embodiments.

A positioning reference based system for determining relative positions when a second device is proximate to a first device is described. This includes determining when a second device is proximate to a wireless boundary encompassing and defined relative to the location of the first device. Certain embodiments of the present invention are particularly directed to a high accuracy, low cost positioning reference based system which employs a peer-to-peer wireless network that may operate without the use of infrastructure, fixed nodes, fixed tower triangulation, GPS or any other positioning reference system.

Certain embodiments of the present invention may be used in a variety of applications for determining the locations of an object, animal or person to a designated area or location or to the location of another object or person. One such application includes determining estimated geographical coordinates based on a known geographical coordinates of a remote unit or an object or location of interest. Another application includes providing navigational assistance to travelers or those unfamiliar with an area. Still another area of applications include determining if a child or a pet strays too far away from a certain location or from a guardian or a pet owner. Yet, other area of applications includes accessing information through object hyper-linking in real world and location based communications and social networking.

Certain embodiments of the present invention do not require any existing infrastructure, wide area network or service provider and allows end users to discover the precise location of who and what are around them. This information may be utilized for asset tracking, security or socializing. Further, some embodiments of the invention can be integrated to an existing mobile device so that the end users can overlay information over other devices. Thus, the end user can visualize and interact with other people or objects within a physical Area of Interest (AOI), or with virtual presence via a wireless network. The AOI corresponds to objects in the vicinity and hence have a high importance due to their proximity. Moreover, the device can create relationships with objects which are known to an embodiment of the device but are not physically near the device, objects belonging to this category are said to be within the Circle of Influence (COI.) These two combined domains are referred to as the Sphere of Influence (SOI).

In general, some embodiments of the positioning system includes an embedded radio frequency (RF) signal and positioning algorithm into an integrated chipset or accessory card (beacons) in mobile devices, or attaching it as a tag to objects such as but not limited to a car, keys, briefcases, equipment or children. Through an environment observation done by a wireless personal area network, position acquisition is accomplished indoors or outdoors. It is used only as a way to physically separate beacons, not as a location aware information pushing. This liberates the system from acquisition of geographical location and centralized network support. For example some embodiments provide for acquisition of positioning information to occur indoors within approximately a 50 m range (about 165 feet) and outdoors within approximately 200 m range (about 670 feet). Although, other embodiments may provide greater ranges.

For some embodiments, on-screen icons are shown on the device screen representing the location of other devices which may be linked to information, personal profiles or web sites (object hyperlinking) without pre-incorporated internet/intranet services. Beacons become “hot links” similar to an HTML link, which does not “broadcast” data. They only supply data if a user “clicks” or engages the beacon.

For some embodiments, all events and information occurring within the prevue of the device are recorded temporarily on a calendar which can be later retrieved, searched and browsed in its original chronological order. This allows an end user to extend social interactions on a prolonged timeline, and is not limited to occurrences at certain locations.

Some embodiments of the invention do not require internet access, a mobile phone service provider or any fixed infrastructure such as building infrastructure, Wi-Fi, communication towers or GPS. There is no concept of access points reporting a mobile user location to a backend to send information. Further, beacons do not need to be arranged in any known locations to acquire positioning information.

Certain embodiments of the invention are easy to implement and subject to low cost for both manufacturers and end users, with personalized applications such as but not limited to item tagging, building tagging, getting to know who and what is around me, alarm based on an object near or far, providing device to device information sharing (such as personal profile), prolonging interaction via Temporal Calendar, and also premium based services which are available to cater to specific consumers' needs, such as but not limited to information overlay (including text, symbols and graphics) in the physical environment, and hierarchical visualization to bring status recognition.

Specifically, certain embodiments of the invention relate to the ability to acquire position information of an object within a local real world space and attach attributes or links of information to an acquired position. The positioning component, for some embodiments, relates to the acquisition of the relative position of a local object via wireless signaling without the assistance of external reference-sources in the local real world space. Some embodiments of the invention overlay information attributes or link information to the object or a location relative to that object.

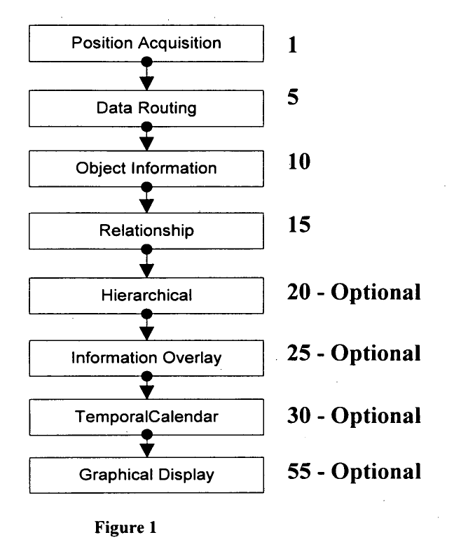

Certain embodiments of the invention establish the location of an object in and around each other without the assistance of external reference sources in the local real world space. Furthermore, some embodiments display and interact with the information showing the location of information, relationships between an object and links to other sources of information within a user device. The high-level process for some embodiments is illustrated in FIG. 1.

In FIG. 1, the process acquires local relative position (1) of other objects by detecting wireless signals indicating the presence of other RF beacons within its area of influence (AOI), and further acquires positioning by integrating sensor data, such as but not limited to range, vector of movement of each object, local object information and device orientation. For some embodiments, local relative position acquisition is done by feeding sensor data (5) into one or more positioning and filtering algorithm, initialized by detection of other RF beacons. Each object is assigned a relative coordinate within the AOI.

For some embodiments, a track file is created and shared across objects to store and synchronize a list of objects presented, which contains, by way of example and not limitation, the ID and object position detailed by the object ID, angle, range, error and error contour. Updating of track files is automatically done when a new position is obtained or an information change is detected.

Each object is assigned a unique identifier which is used to reference object information attributes. Information attributes may further link to other sources of data which can be embedded in the object or accessed via remote gateway.

The Internet provides the ability to link information to other Internet data objects. The current Internet does not extend beyond the virtual or electronic world and has no concept or ability to link information to physical objects. Certain embodiments provide a way to allow real-world objects to be linked to information referred to as object hyperlinking.

Some embodiments of the present invention allow a mobile device or other objects to determine the position of nearby objects and associated information to be linked together (10). Each object's hyperlinking assigns or attaches a reference link (often referred to as URL) into the object in the real world.

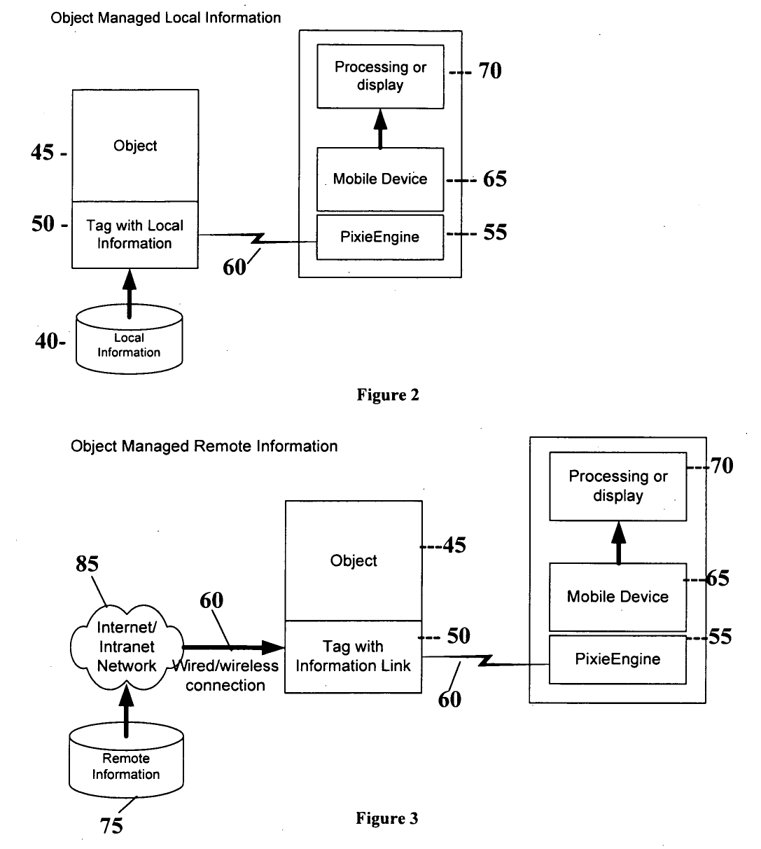

Object hyperlinking can link an object in the real world or physical space with information which may take the form text, data, web pages, applications, audio, video, or social information. Object hyperlinking may be implemented by numerous methods and combinations of them to retrieve the referenced information. FIG. 2 illustrates an embodiment of a method to implement object hyperlinking where local information stored in local database 40 is associated with an object 45 via a tag 50. For some embodiments, local database 40 may be stored a storage medium such as but not limited to read only memory (ROM), random access memory (RAM), magnetic storage medium, or optical storage medium. The information associated with tag 50 is communicated to a positioning system 55 through a communication link 60. Communication link 60 between a positioning system 55 and tag 50 may be established using any form of communication link including but not limited to RF, optical, wired, or other communication link. For some embodiments, positioning system 55 may optionally be coupled with a mobile device 65. The positioning system 55 may be coupled with a mobile device through an RF link, an optical link, or a hardwire link. For some embodiments, positioning engine 55 may be coupled with a mobile device through a Bluetooth link. Additionally, mobile device may be coupled with a display 70.

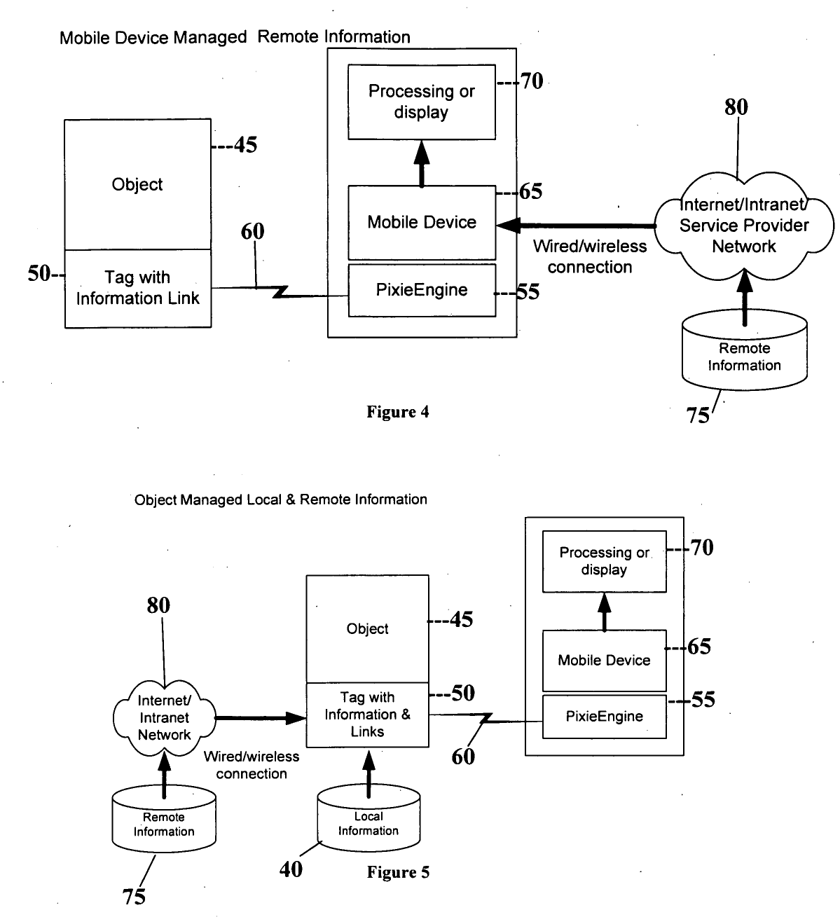

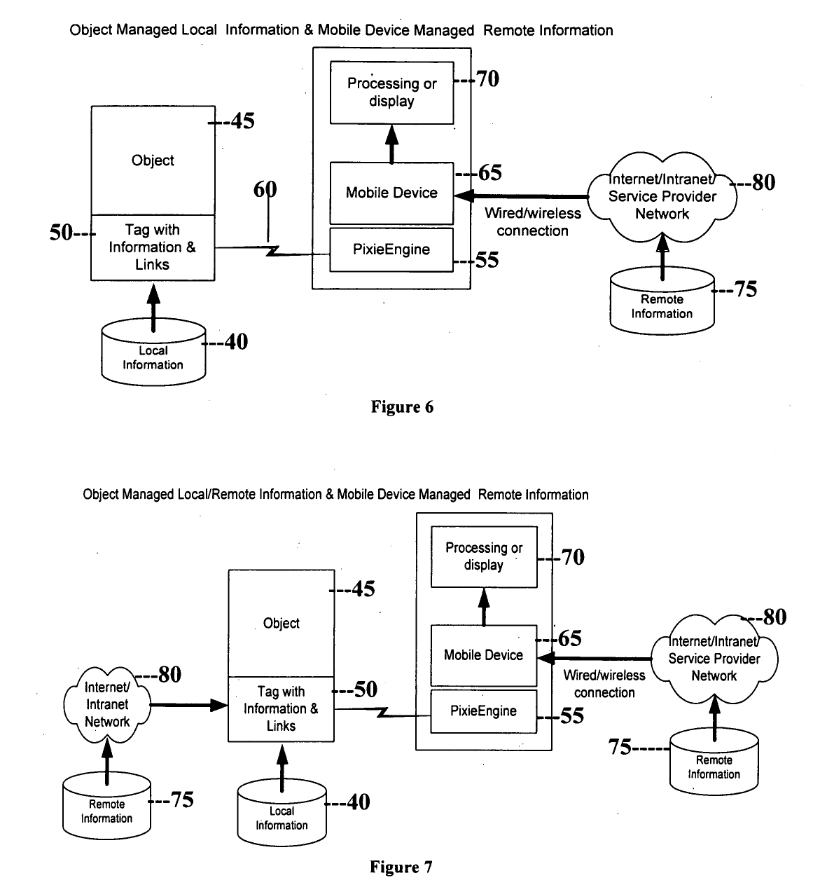

FIG. 3 illustrates an alternative method to implement object hyperlinking where tag 50 communicates with a remote information database 75 via an intranet/Internet network 85. Remote information database 74 may be coupled with tag 50 through any communication link, as discussed above, to an Internet network, an intranet network, or other network. Moreover, positioning system 55 may be coupled with a remote information database 75 as illustrated in FIG. 4. Positioning system 55 may be coupled with a remote information database 75 directly or through a mobile device 65, as illustrated in FIG. 4. Positioning system 55 may be coupled with a remote information database 75 through any communication link, as discussed above. In some embodiments, remote information database 75 is coupled with tag 50 through communication link through a network as discussed above. Moreover, tag 50 may be coupled with any number of information databases. FIG. 5 illustrates an embodiment where tag 50 is coupled with a remote database 75 and a local database 40, as discussed above. Furthermore, both positioning engine 55 and tag 50 may be coupled with any number of information databases. FIG. 6 and FIG. 7 illustrates alternative embodiments illustrating configurations of how a positioning engine 55 and tag 50 may be coupled with information databases, similar to those discussed above.

For some embodiments, each object contains object attributes and information that can be used in searching and matching objects meeting specified criteria. Searching and matching of object information and hyperlinks provide a methodology to determine relationships between local and virtual objects (15). These relationships between objects “connect” the objects based on the information attribute matched.

As an example, if the objects represent people then the relationship may be defined as social connections or matches of personal or social profiles. Further, relationships may be created with objects that include those outside the AOI if a suitable communication gateway is found. Furthermore, these relationships may be assigned hierarchical values such that objects may be filtered to display relationships of a certain hierarchy status (20). This is discussed in greater detail below.

By default, for some embodiments, the physical location of information contained within an object is spatially referenced to the physical location of the object generating the RF signaling. However, information may also be spatially placed at a location away from the actual location of the given object thus creating a relative location based on its own position. In other words, an object may be associated with information directly related to that object or associated with information related to another object at a different location. This allows information to be placed or overlaid at a location that is associated with that location or a location different from the physical object location. Additionally, a single object may be able to project multiple and different types of information at different spatial positions around its physical space.

For some embodiments, an object has the ability to capture all object activities and relationships that it obtains. The data is date-time stamped into a time-line as a calendar (Temporal Calendar) which may be used for later search and retrieval (30). This capability allows for the reconstruction of physical events within a given time.

Through utilizing a user device all data may be further graphically represented on a display (35). A display may create interactive graphical representations of objects, object information, relationships and information overlay. The display may further allow for objects to be oriented according to the physical scene matching the real world object location from the device referenced position.

Local Object Position Determination:

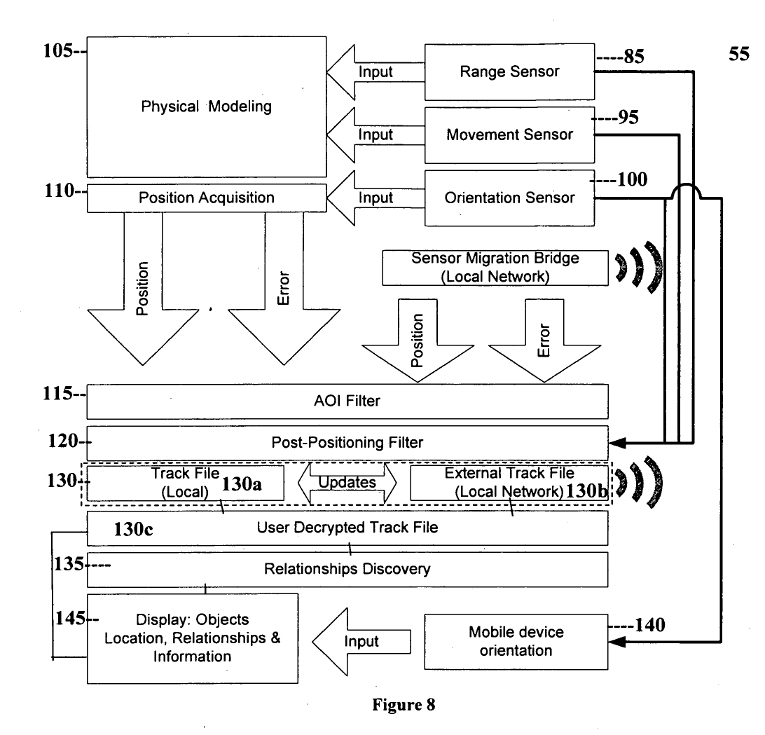

The block diagram of FIG. 8 shows the components utilized for some embodiments of the invention to provide accurate information of the relative location of an object and to correctly orient the information in a mobile device.

For some embodiments, a positioning engine 55 acquires local object positions by utilizing one or more sources of input data. Sources of input data include but are not limited to a range sensor 85 for determining the range between objects, a movement sensor 95 for determining a movement vector, and an orientation sensor 100 for determining a local orientation. Range sensor 85 provides the range between itself and other objects. A movement sensor 95 may include an acceleration sensor that provides the ability to compute a vector of motion and the object tilt angle. An orientation sensor 100 may include a magnetic sensor that provides the local earth magnetic field or compass.

These sensors are coupled to a physical modeling component 105 and position acquisition component 110. The sensor data is fused together by a position acquisition component 110 based on the sensor input and input from the physical modeling component 105. The position acquisition component 110 returns the relative position and associate error of local objects to an AOI Filter component 115 coupled therewith. Moreover, the AOI filter component 115 is also coupled with sensor migration bridge component 116, which provides position and error information to the AOI Filter component 115 based on information external to a positioning engine 55. The AOI Filter component 115 is further coupled with a post-processing filter component 120.

The relative position is then filtered to smooth the dynamic qualities of the object by the AOI filter component 115 and post-positioning filter component 120. The position is stored into a track file component 130 coupled with a relationship discovery component 135. The track file component 130 compares the information received from the post-positioning filter module 115 to track files received from other objects in the vicinity through the sensor migration bridge component 116. The output from the post-positioning filter component 120 is used to create a final track file with the best available information. This information is stored in the track file component 130.

For some embodiments, a track file component may include a local track file component 130a, an external track file component 130b, and a user decrypted track file component 130c. A local track file component 130a may store position information of the local mobile device. Alternatively, an external track file component may store position information related to other mobile devices or objects. For some embodiments, information in stored in the local track file component 130a is encrypted. Furthermore, for some embodiments, a local track file component 130a and an external track file component 130b are coupled with one another and pass position information between the components.

For some embodiments, to access encrypted information stored in the track file component 130, the track file object location encryption key is compared to the user decryption key. Those objects which the key can decode are moved into a user object list. This list represents the objects which the user is able to see the corresponding location.

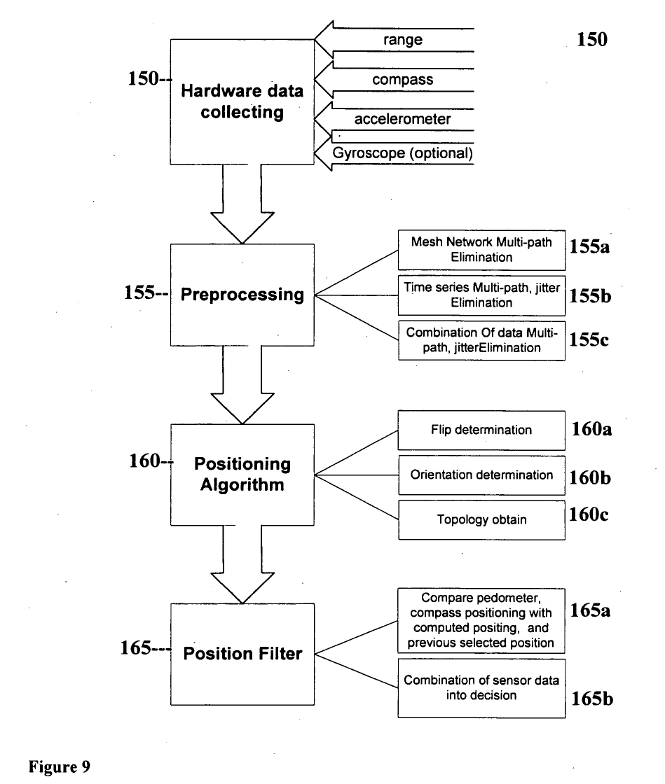

FIG. 9 also includes a relationship discovery component 135 that includes a relationship filter that determines the relationship between the object and other objects in the user track file. The relationship discovery component 135 is coupled with track file component 130. The relationship discovery component uses the information stored in the track file component 120 to compare and determine relationships.

For user devices with a graphical display, the objects location, relationship and information can be visualized. Display component 145 is coupled with track file component 130, relationship discovery component 135, and orientation sensor 100. For some embodiments, the orientation sensor includes a magnetic sensor that provides information to display component 145. This information can be used to rotate the display to match the user device orientation to its physical world view. Furthermore, the information received from track file component 130 and relationship discovery component 135 is used by display component display information related relative position of objects, relationships between those objects, and other related information.

Positioning Acquisition:

For some embodiments, positioning operations of the positioning acquisition component 110 are shown in FIG. 9 of Block diagram of positioning processing. First, sensor data is collected at hardware data collecting step (150). Certain embodiments include collecting sensor data form one or more sensors including, but not limited to, a range sensor, an accelerometer, a gyroscope, and a magnetic sensor. The hardware data collecting step (150) includes collecting walking vectors of each node, and ranges between each two of them. Then these raw data are preprocessed (155) to achieve a higher precision. The preprocessing step (155) includes one or more of mesh network multi-path elimination (150a), time series multi-path, jitter elimination (155b), and combination of data multi-path, jitter elimination (155c). The output of the preprocessing step (155) is then fed into positioning algorithms (160) for relative position acquisition.

The positioning algorithm step 160 includes one or more of flip determination (160a), orientation determination (160b), and topology obtain (160c).

After that, obtained positions are filtered (165) via mathematical methods to achieve a final coherent and consistent position solution. The position filter step (165) includes comparing pedometer and compass positioning with a computed position and a previously selected position (165a). Moreover, the position filter step (165) may use the combination of sensor data to further aid in the determination of position information (165b). The positioning acquisition includes those for 3-d network configurations, which links to a generalized positioning algorithm from the 2-d algorithm discussed explicitly below.

Preprocessing:

For some embodiments preprocessing operations including one or more of the following: network optimization method to eliminate multi-path range data; Time series multi-path, jitter elimination, which acquires a series of sensor data, and eliminate obvious jitters within this time range; and combination of data with the same objective.

Network Optimization:

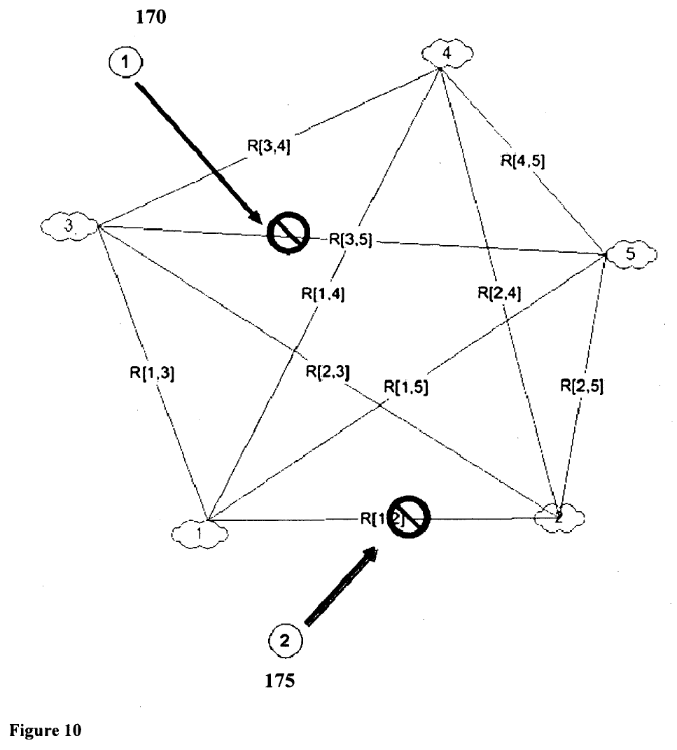

FIG. 10 shows a network including 5-nodes network of which 2 of the objects range data have been corrupted by multi-path due to blockages 170 and 175 between corresponding two nodes. A node is a beacon, object, tag 50, or positioning engine 55 that is transmitting a reference signal. Via a mathematical analysis of the network, a single solution of the correct topology is possible to be achieved, depending on corruption level, data consistency and configuration shape. This method is called network optimization.

Time Series Multi-Path, Jitter Elimination:

TABLE 1
Range jitter elimination based on time series of data

| | Range 12 | Range 13 | Range 23 |
|---|---|---|---|
| time | (m) | (m) | (m) |
| 1 | 10.4 | 16.9 | 12 |
| 2 | 10.4 | 16.9 | 12 |
| 3 | 10.1 | 16.9 | 12.1 |
| 4 | 10.3 | 16.9 | 12.1 |
| 5 | 10.9 | 16.9 | 12.1 |
| 6 | 10.7 | 16.4 | 12 |
| 7 | 10.3 | 16.3 | 12.1 |
| 8 | 7.2 | 16.4 | 12.1 |

Table 1 shows a series of range data recorded by an embodiment of a positioning system. Data that is obviously inconsistent with previous recording are subject to be removed.

Combination of Data Multi-Path, Jitter Elimination:

TABLE 2
Combination range and compass data to eliminate jitter

| | Range 12 | |
|---|---|---|
| time | (m) | Compass1 (degrees) |
| 1 | 7.5 | 54 |
| 2 | 7.8 | 54 |
| 3 | 7.6 | 55 |
| 4 | 8.1 | 55 |
| 5 | 8.3 | 54 |
| 6 | 9 | 55 |
| 7 | 8.5 | 55 |
| 8 | 8.1 | 55 |
| 9 | 7.5 | 55 |
| 10 | 7.4 | 54 |
| 11 | 7.3 | 27 |
| 12 | 7.3 | 26 |
| 13 | 7.2 | 54 |

Table 2 shows a recording of both range and compass data in two different columns, consistency of each column serves to imply the other, which helps to eliminate jitters that are not as obvious as in time series section.

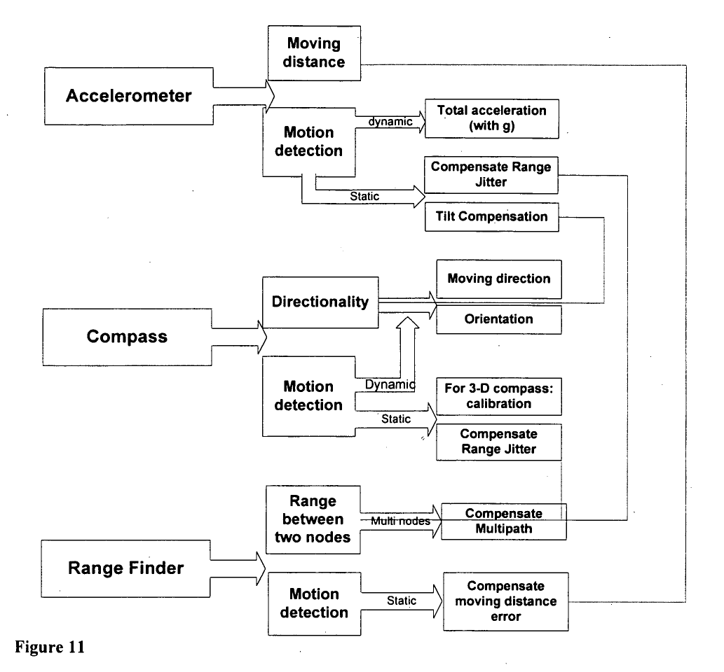

In general, as shown in FIG. 11 of Preprocessing specifically, motion sensor can be used to compensate tilt for precise magnetic orientation acquisition, as well as eliminate range jitter either through raw motion data, or computed walking distances. Similarly, compass sensor can also be used for the same operations. While on the other hand, consistent range data can also be reversely applied to compensate corrupted directionality or walking distances calculation, which lowers the probability of data corruption as a whole.

2-Dimensional Positioning Algorithm:

The following discussion is focused on 2-d network configurations. Due to different mechanisms, there are two scenarios—when there are only two nodes (algorithm can also apply to 3 nodes scenarios) present in the network, and when there are multiple nodes (preferably no less than 4) available—to be discussed, each to be solved with a different algorithm.

Two Nodes Scenario:

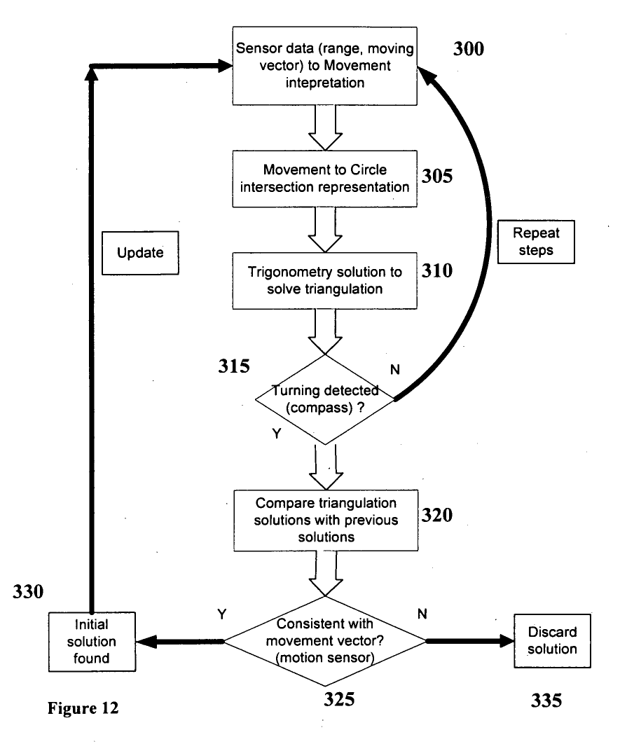

An overview of process flow for an embodiment is illustrated by FIG. 12

Sensor Data to Movement Interpretation (300)

In general, the larger the network, the more information per nodes, considering a number of ranges within this network is proportional to combinatory pairs. Therefore, a two nodes scenario possesses the least amount of data per node, due to which extra efforts need to be put in for compensating insufficient range data. Movement interpretation is defined as moving distance and heading of each object pertaining to the network, as a way of said compensation. For an embodiment, a magnetometer is used to obtain this information. Several algorithms, discussed below, provide moving distances of the device holder within a time range, specified to apply to different scenarios.

Acceleration Double Integration Method

Under circumstances when acceleration is large enough to distinguish from sensory noise background (typically traveling in an automobile), an acceleration double integration method is used to compute traveling distances. For some embodiments, an acceleration double integration (with respect to time) method is applied in inertial navigation systems using data from two or more (preferably) orthogonal accelerometers. Single integration of the obtained data calculates velocity from acceleration as the user moves, whereas double integration calculates position. The results of the integration are added to the starting position so as to obtain current location. The position errors increase with the square of time due to the double integration.

Step Count (Pedometer) Method

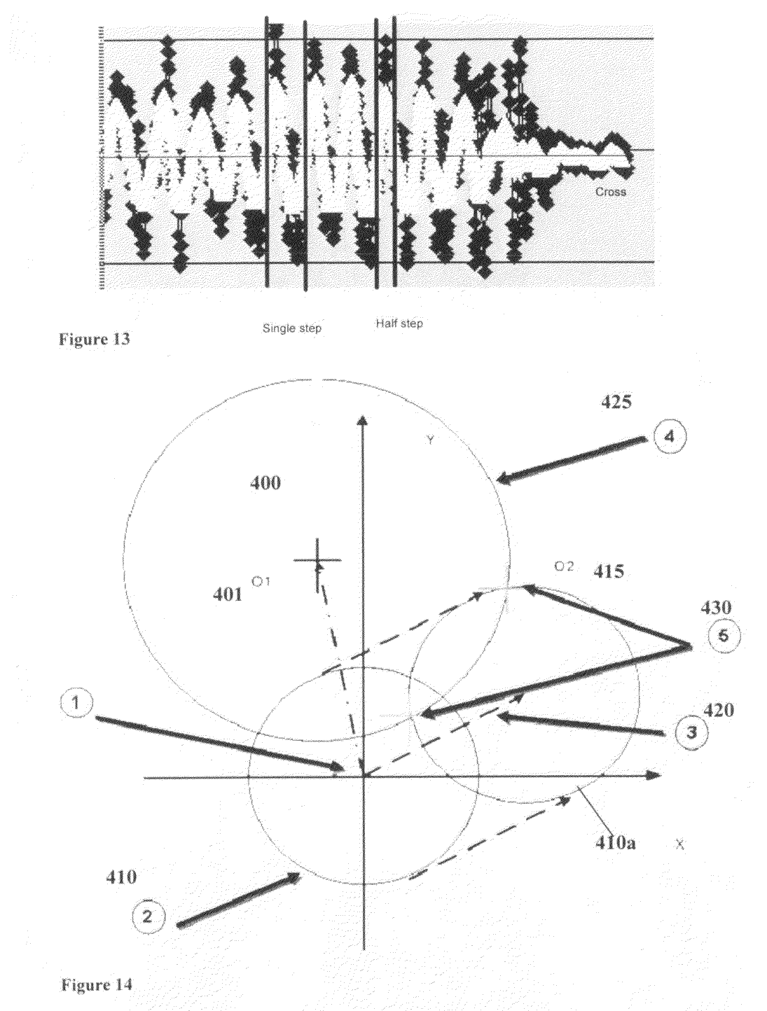

This work is specifically employed for runners, foot traveler or pedestrian use where acceleration measurement is vulnerable to sensory noise, and “step” pattern is explicit. FIG. 13 shows an illustration of such a pattern in acceleration sensor data according to an embodiment. Step count method is simply counting the number of physical steps interpreted from a pattern such as the one illustrated in FIG. 13. Such a method is commonly regarded as a pedometer.

The pattern of the acceleration signal has a profile which repeats at each step. In some embodiments, the acceleration profile comprises in succession: a positive phase, in which a positive-acceleration peak occurs due to contact and the consequent impact of the foot with the ground; and a negative phase in which a negative-acceleration peak occurs due to rebound, having an absolute value smaller than that of the positive-acceleration peak. A step detection is based upon the comparison of the value of the acceleration signal with a reference threshold having a pre-set value for the detection of acceleration peaks. Counting of the steps is subsequently conducted and measurement of the total distance traveled is updated by multiply estimated human step length.

Movement to Circle Intersection Representation (305)

In FIG. 14 Origin 1 400 is where a first object 401 is before moving. The bottom circle 410 represents the possible locations of a second object 415 determined by range, before an initial position is computed. When the second object 415 moves, since we know the direction (read from compass) and distance (read from pedometer) of its traveling, represented as moving vector 420, we simply move the first circle 415 in that direction to that distance away, with the new circle represented by 410a to be the possible locations of the second object 415 after it moves.

At the same time, the first object 401 moves, to another position which can be denoted by certain coordinates (obtained by its traveling vector). After moving, we update the range between the two objects, which is shown as the largest circle 425. The intersections of the two circles 430 after moving should be the possible solutions of the relative position of the second object 415.

Trigonometry Solution to Solve Triangulation (Circle Intersection) (310)

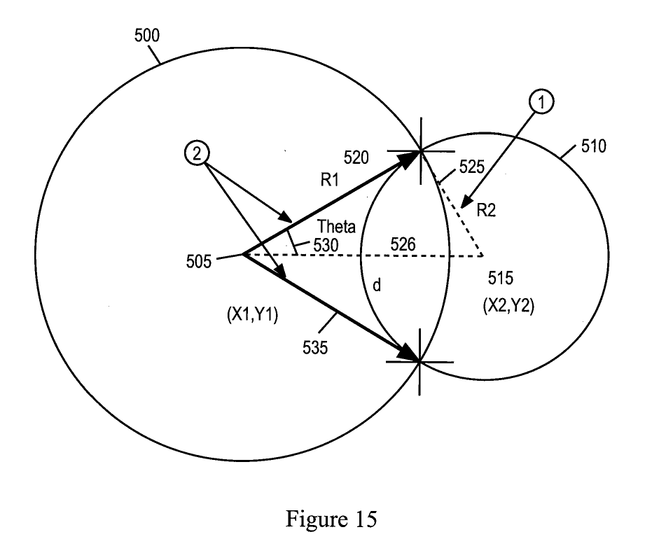

Now the positioning becomes a problem of obtaining intersection of a first circle 500 and a second circle 510. The first circle 500 is defined by a first center 505 and a first radius 520. Similarly the second circle 510 is defined by a second center 515 and a second radius 525. Thus, trigonometry is used to determine the intersection of the two circles. FIG. 15 shows how this information is used to determine the intersection of the two circles. Applying trigonometry to solve for the distance (d) between the first center circle 505 and the second center 515. Moreover, trigonometry is used to solve for the angle theta 530 in the triangle 526. Solving this gives the positioning system enough information to define two vectors 520 and 535. By vector addition, two possible sets of coordinates can be obtained:

Theta=acos((R1̂2+R2̂2−d̂2)/(2*R1*R2))

Coordinate Set 1:

X=X1+R1*cos(theta)

Y=Y1+R1*sin(theta)

Coordinate Set 2:

X=X1+R1*cos(−theta)

Y=Y1+R1*sin(−theta).

The above mathematical technique is called triangulation, which will be repeatedly used in positioning below.

Turning Detection (315)

A turn is defined as a change in heading of movement, envisaged by a non-noise level change during continuously observation of magnetometer data. In the case where the detection occurs (which indicates the occurrence of a turn), a determination of position is conducted as described in the next section; otherwise, the algorithm returns to the initial condition of looking for a new circle intersection.

Compare Triangulation Solutions with Previous Solutions (320)

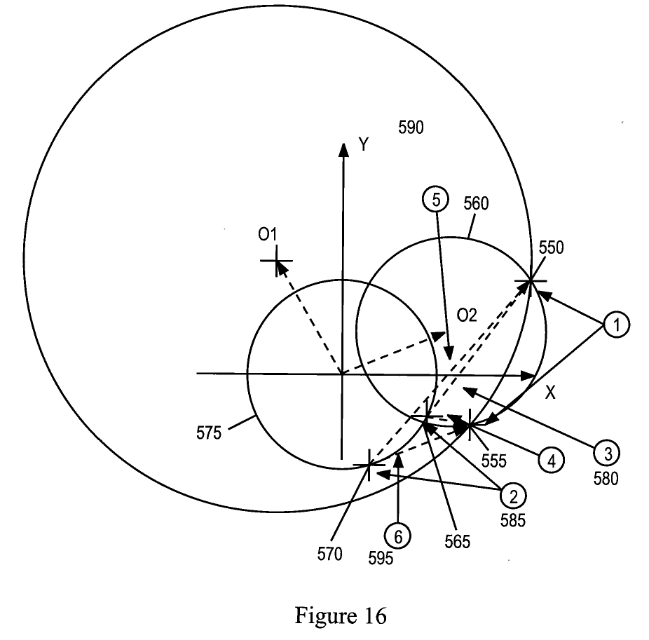

When a turn is detected, compare new intersection solutions with previously obtained ones, and choose the one that has a consistent moving vector with sensor data. FIG. 16 depicts the newly formed circle intersection marked a first cross 550 and a second cross 555 on the top small circle 560, compare with previous triangulated relative positions indicated by a third cross 565 and a fourth cross 570 on the bottom circle 575, the following moving vectors can be deduced:

### Previous Triangulated Coordinates:

(Xprev 1, Yprev 1)

(Xprev 2, Yprev 2)

### New Triangulated Coordinates:

(Xnew 1, Ynew 1)

(Xnew 2, Ynew 2)

### Deduced Moving Vectors:

Vector1, shown as 580: (Xprev 1-Xnew 1, Yprev 1-Ynew 1)

Vector2, shown as 585: (Xprev 1-Xnew 2, Yprev 1-Ynew 2)

Vector3, shown as 590: (Xprev 2-Xnew 1, Yprev 2-Ynew 1)

Vector4, shown as 595: (Xprev 2-Xnew 2, Yprev 2-Ynew 2)

Compare the above vectors with moving vectors obtained in the initial step, select the one that has consistence with the moving vector, in FIG. 16 is vector4 595. Thus the positioning system determines the current relative position is (Xnew 2, Ynew 2).

For some embodiments, the operations described above are repeated at a regular interval to secure a higher precision in intersection solution choice. For an embodiment, the operations are repeated 1 to 60 times per minute. In other embodiments, the operations are repeated more often.

Multiple Nodes Scenario (Example: 5 Nodes Scenario):

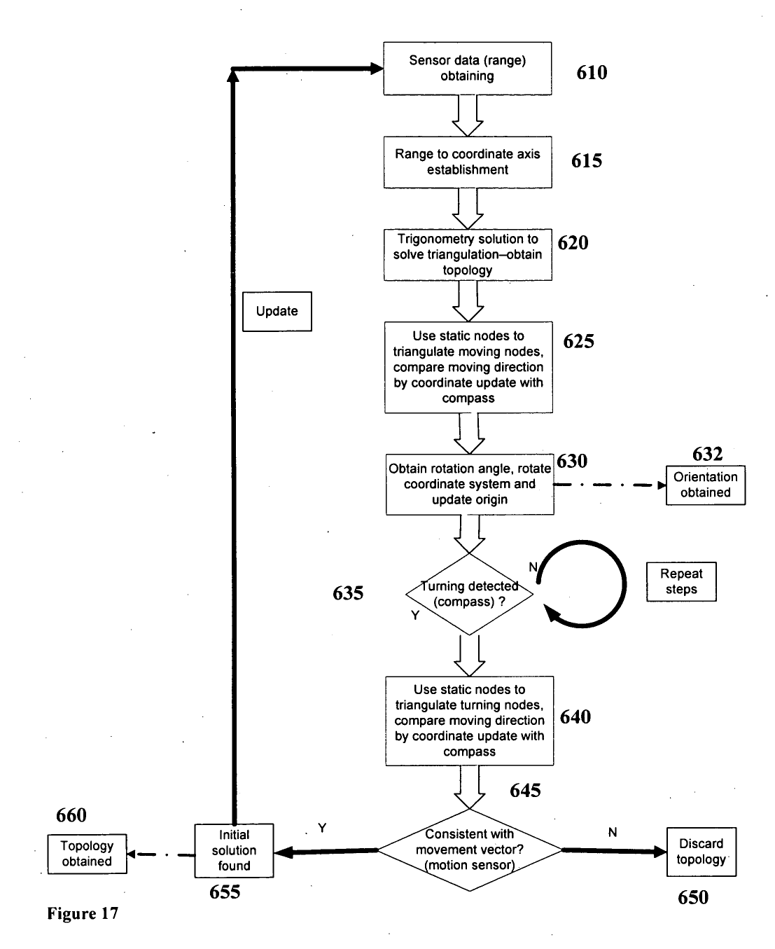

An overview of process flow according to some embodiments is illustrated by FIG. 17.

Sensor Data (Range) Obtaining (610)

Unlike the two nodes scenario, multiple nodes networks normally enjoy relatively sufficient range data to secure acquisition of topology. However, occurrences of error may be considerable when multi-path issues are present, and when insufficient range data are available, thus the following proposed procedure may produce no useful output.

In a situation, such as above, where no useful output is produced, some embodiments of the positioning system automatically switch to a two nodes operations to configure each other node, as described above.

Range to Pseudo Coordinate Axis Establishment (615)

For embodiments using a range to pseudo coordinate axis establishment technique, the 5 nodes are ordered, starting with observer as node 1 (origin). The other nodes are then randomly assigned a number if the range between node 1 and that node is greater some distance from node 1. For an embodiment the range between node 1 and that node is greater than 3 m (testable parameter. People who sit next to node 1 are not preferred to be anchor points). The nodes are then assigned a pseudo set of coordinates. For some embodiments, the nodes are assigned a pseudo set of coordinates on an x, y axis. Pseudo coordinates, as referred to here, are defined as a temporal coordinate system enabling computation before the real coordinate can be found.

Trigonometry Solution to Solve Triangulation—Obtain Topology (620)

After setting up a coordinate system, some embodiments, randomly choose one node from the rest nodes which satisfies: a range between this first node and a second node and a third node are both greater than a certain distance. For an embodiment the distance is 3 m (due to the same reason as the previous step). Obtain circle intersections, as discussed above, to obtain two possible pseudo coordinates for the third node. Select one of the two possible coordinates of the third node, find the rest of the topology. Intersect two circles formed by node 1 & node 4, node 2 & node 4, and use node 3 as tier broker. Choose one possible coordinate of a node 4 that has a distance to node 3 closer to sensor data. Repeat with alternative intersections, obtain all coordinates of node 4. Average these coordinates, return as final coordinate of node 4. Repeat the previous step for fifth node-one possible topology construction finished. A symmetric topology can be easily developed by flipping the obtained one over px axis, as shown in FIG. 18.

Compare Moving Direction by Coordinate Update with Compass (625)

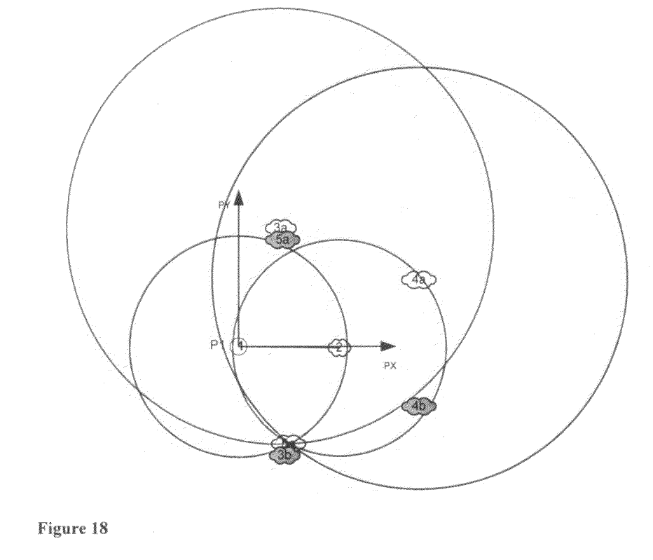

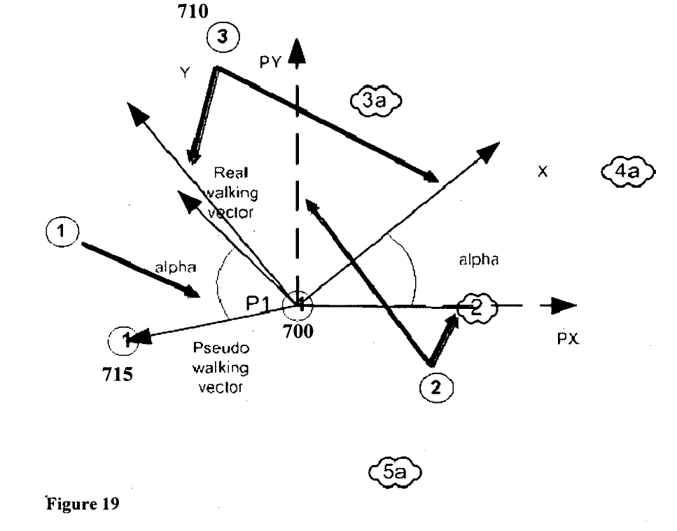

In FIG. 19, with topology a, after node 1 moves from a first position 700 to a second position 715, obtain new coordinates of node 1 by intersection of other static nodes in a pseudo coordinate system a: new triangulated coordinates (X1,Y1), deducing moving heading of node 1 in such coordinate system is:

angle 1=atan2(Y1, X1).

Compare with real walking direction provided by compass heading angle 2, obtain rotation angle of pseudo coordinate system alpha:

alpha=angle 2−angle 1.

Rotate Coordinate System—Orientation Obtained (630)

Rotate the entire coordinate system by alpha to match the real orientation with “north”, hence we obtain the real coordinate system 710.

For all coordinates, rotate by angle alpha will cause the following: for an object with polar representation such as range=R, azimuth=theta, new polar representation becomes range=R, azimuth=theta−alpha

Update origin to be at current position of node 1 (715) by subtracting its triangulated coordinates from the entire topology: for each object present with Cartesian representation (X, Y), updated representation becomes (X-X1, Y-Y1).

Turning Detection (635)

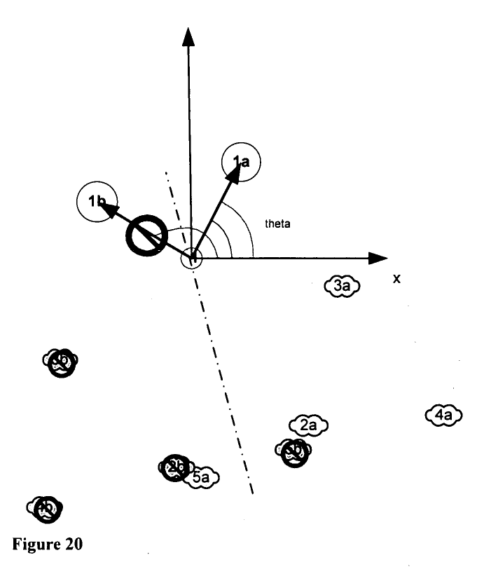

In FIG. 20, list the two possible topologies in the obtained real coordinate system (notice that all coordinates have not yet been determined because of this flipping ambiguity)

Turning of moving object is necessary in mitigating said flipping ambiguity by creating discrepant deduced moving headings. For an embodiment, detection of turning should come from both envisagement of magnetometer heading change and triangulation coordinate deduced heading change, to raise the level of detection accuracy.

Providing new triangulated coordinate for node 1 is (X1new, Y1new), deduced heading of node 1 is

Heading(new)=atan2(Y1new,X1new);

compared with previously recorded heading:

Heading(previous)=atan2(Y1prev,X1prev);

Hence:

Heading change=Heading(new)−Heading(previous).

If Heading change exceeds preset threshold, the second condition in said turning detection is satisfied.

In the case where said detection occurs (which indicates the occurrence of a turn), a determination of topology is conducted as described in the next section; otherwise, the algorithm repeats until such detection is achieved.

Compare Triangulation Deduced Moving Heading with Magnetometer Heading—Obtain Topology (640)

Once turning of node 1 is detected, we have in previously section heading of node 1 is Heading (new)=atan2 (Y1new, X1new). Notice that this is deduced by triangulation in topology a only.

Apply reflection symmetry, using topology b, new coordinates of node 1 will be:

(X1new b=cos(2*beta)*X1new+sin(2*beta)*Y1new, Y1new b=sin(2*beta)*X1new−cos(2*beta)*Y1new).

Where beta is angle between new coordinate of node 1 in topology a and an x axis, shown in FIG. 20.

Compare azimuth of two possible coordinates of node 1, choose the one that is closer to compass heading—theta, hence the corresponding topology.

Lastly update origin again, and repeat triangulation with obtained topology for updating.

3-Dimensional Positioning Augmentation:

3-Dimensional (3-D) positioning augmentation is designed for applications which require an estimation of height, as may be needed when requiring information overlay placement at a height of 1 meter above the ground. This additional dimension acquisition provides a height dimension and can be used to display and to orientate objects accordingly. The process leverages an existing 2-D positioning algorithm and adds height when available to nodes, additional height information or larger collections of sensor data.

In the following discussion, two methods are discussed which reconstruct the 3-D mesh network with absence of any access points, each of which method operates under certain constraints and thus is feasible for designated applications.

Method of Pre-Programmed Height:

For some embodiments, this method combines a mechanism of both access point localization and 2-D positioning. Static positioning engines, tags, beacon or other objects emitting a position signal, one such embodiment including a Spotcasts, deployed at certain height acquire such information through either automatic computation or manual input of height as a positional characteristic of the Spotcast. Through communication and relay of information, the entire network shares knowledge of different height that each Spotcast possesses. From this information a positioning engine such as a Spotcast determines an associated horizontal plane it resides.

With said preprogrammed height characteristics as known factor of the network, computing the rest of the topology can be done per the combination of 2-D and 3-D geometry. The complete network configuration is thus acquired and updated thereafter utilizing the known 3-D geometry.

The method demonstrates viability to be applied to applications rich with static positioning engines such as a Spotcasts. Compared with access point approach, this method serves to save intensive labor in acquiring precise locations of anchor points, liberates usage from rigid infrastructure base, as well as operate without the need of having assigned anchor points.

Location accuracy of additional dimension is relatively lower compared with access point localization method. Nevertheless, for many day-to-day applications where a lower level of accuracy of 1 meter in height is sufficient in operation, the method is an appropriate approach to function.

3-D Geometrical Positioning Based on Movement:

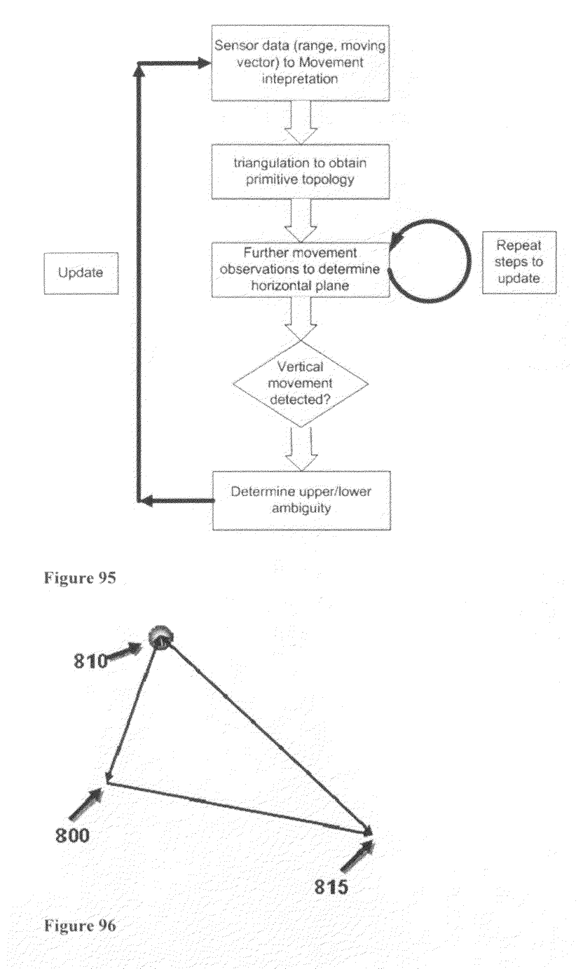

Another form of 3-D network reconstruction is through a larger collection of information to gain simulated anchor points performing positioning. FIG. 95 displays an overview of such process according to some embodiments. Specifically, the FIG. 95 process includes using sensor data to do movement interpretation, using triangulation to obtain a primitive topology, and analyzing further movement observations to determine a horizontal plane. The analyzing of further movement may be repeated to update, as shown in FIG. 95. The FIG. 95 embodiment also includes detecting vertical movement and determining upper/lower ambiguity. From this step the process flow of the FIG. 95 embodiment moves back to using sensor data to do movement interpretation. Rather than relying on end user to build dimensional characteristic, these position related signatures can be obtained by observing the dynamic characteristics of the network under movement for some period of time. FIG. 96 though FIG. 99 illustrates the detailed process of this approach which composes a 2-D geometrical plane of which 3-D positioning is used for reconstruction.

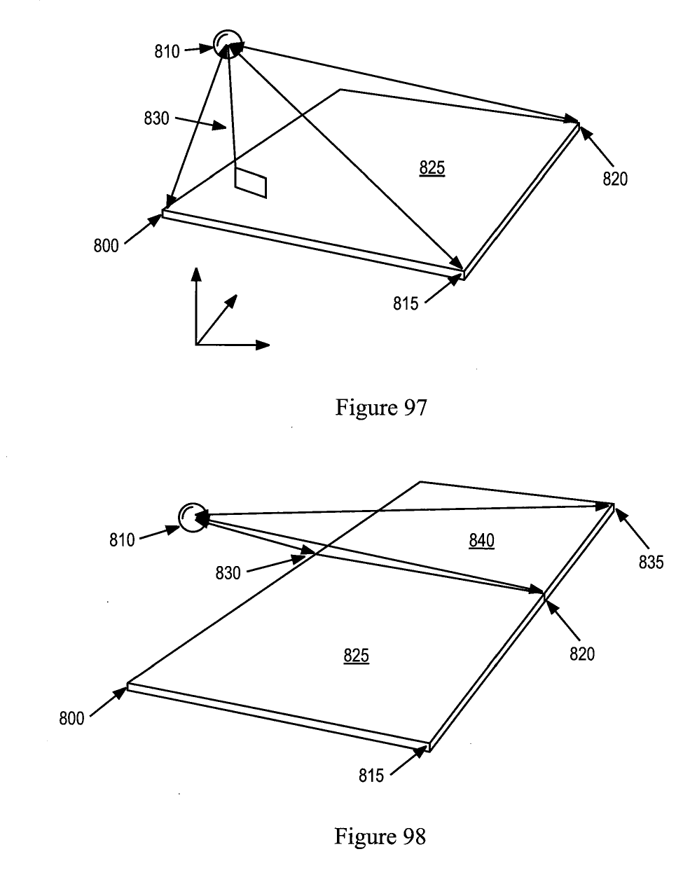

FIG. 96 shows a scenario where two nodes 1 (800) and 4 (810) are present, of which node 4 (810) possesses a higher position than node 1 (800). After node 1 (800) moves to new location 2 (815), a triangle can be formed by: moving distance of node 1 (800), ranges between node 1 (800) and node 4 (810) through measurements before and after moving. As 2 (815) continues moving to 3 (820), a plane is constructed by the series of measurement, shown as gray plane 825 in FIG. 97. Providing said plane is horizontal, the height of node 4 (810) would be derived as perpendicular distance to said horizontal plane of reference shown by 5 (830).

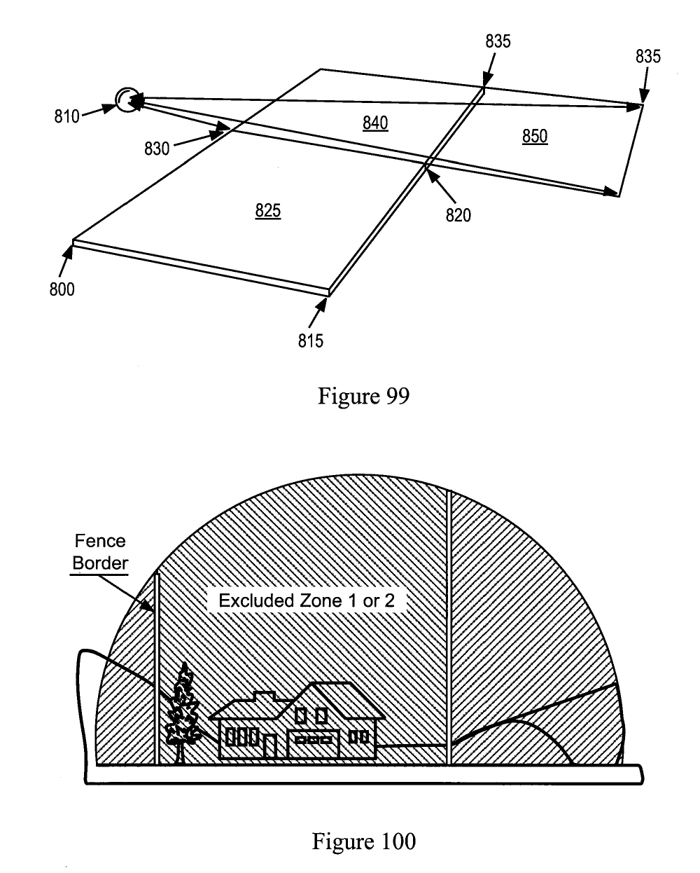

However, due to ignorance of vertical movement of node 1 (810), determination of horizontal plane is subject to further confirmation. FIG. 98 shows the continuous journey route of node 1 (810) from spot 3 (820) to 5 (830), then 6 (835), when a new plane (840) is constructed to compare. Ambiguity of horizontally at this stage still exists if height discrepancy is observed in returned two planes. Specifically, if two planes are not both horizontal, then their independently referenced height of node 4 (810) would be of distinguishable differences.

This ambiguity is mitigated, for some embodiments, through an extended observation of movement, shown in FIG. 99. As node 1 (810) trips from 6 (835) to 7 (845), forming a third plane (850), comparing which with the two previously constructed ones, consistency in referenced height of node 4 (810) serves to validate horizontally, as well as consequent height associated with the configuration.

For 3-D networks with more than 2 static Spotcast nodes, the same technique can be applied replacing each traveling spot (such as ID2, ID3, ID4, ID5, ID6, ID7) with static Spotcast nodes present in the network. With such larger networks, process of obtaining and comparing planes are correspondingly shortened.

Unlike the pre-programmed height method, implementation of this method does not demand abundance in static Spotcasts, attributing applicability to broader areas with mobility.

Sensor Migration Bridge:

Some embodiments of the invention provide a migration bridge or backwards compatibility to operate with mobile devices or objects which implement partial technological sensor solutions. In order to share known information, the migration bridge will utilize a local wireless network protocol (Wi-Fi). Through the local network, devices will be able to share known information with each other to augment any known data points. This will provide range, localization enhancement and error reduction between devices.

Some embodiments of the invention will allow existing mobile devices to use a signal to compute range data. For some embodiments, this signal is a Bluetooth signal. This signaling will provide enough information to give a reasonable accurate range which can be further enhanced through other devices participating in the local network. However, without dead-reckoning technology, Bluetooth devices will not be able to provide angle and range.

Some embodiments of the invention will allow existing mobile devices with GPS capability to calculate Range and Angle from GPS data. To increase resolution granularity, GPS data will be augmented by range calculation based on the Bluetooth range.

GPS or Bluetooth will not calculate device orientation. While orientation can be computed while the device is in motion, this would not be the case when it is stationary. These devices will lock the display orientation and will not rotate the display information.

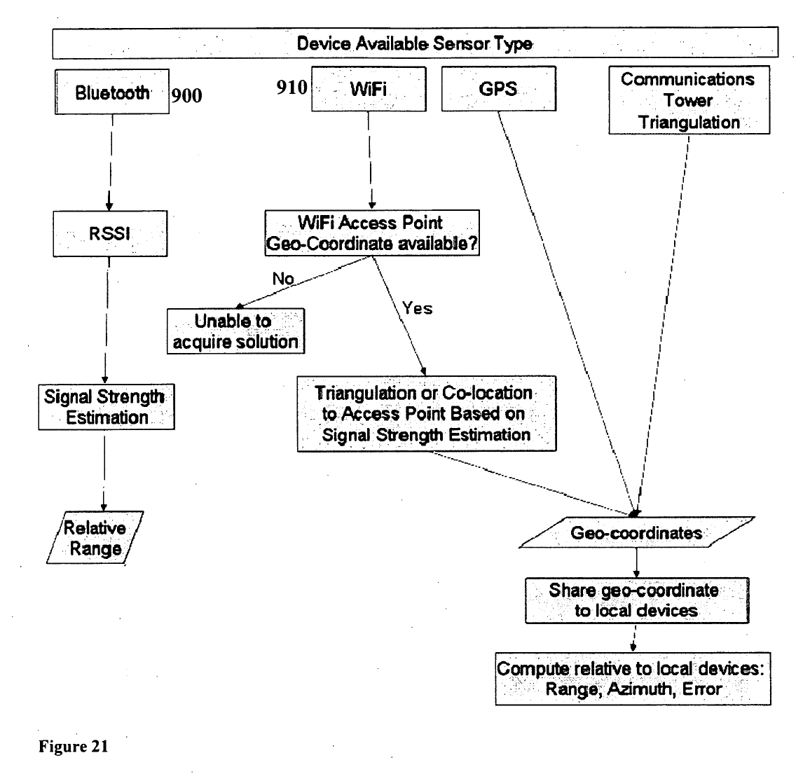

FIG. 21 shows an overview for processing different sensor types according to some embodiments. Devices which include Bluetooth 900 can only achieve an estimated relative range from other devices based on a Bluetooth signal strength estimate.

FIG. 21 also shows that, in certain embodiments, devices with Wi-Fi 910 can access public data bases of geo-coordinates for publicly available Wi-Fi access points. Given 1 or 2 access points available within range, a given device can be collocated around the access point at an estimated range and given a geo-coordinate based on a closest access point with the strongest signal strength. Given 3 or more access points available within range a triangulation can be established based on the signal strength to each access points and a geo-coordinate determined.

FIG. 21 further illustrates that given that a geo-coordinate is found, these coordinates are shared across the local devices via a local wireless network and a relative coordinate system is calculated and the required relative data range and azimuth are determined. An error area is also computed to determine the possible error associated with the range and azimuth.

The relative coordinate conversion between two devices with geo-coordinates (X1, Y1) and (X2, Y2) is as follows:

Range=SQRT((X1−X2)̂2+(Y1−Y2)̂2)

Azimuth=ATan 2((Y2−Y1),(X2−X1))

AOI Filter:

Some embodiments of the invention filters out information which is outside its AOI. This information may be received due to increased range calculation via sharing of track information between devices using the local area network.

Given that a relative range is available between devices, the AOI Filter will remove objects which are farther than a defined maximum range.

Post-Positioning Filter:

After relative positions are acquired by positioning algorithm, solutions are sent to filters for better estimation. Several methodologies are available for utilization, such as recursive estimation of the state of a dynamic system from incomplete and/or noisy data points (Bayesian Filter), and the same techniques as used in preprocessing for jitter elimination.

Track Files:

Some embodiments of the invention utilize track files in order to keep a list of local objects. The track file contains the object ID, angle, range, error, error contour and associated information. Local track files can be sent or received from other local objects and merged utilizing augmented data from other objects. Thus the final merged track decrease position errors.

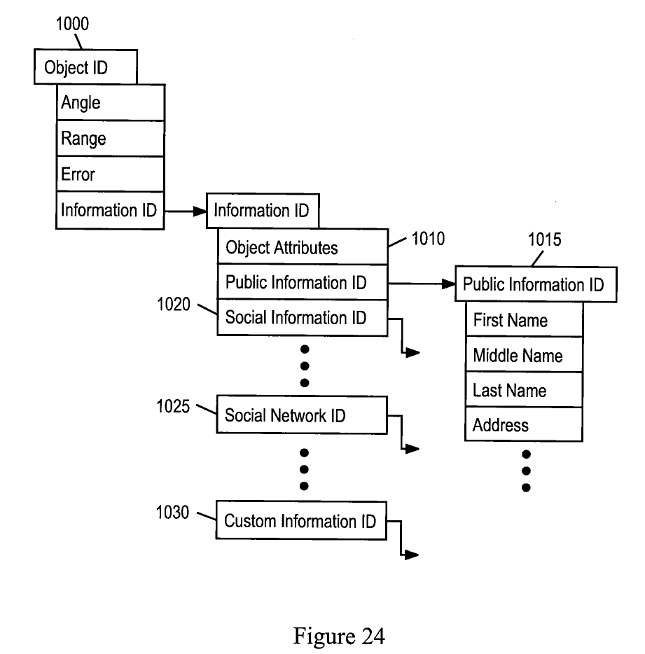

FIG. 24 shows a Track file database example where each ObjectID 1000 represents a unique object or “track” in the SOI and its associated location information. Each ObjectID 1000 is linked into its information which includes the object attribute characteristics 1010, public information 1015, different social information 1020 or social network 1025, and custom defined information types 1030.

External Track Files:

Some embodiments of the invention has the option to merge other mobile devices' or objects' track files in order to augment its own data set and to decrease the position error.

User Decrypted Track Files:

The track file location contains a decryption key which determines if the object can view or act upon location information. If the object key matches the existing location key of the object then the object location is decrypted and passed into a user viable final track file.

The merged track file establishes the final track files of objects to be displayed. This track file with augmented position allows objects with limited sensor capabilities to view and manage location of other objects with enhanced their sensor capabilities.

FIG. 24 shows a Track file database example where each ObjectID 1000 represents a unique object or “track” in the SOI and its associated location information. The ObjectID 1000 record is visible however the information ID's 1010 are each encrypted with their unique key. In order to access the information, the data is first decrypted.

Architecture:

Certain embodiments relates to a system and/or method that allow a device the capability of locating and visualizing relative position between objects near each other without reference information. Each object creates a physical model of its environment to acquire a local reference system of objects in its environment. In general, the system and/or method is achieved by incorporating a mathematical physics modeling algorithm which utilizes the following inputs: range between objects, object movement vector, local orientation and data feedback loop with other remote objects. The data feedback loop shares location information between objects to improve and complement other object data and sensors.

Physical Signaling

Some embodiments of the device require a method to transmit data and estimate range between objects. One such embodiment uses a radio frequency (RF) transceiver to provide signaling and information between devices. Two standard methods are used for range computation between objects: Received Signal Strength (RSS) and/or Time of Flight (ToF). For RSS, the power level from the RF transmission is utilized to provide a signal strength which is then correlated to a range for the specific transmitter specifications. Range via ToF utilizes a data protocol or signal to establish the timing to calculate the transmission time. To increase accuracy multiple signals may be sent back and forth between objects to accumulate a larger time of flight value and averaged by the number of trips. Some embodiments of the invention combine both methods into a dual approach providing additional sensor and environmental characterization between the objects.

Some embodiments of the invention utilize a narrow band transmitter operating at 2.4 Ghz. Other embodiments may use other frequency band or standards including, but not limited to, Ultra Wide Band (UWB) transmission method or ultrasound to determine range between nodes.

Local Orientation

The device requires a method to create local orientation so that all local objects are synchronized to a similar referenced point. According to some embodiments, a three axis magnetic sensor is utilized that can sense the Earth's magnetic field. Through the utilization of the tilt sensor, the object tilt compensation is done in order to provide accurate reading and accurately determines the Earth's magnetic field.

The magnetic declination is the angle between true north and the sensor magnetic field reading. The magnetic declination varies at different locations in the Earth and at different passages of time. The declination may vary as much as 30 degrees across the United States. However within a 100 KM area the magnetic declination variation is negligible and hence not significant for certain embodiments to operate locally.

Tilt Sensor

Some embodiments of the invention use a method to compute the tilt of the device relative to the Earth. On such embodiment utilizes a three axis MEMS accelerometer in order to determine tilt.

Movement Vector

When the object moves, the device requires a method to determine the relative distanced moved. This value provides a reference notion of the distance traveled over ground. Some embodiments utilize a pedometer function or a physics model for displacement as a double integration of acceleration with respect to time. Examples of these two methods have been described in detail above.

Data Feedback Loop

The device requires a method to transmit and receive data in order to share and updated with other local objects sensor data, location and information. Some embodiments utilize a narrow band transceiver in 2.4 GHz. Additional embodiments may include other bands or methods to transmit data between devices.

As each object acquires object positions, they are stored in a local track files. The track file contains the object ID, angle, range, error, error contour and associated information, according to some embodiments. Each neighboring object shares its local track file in order to merge the data into an augmented data set. Thus, the final merged track may decrease position errors and augment other objects with limited or less accurate sensors.

Positioning Engine Configuration

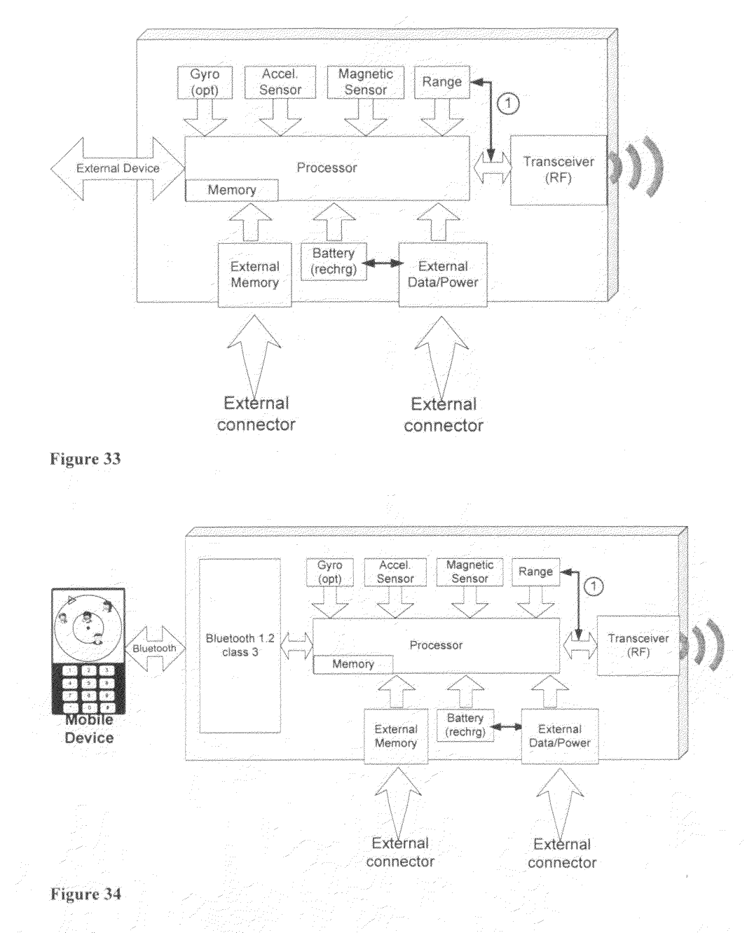

According to certain embodiments, a positioning engine such as a PixieEngine as developed and implemented by Human Network Labs, Inc. based out of Philadelphia, Pa., is used. This integrated circuit board may be further integrated with other components via physical or wireless connection. A block diagram of a positioning engine according to some embodiments is shown in FIG. 33. The FIG. 33 embodiment includes a gyroscope, an acceleration sensor, a range sensor, a magnetic sensor, memory, external memory connector, battery, external battery/data connector, an interface to an external device, and a transceiver all coupled with a processor.

Further, PixieEngine implements a power transmission adjustment level based on range and RSS between objects see FIG. 33.

Some embodiments integrate the technology with existing devices over the standardized communication channels. On such embodiment use a Bluetooth wireless connection as shown in block diagram in FIG. 34. Specifically, the FIG. 34 embodiment shows all the same type of blocks as discussed with FIG. 33 coupled to a processor, but also includes a Bluetooth interface coupled to the processor for communications with a device.

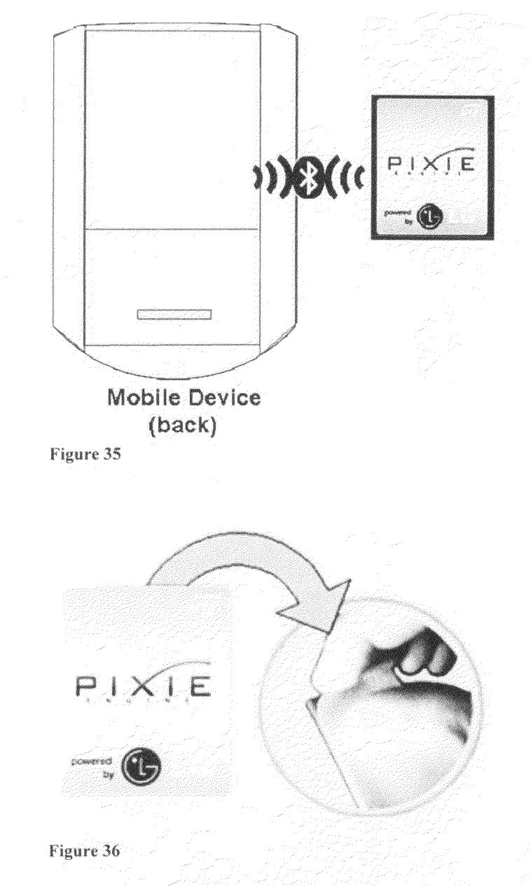

Communications between a mobile device and a positioning engine such as a PixieEngine, as well as between PixieEngines are shown in FIG. 35, FIG. 38 respectively.

Positioning Engine Encryption

To provide privacy and security protection, some embodiments of the invention further allow for the implementation to operate in a fully encrypted mode between objects and internally. The implementation allows information to be shared with external devices which is listed in the User Decrypted Track File. Thus data stored within the integrated component can be maintained encrypted until use decryption key requests are met and matched.

Local Network

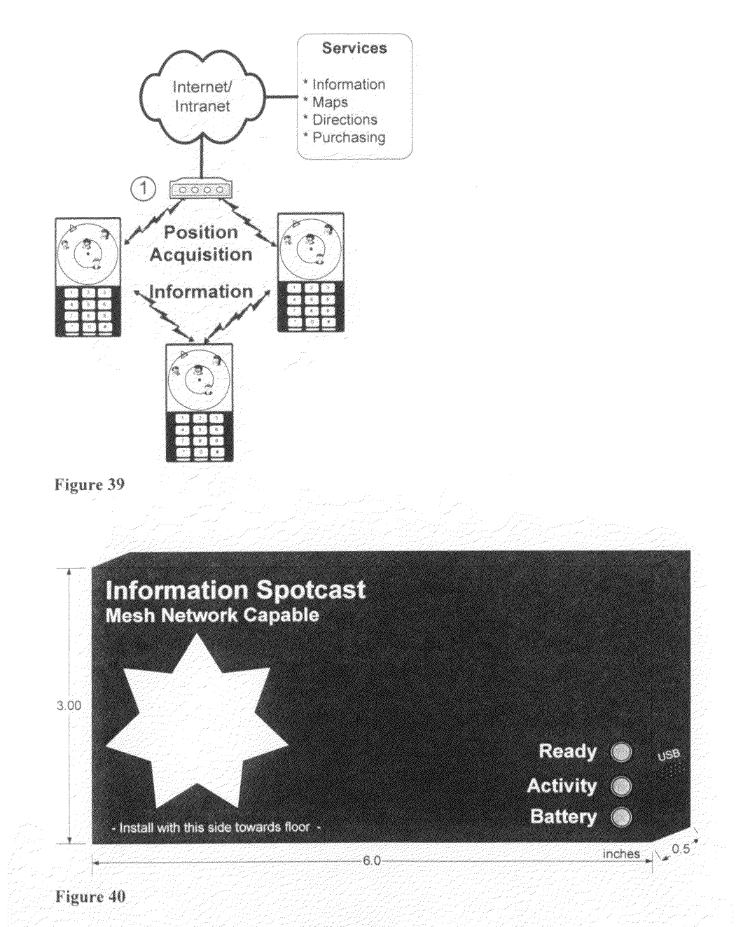

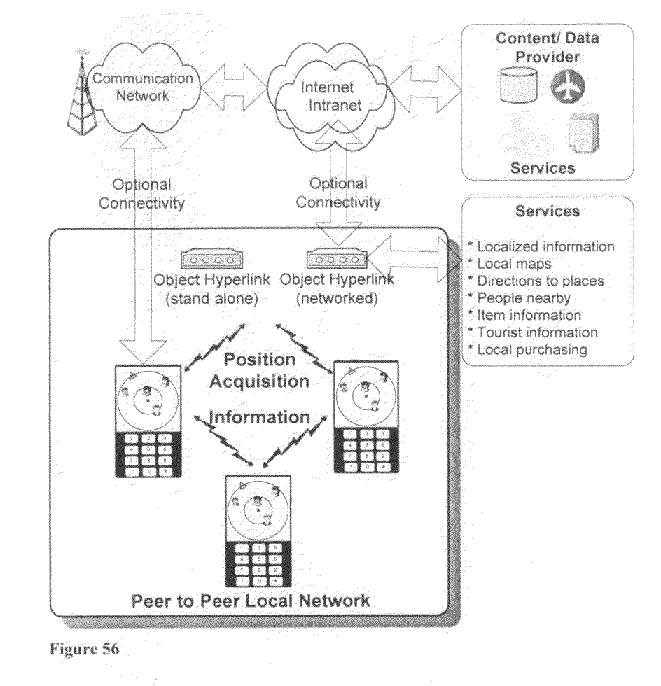

Some embodiments of the invention implement a local peer-to-peer mesh network which is utilized to send location and object information. The local network allows for data to be routed to each peer object as well as objects not directly accessible via an intermediary object. The network allows for continuous connection and reconfiguration by finding alternate routes from object to object as objects physical connectivity is broken or its path blocked. The mesh network may operate if it is fully or partly connected to objects in its network. Examples of such a network are shown in FIG. 39 and FIG. 56. FIG. 39 illustrates an embodiment of a mesh network that shows how information, such as services and position acquisition information, may be distributed through the network of objects in a peer-to-peer mesh network.

Wide Area Network

Some embodiments of the invention implement a local peer-to-peer mesh network which allows objects to act as gateways to resources located outside the local objects. Connectivity may be to a local information resource or remote via a wide area network. Information between objects is exchanged locally with individual objects capable to request information from data outside the local network as shown in FIG. 39 and FIG. 56.

### FORM FACTORS ACCORDING TO SOME EMBODIMENTS OF THE INVENTION

In some embodiments, the functionality and services are implemented via two types of positioning engines physical devices:

Stick-on

Spotcast.

For some embodiments, the Stick-On form factor allows for the technology to be easily integrated into existing mobile devices. Alternatively, a positioning engine may be integrated directly into a device using hardware, software, or any combination of the two. The Spotcast are intended for standalone usage and do offer additional services which may not be appropriate in mobile devices such as: object hyperlinking, data gateway and object directionality. Finally, an Ultralite Spotcast provides a miniaturized form factor which can be attached to existing products or animal/child to provide information or location.

### Certain Stick-On Embodiments

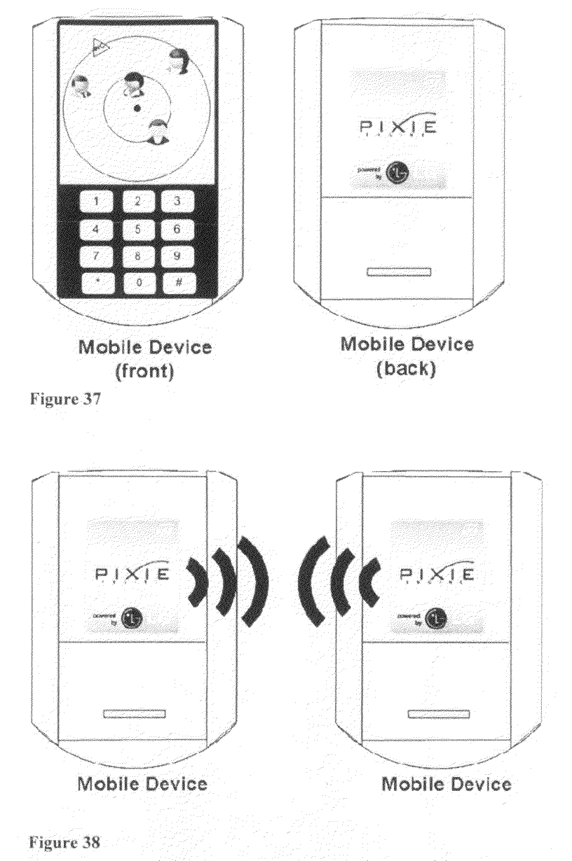

Some embodiments can further be integrated into a physical form factor which allows for the technology to be attached or adhere to existing mobile devices as shown in FIG. 36 and FIG. 37.

The Stick-On provides for the unique marketing methodology of viral marketing strategy where another party may utilize the Stick-On both for functionality and for marketing awareness.

In FIG. 37 shown the Stick-On is physical mounted on a Apple product however such a Stick-On can be applied to any type of device. Certain stick-on embodiments provide both the innovation functionality and a unique viral marketing methodology implemented via a hardware solution.

### Certain Spotcast Embodiments

Certain embodiments provide the architectural components needed to implement object hyperlinking. This is further integrated into a device which may be deployed and attached to static objects in different scenarios as needed either utilizing battery or wired power source as shown in FIG. 33. Spotcast provide the object hyperlink connectivity shown in FIG. 2, FIG. 3, FIG. 4, FIG. 5, FIG. 6, and FIG. 7.

### Certain Information Spotcast Embodiments

A basic device which implements at least some of the embodiments is a “Spotcast.” One such embodiment of a Spotcast device is shown in FIG. 40. A Spotcast creates the object hyperlinking and the information can be stored in the device or it can link into another source of local or remote information.

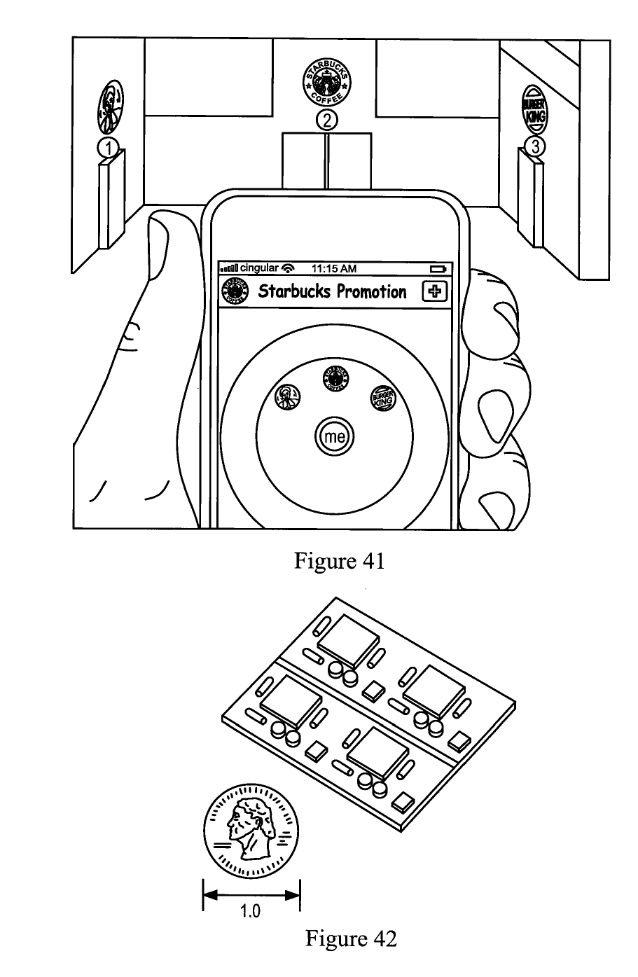

An example implementation of a Spotcast or other static position engine is provided in FIG. 41 where Spotcasts are installed where information is to be made available. In this case, Spotcast are installed at each of locates 1, 2 and 3. Location 1 links to information on the restaurant Kentucky Fried Chicken, 2 links to information on Starbucks and 3 links to information on Burger King. The user views the scene through his mobile device which is also equipped with the innovation. The graphical icons are shown to correspond to the physical location of the Spotcast installed in reference to the end user shown in the middle of the display as “me.”

### Certain Ultralite Spotcast Embodiments

Equivalent in functionality as a Spotcast Information with limited battery life and intended for attachment to other products for quick deployment where the other product will be used as a delivery platform. See FIG. 42. An example of this is attaching an Ultralite Spotcast to a movie poster. When the movie poster deploys, the Spotcast is automatically deployed. This type of Spotcast can also be utilized to tag high value asset, such as child, pet, briefcases and car keys to provide capability of tracking for the end user.

### Certain Directional Spotcast Embodiments

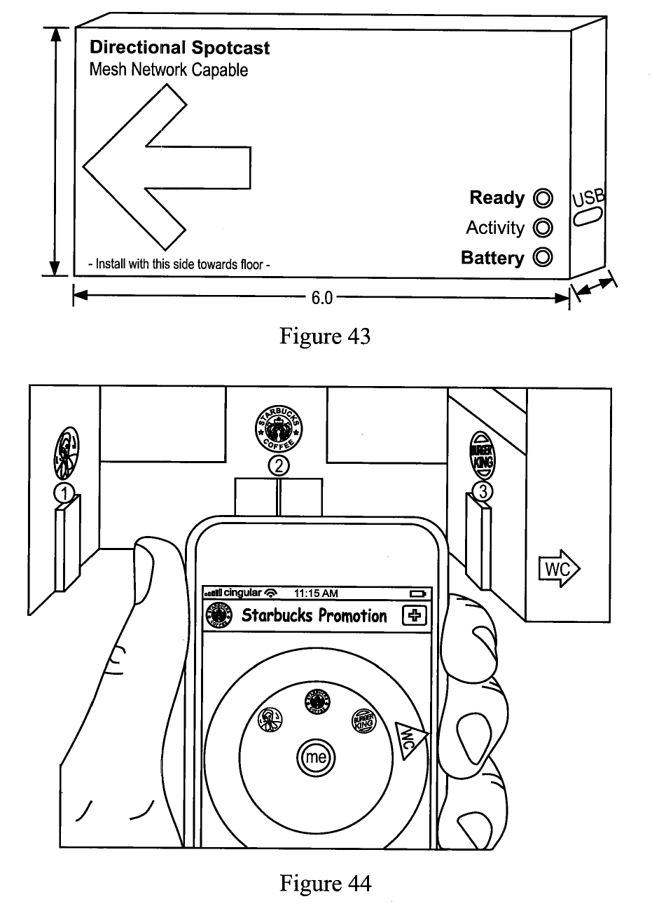

Some embodiments of the present invention can provide direction information to objects in the area which may be used to guide or show the user to the intended location. The basic device allows the innovation to be physically deployed either utilizing battery or wired power source as shown in FIG. 43 The device can store a reference direction to other objects in the area.

An example of an embodiment of a Directional Spotcast is provided in FIG. 44. The scenario below shows bathrooms “WC” located towards the right of the user. A Directional Spotcast is installed to provide a compass direction of the actual bathroom Spotcast.

### Certain Fence Spotcast Embodiments

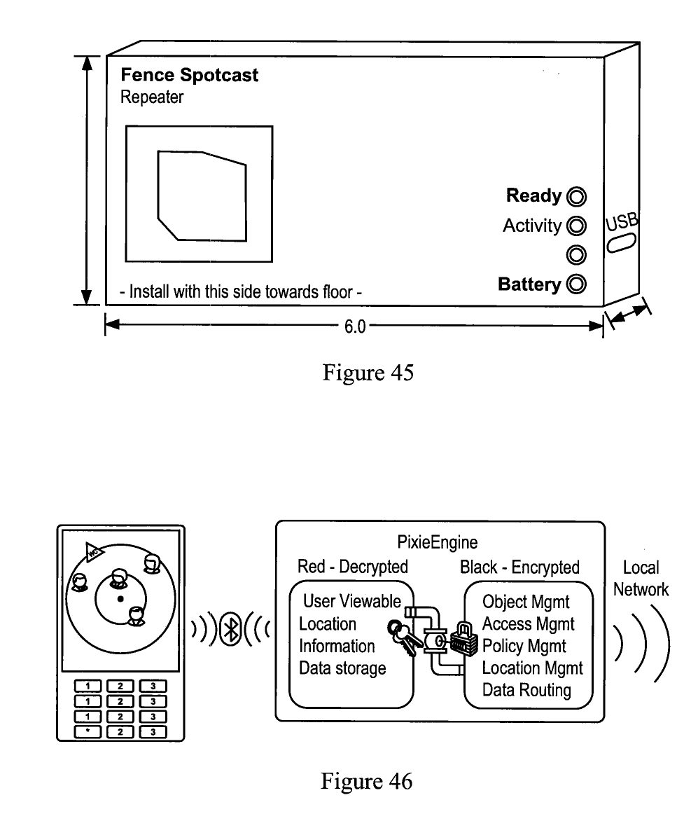

Certain embodiments can store fence boundary information to objects in the area which may be used to alert other objects of zone categories. The basic device allows the innovation to be physically deployed either utilizing battery or wired power source as shown in FIG. 45. The device can store reference geometry to other areas creating safe zones.

### Certain Device Spotcast Embodiments

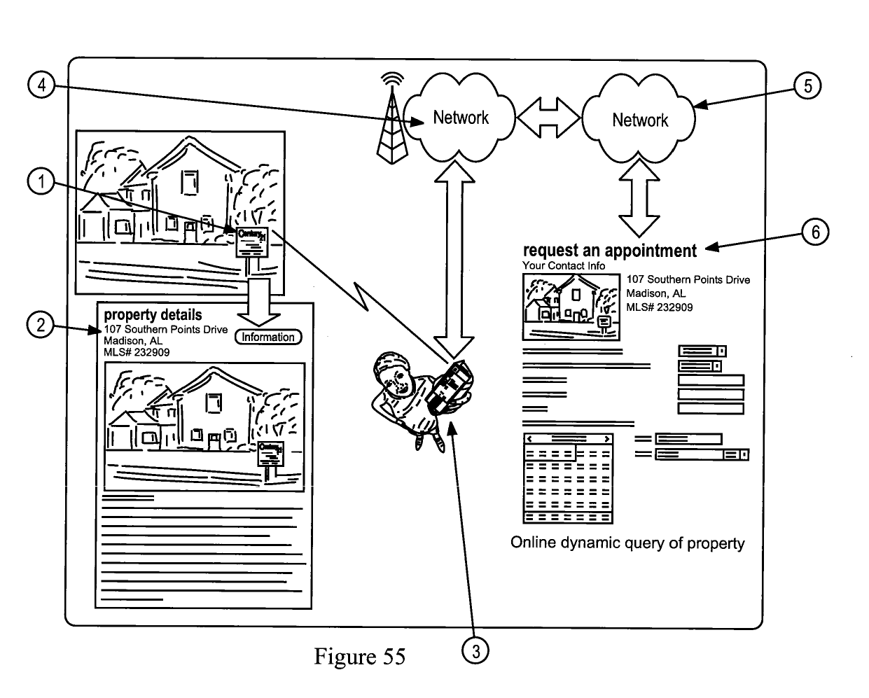

Some embodiments can integrate information between objects and existing devices such as printers or overhead projects in the area. Some embodiments allow for the interaction between device including activating and controlling devices as shown in FIG. 55. As shown in FIG. 55, a user mobile device interacts with a static Spotcast either from local network or incorporating internet service of the device according to some embodiments. Thus, as seen in FIG. 55 a Spotcast on a sign can trigger property details to be downloaded to a user device via a network connection.

### Positioning Engine Processing Functional Blocks According to Some Embodiments

In some embodiments, the architecture is implemented as two parts: stand alone embedded solution and a client application that may operate in a mobile device.

Client Application

For some embodiments, the Client application provides the means to visualize and interact with objects which are accessible by the user. This application operates entirely in the user device.

The client application is intended to operate in a wide range of user devices from low end to high-end multimedia rich devices. In additional, benefiting from the infrastructure-free feature, certain embodiments are operable anywhere in the world, even when existing wireless service providers are not available. FIG. 85 displays positioning system applied to several mobile devices, each of them shows the reconfigurable user interface. The display utilizes the same location architecture targeted to a specific application, such as social networking, military and child tracking.

Embedded Solution

For some embodiments, an embedded solution implements location acquisition, security, search, and data routing outside the access of the user or client application. This provides a privacy separation between the user accessible data and other data which is not intended to be accessed by the user.

The Embedded Solution is internally divided into two sides a “Black Side” which contains encrypted data and a “Red Side” which contains decrypted data. The red/black approach provides a careful segregation between Red and Black data.

Black Side—Encrypted

Data that is encrypted information or ciphertext (Black) contains non sensitive information is operated in the black side. However, the user client application has no access to the black side unless the user key matches and is allowed to pass the key filter. This allows certain embodiments to manage and operate the black side while keeping encrypted data and resources outside user access.

The black side includes management for the hardware resources needed for positioning and communications as well as algorithms for data manipulation as shown in FIG. 46.

Red Side—Decrypted

Data that contains sensitive plaintext information (Red) is operated in the red side. The red side allows for searches to occur within the data fields themselves as these fields are now in plaintext format.

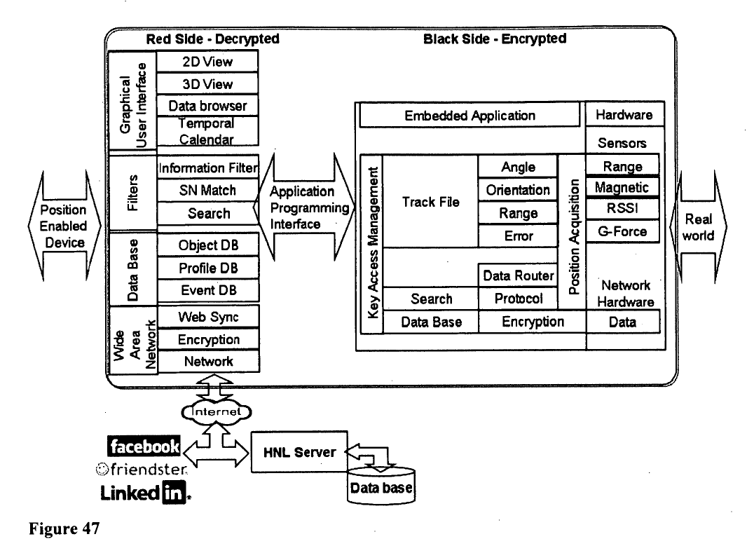

The user device may access the red side via a command protocol between the client application and a positioning engine such as a PixieEngine. The command allows for the transmission of accessible object information into the user device. The different functions are shown in FIG. 47. FIG. 47 illustrates the detailed category and functions of red side-Decrypted and black side-Encrypted of an embodiment of the a positioning system, such as a PixieEngine. In the FIG. 47 embodiment the decrypted side includes graphical user interface, filters, data base, and wide area network. The graphic user interface in the FIG. 47 embodiment includes 2D view, 3D view, Data browser, and temporal calendar. The Filter in the FIG. 47 interface includes information filter, SN match, and Search. The database in the FIG. 47 embodiment includes object database, profile database, and event database. The wide area network in the FIG. 47 embodiment includes web sync, encryption, and network, this module interfaces with a network such as the internet. The decrypted side modules interface with the encrypted side, in the FIG. 47 embodiment. The FIG. 47 embodiment includes on the encrypted side and embedded application, hardware sensors, and network hardware. The embedded application includes key access management, track file, angle, orientation, range, error, position acquisition, data router, protocol, search, database, and encryption modules in the FIG. 47 embodiment. The hardware sensors in the FIG. 47 embodiment include range, magnetic, RSSI, and G-force. Furthermore, the FIG. 47 embodiment includes a data module in the network hardware. These hardware and network hardware modules interface with the real world in an embodiment as illustrated in FIG. 47.

User Key

In order to convert encrypted black information into readable data or plain text, the user supplies a valid key for decoding.

Directions to Points of Interest

In addition to providing location information, the display can show directions to point of interest for some embodiments. These are specialized directional-objects which provide a reference direction to a Point of Interest. These are objects that are orientated towards the direction of the Point of Interest. In addition to computing the location of the object, their orientation is used to provide a vector to the Point of Interest.

The actual location of a directional-object is not important but rather what they are referencing by their direction. Directional-objects are shown on the outside line in the COI with an arrow indicating direction.

Directional objects are programmed through a direction routing table which describes the compass direction to head from the given location.

FIG. 23 shows objects located in two perpendicular hallways (1201) (ID 1) as what may be found in a typical airport. The objects A1 (1200), A2 (1210), A3 (1220), B1 (1225), B2 (1230), C1 (1240) and C3 (1235) are configured as information Directionality is provided in reference to Earth's magnetic north. The objects may be a position engine such as a Spotcast with directionality routing built in. In this configuration, object A1 (1200) (ID 2) directional route indicates that section “B” (1225, 1230) or “C” (1235, 1240) is located east of itself. Similarly, object B1 (1225) indicates that section “A” (1200, 1210, 1220) or “C” (1235, 1240) is located south of itself.

In FIG. 23 a directional object is inserted in the middle (1245) (ID 3) to provide a directional gateway associated with a turn. The directional object indicates that section “A” (1200, 1210, 1220) is west of itself, “B” (1225, 1230) is north of itself and “C” (1235, 1240) is south of itself.

Range is automatically computed for any given direction based on the available information and directional route table. For example, range between A1 (1200) and C1 (1240) can be ascertained by following the directional table and summing the available ranges: R1+R2+R3+R4+R5.

Directional routing can be computed programmatically as well, however, in certain scenarios, programmatic determination may not take into account a particular physical limitation established in the real world, for example a non-working elevator or an obstruction in the path.

Alert to Remote Devices

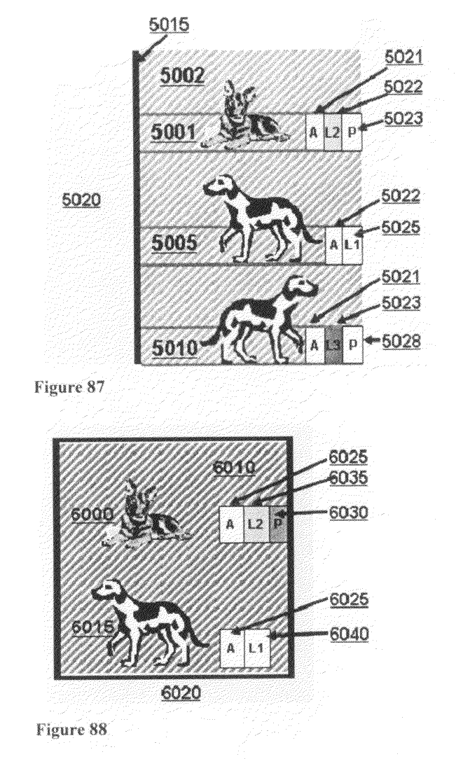

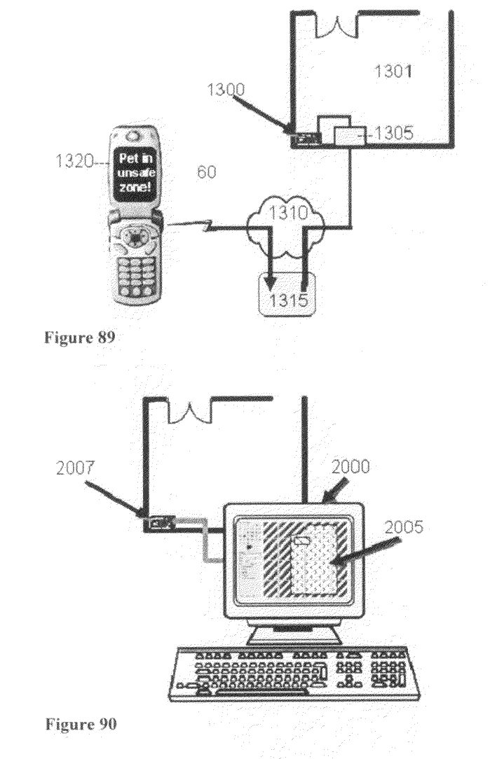

When an object creates an event, an object can be configured to send an alert or message to a remote device. FIG. 89 shows an overview of where a positioning system such as a Spotcast (1300) installed in a building room (1301) is connected to a computer or Internet gateway (1305) which provides connectivity to the Internet (1310). The Spotcast sends a message to a gateway server (1315) which transmits the message over a communication link (60) to the appropriate remote party or user/mobile device (1320) or parties utilizing the programmed communication protocols.

Relationship Discovery:

Each object contains a link to information creating a source of information attributes. Objects relationships can be determined passively by evaluating objects with similar and matching attributes are determined to have relationships or actively by creating supply/demand attributes. Each relationship has a strength value which indicates the quality of the relationship or “how good” the relationship is between the two objects.

For objects linked to personal profile, a passive relationship may be something as simple as identifying other personal profiles who are from the same city. In supply/demand relationships each object provide a list of information which it has available and a list of items is seeking.

On objects with a graphical display, relationships can be viewed by the end user through lines between objects.

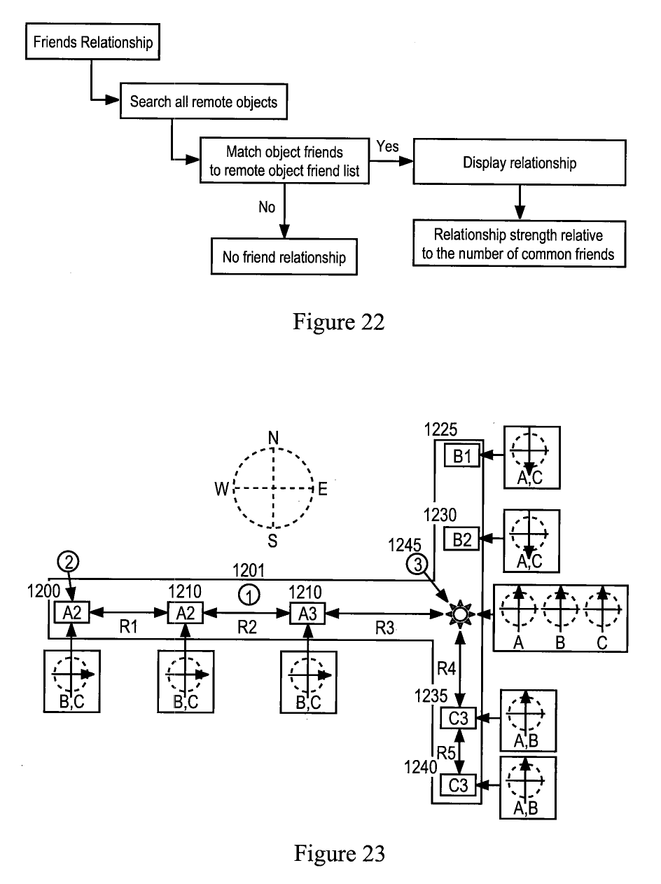

Relationship discovery application can be loaded into the system as software plug-ins to meet specific needs based on the available data. For example a friendship relationship discovery application can search the objects in the AOI and match the remote object friends with the user's friends, thus providing a visual representation of common friends as shown in FIG. 22. Further the relationship strength can be shown as a function of the number of common friends. For example:

TABLE 3

| Number | Relationship | |
|---|---|---|
| of Friends | Strength | Display |
| 1-2 | Weak | Thin thickness line |
| 3-5 | Medium | Medium thickness line |
| 5+ | Strong | Strong thickness line. |

According to an embodiment, the FIG. 22 process searches all remote objects and matches objects friends to a remote object friend list. If there is a match the process displays the relationship and indicates a relationship strength of common friends. Alternatively, if no relationship is found, none is displayed.

Relationship discovery application can be as numerous as the social needs and data sets available. For example when embodiments of the invention are used in a medical conference scenario, specific medical data sets and application may be loaded in order to create unique relationships specific to that group. Relationships shown may be those of doctors who have a common specialty or working on similar fields.

User Display

Some embodiments of the invention provide for the object location, relationships and information to be optionally shown via a graphical display. A display may show a graphical representation of the objects in the AOI or those linked virtually. Additionally, the user interface can show information and relationships between objects in the physical area and those which are not physically present but have a virtual connection.

The location of other objects in the AOI is shown in their relative location from a user device. The graphical display is orientated to match the device physical orientation, the view with the top of the display being “forward” to the user holding the device. Objects which are ahead of the user are represented in their corresponding locations which mirror their physical presence.

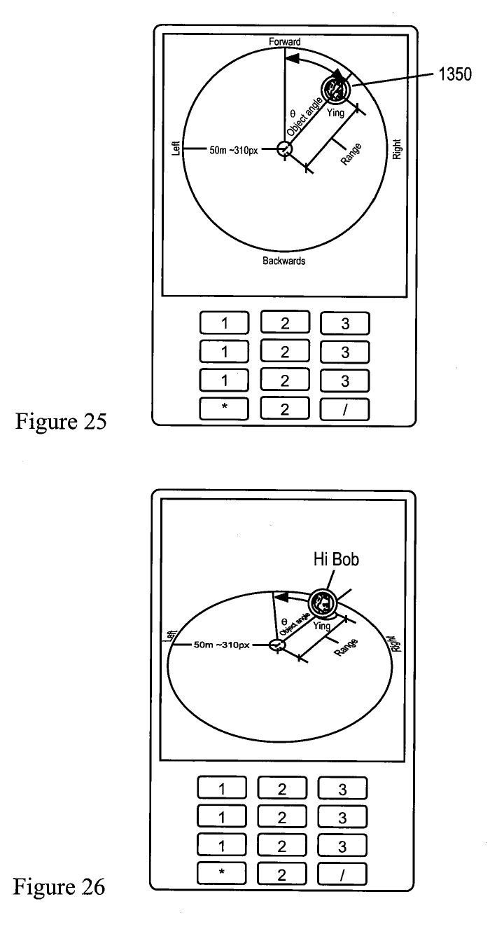

In this example as displayed in a top view in FIG. 25, an Icon 1350 is used to show another object representing a social profile in another mobile device. The Icon labeled “Ying” is a distance away “range” from the user.

The user display can vary according to intended use, however for some embodiments the technology is positioned to provide a “from the above” 2-dimensional and forward looking 3-dimensional view. The 2 dimensional-view shows the object holding the device in the center which would represent “me”. Objects in its AOI are shown at their corresponding position based on the device orientation as viewed from above. Thus, if the user is holding the device pointing northward and an object at 30 meters is shown at 45 degrees ahead, then it is displayed as shown at 45 degrees as in the FIG. 26.

The display can also provide a 3-dimensional view as a projection of 2-dimensional view, with 45 degrees of tilt angle. This projection can be done via such mathematical transformation: display located at (X, Y), moves to new location at (X, 0.7*Y), according to some embodiments.

Some embodiments of the system provide the ability to create height of objects in the user plane. The height can be estimated via computational method of the user plane and object's heights placement based on the user plane or via hard coding. For example, the height of a box is hard coded to be 1 meter above the floor.

FIG. 25 shows a 3-dimensional representation of the 2-dimensional view provides a forward field of view of the user and tilts the user plane in perspective where objects farther away forward are smaller. Additionally, this view can be used to show the height of objects in the display.

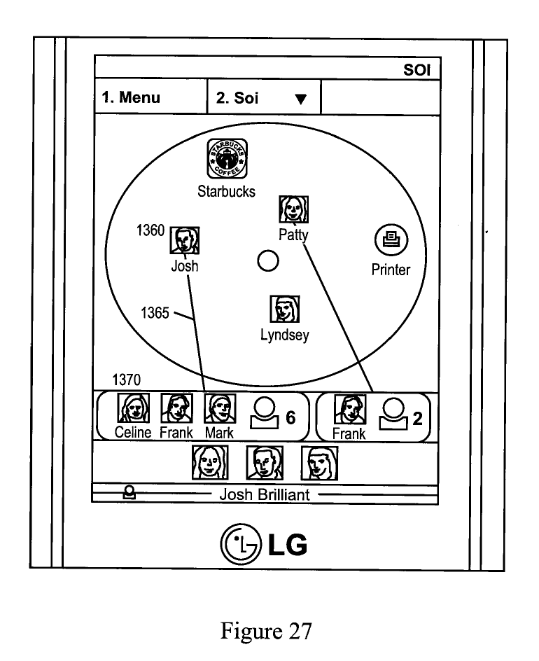

Some embodiments of the invention allow for relationships between objects to be established and may be visualized by showing a line connecting the object and the established relationship. FIG. 27 shows the common friends between the user and “Josh” (1360). A relationship line (1365) between Josh (1360) and a group of individuals matching the relationship (1370) is shown.

In addition to basic information of objects shown by text or icons, users are able to obtain additional information by interacting with an object. As the user selects an object additional pages of information may be shown.

Some embodiments of the invention implement a graphical display using a light client application in Java/J2ME which resides in the mobile device such as phones or media players.

For two dimensional display a circle is shown to represent the top view area of object localization. The radial view coverage range can be programmed and supports zoomed in/out in quadrant or area views.

Range Only Objects

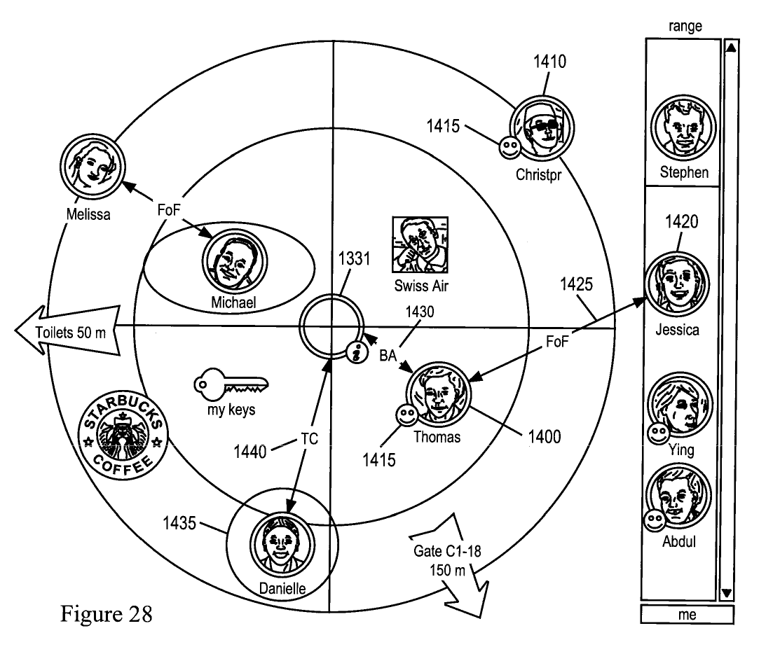

For devices which cannot acquire full localization due to inadequate sensors or poor sensor data, a range-bar can show the range from the user. Range only objects may be shown as a circle within the main area or displayed horizontally or vertically by range as shown in FIG. 28.

Objects Error Display

When integrating to other location systems with larger location errors such as GPS an error profile shadow may be shown to indicate the possible locations of the object. The display can show the location error of each device using a shadow under the icon. This allows for different technologies with larger errors such as GPS to be able to participate with sensors which provide higher location resolution. The shape of the error provides an indication of the possible locations of icon referenced objects/individuals.

Object Graphical Representation

For some embodiments, each object can modify its own graphical representation and be personalized with photographs, drawings, company logos or other media.

Object Gender and Type

For some embodiments, the display shows mobile device gender by providing a background color coding or graphical adjunct to the display in the mobile device icon. As an example, blue is utilized to show the gender male, pink is used for female and gray is used to indicate no gender selection.

Object Group Attachments

For some embodiments, the display shows attachments to other social groups. Attachments can be displayed as a small graphic attached to the main object icon. In FIG. 28, Thomas (1400) and Christpr (1410) both indicate an attachment to Friendster social network group (1415). For some embodiments, this is displayed using a small Friendster graphical icon such as [symbol] .

Mobile Device Orientation

When the innovation provides a user display, the display is rotated using a magnetic sensor to provide a display which matches the real world view relative to the device position.

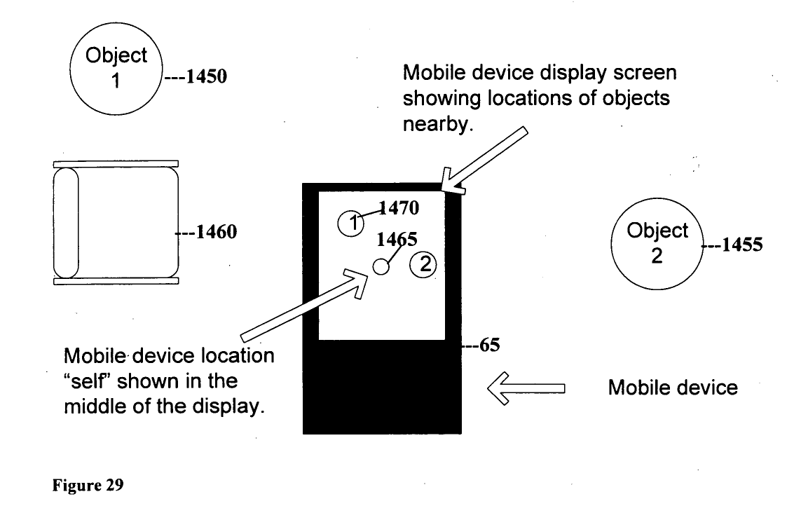

To illustrate this scenario FIG. 29 shows a room with two objects (1450, 1455) and a user device 65 at their approximate relative position. For the illustration a “chair” 1460 has been added to the drawing. The chair 1460 will provide an anchor to show the effects of rotation on the display. The device location is represented by a middle circle 1465 in the device display. Objects are shown around this point indicating their relative position. In the mobile display, Object 1 (1470) is northwest of the user (self) (1465) and Object 2 (1475) is shown east of the user.

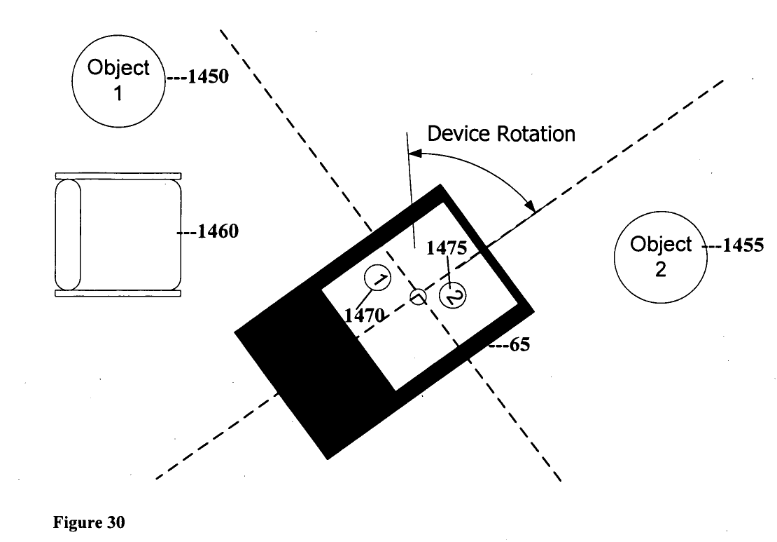

In FIG. 30 the mobile device 65 is rotated and changes orientation. The device sensors are able to obtain the change and provide the graphical display a rotational correction.

All positioning computations are done with respect to “North” returned by the magnetic sensor compass, which is usually not the orientation of device. The rotation equation is the following:

Assume device orientation has angle alpha with “North”, positioning algorithm returned polar coordinates of an object is that:

range=R, azimuth=theta;

then the displayed polar coordinates of such object should be:

range=R, azimuth=theta−alpha.

Displaying said coordinates will match relative position of such object in real world. The display is oriented correctly and objects are shown at the correct relative orientation and position from the user. The diagram shows the device rotation and the new locations of the objects in the device display. Thus the display view mimics the position of the objects in world view.

Profile Display:

Personal Information Profile

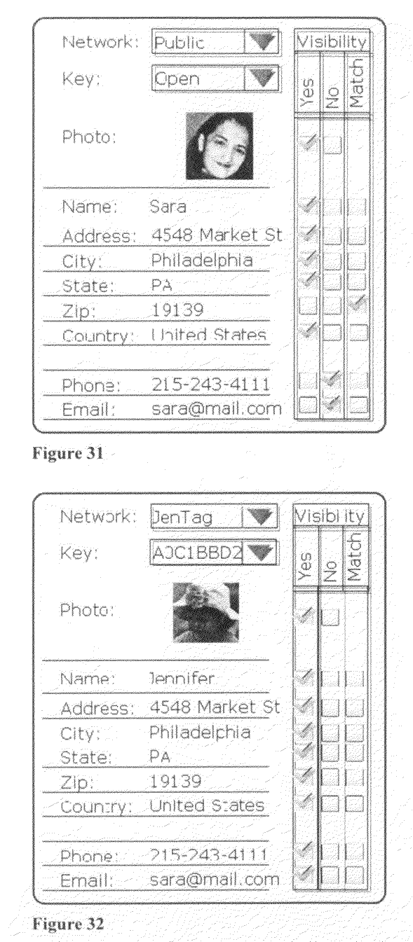

This display in FIG. 31 contains end user information which may be manually input or aggregation from existing social networks. End user can specify the security access levels of the information. Information between objects is shared and that information which meets the access level of the profile is accessible and shown to each user.

Tag Information Profile

An information Tag is a display-less positioning engine 55 as shown in FIG. 32 which may contain object information. For some embodiments, the Tag may be programmed with a child, pet or other information and used as a tracking or identification device. Some embodiments allow for security levels to be set so that information privacy and positional privacy is assured.

Relationships:

Object Relationships

The innovation provides the ability to identify relationships between local objects and virtual objects. The client application display shows relationships between objects via graphical representation. These relationships can show even when objects are not physically present. For example, in FIG. 28, a relationship from the user holding the device to Jessica is shown as a line even though Jessica 1420 is not physically present. This is accomplished by creating relationships and associations between objects and user data base.

Relationships may be shown through different graphical representations such as a line between two given objects with a common relationship.

Relationships can be shown between objects of different location technologies such as between relative location, GPS or range technologies.

Social Relationships

Some embodiments of the invention allows for any relationship to be visualized in user display such as:
Friends
Friends of Friends
Business relationships
Similar interest
Common backgrounds, schools or cities

In the example in FIG. 28 Jessica's icon 1420 is automatically placed there due to the fact that Thomas 1400 is in the AOI and both are common friend to Jessica 1420. The relationship between Thomas 1400 and Jessica 1420 is shown by a line drawn 1425 indicating that Thomas 1400 is a Friend of a Friend (FoF) to Jessica 1420. In addition, Thomas 1400 is also a Business Acquaintance (BA) of the end user so a line is drawn showing the relationship 1430 between “me” 1331 and Thomas 1400 as “BA.”

Another relationship example is shown between Danielle 1435 and “me” 1331. This relationship 1440 indicates that Danielle 1435 is not in the end user database as a friend or acquaintance but Danielle had been within the AOI at some other day(s) as indicated by the data stored in the Temporal Calendar (TC). The color of the line drawn represents how often this has occurred, with “red” indicating that Danielle has been in the AOI many times before. This provides the relationship describing how often users “bump” or have casually been near each other.

Match-Making Relationships

FIG. 28 displays another type of relationships between the end user 1331 and other people within AOI, based on a database matchmaking function.

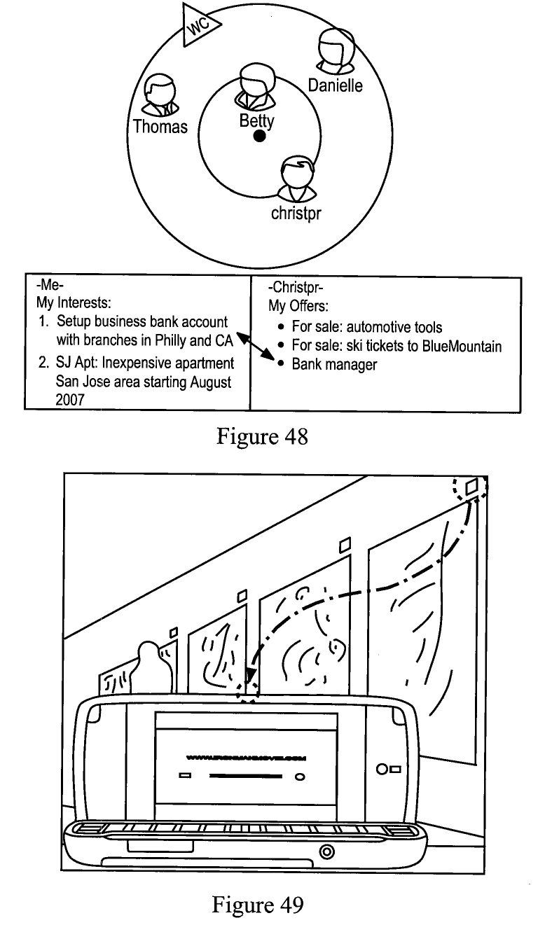

In the display, Melissa's profile contains matching bars shown as green bars on top of her picture. Match bars are part of profiles telling matching percentage of people within SOI. Profiles of people can be categorized into segments such as: Basics (gender, age, height, weight, address, etc); Personal interest (music, TV shows, sports, cooking, etc); Professional profile (education, occupation, company, position, etc). Bars in these segments show how much this person matches user's criteria. FIG. 48 another embodiment of displaying match-making relationships by an interest of “setup business bank account with branches in Philly and CA” as stored in a database is associated to the profile of Christpr who is a bank manager. Thus, according to some embodiments a line is drawn in a display link labeled “bank” to indicate a match for that interest, as illustrated in FIG. 48.

Sale/Trade Relationships

Relationships can further be used to identify or engage in sale, purchasing, bidding or bartering in a localized basis.

As an example, matching links between viewer and Christpr 1415 and Danielle 1435, which is enabled when they provide services, information or items which match my demand. Through this method, user 1331 can identify his/her demand and supply (can be products and services) with his/her profile (not shown on the device). Some embodiments of the invention then searches and identifies these relationships when the user's demand matches objects with the appropriate supply resources. These successful relationships are shown via a link between the two objects. FIG. 48 shows an embodiment where a user's interests are matched with offers or supply resources of another. To minimize abuse by sellers, access to demand list is not allowed to be default. Thus, sellers cannot pre-qualify buyers by accessing their needs before the buyer activates that option.

Relationships Strength

The client application is able to show the strength of the relationship which correlate to the match level for the given relationship. Relationship strength can be shown as a function of a given parameter, for example the number of common friends as shown above in Table 3.

Information Linking and Routing:

Some embodiments of the invention attach information attributes or links to acquired positions of objects, locations or individuals within AOI or with virtual presence, which enables searching, filtering and interacting with objects, locations or individuals. As a gateway bridging positioning and information, this present operations serve to enhance communication, social interaction, information accessibility commercialization and object tracking and identification.

Object Behavior:

General Object Behaviors and Interactions

Object behaviors can be generalized to those which it can receive or send to other objects. Objects can receive data from other objects or send data to other objects at the sender's request.

Examples of this would be to drop a data file into an object such as a music, video or document. The receiving file would then execute its programmed behavior for that data file.

By selecting an object, the requesting object can obtain the data sources the object has to send. This could be a personal profile for an object representing an individual, an image file for an object representing a camera, a document for an object representing a poster in the wall.

These concepts provide the ability to submit data or attach data to a given object.

Activating Object Behaviors

For some embodiments, a user may request object to perform specific behaviors as defined by the object category of behaviors and behaviors which may be added or downloaded to the object. By selecting an object or group of objects the user will be provided a list of available actions or behaviors that may be performed. The user may then select a specific behavior and submit it to the selected object or objects. By default a given set of behaviors are available for each object and new behaviors may be downloaded to the object if the said object allows and accept new behaviors.

Device Object Visual Behaviors:

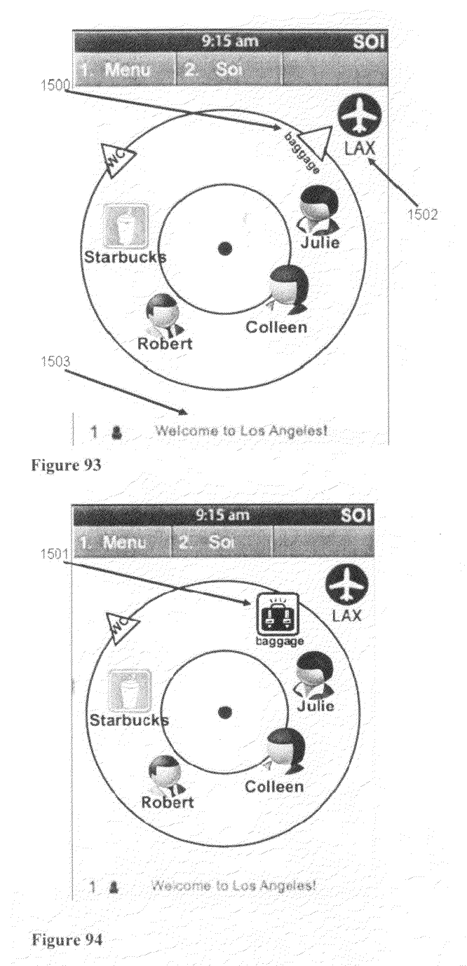

Some embodiments of the invention modify objects visual appearance based on specific object behaviors as viewed by a user display. An object may change appearance based on how it relates to the viewing object. For example, when an object is too far from the viewing area, an object may change its appearance to a directional indicator 1500 as shown in FIG. 93. As the object nears the viewing object and enters the range of view, the object may change to a different graphical representation (1501) as shown in FIG. 94.

Social Interaction:

This service relates to linking social related information to objects displayed as icons on the screen representing individuals or objects of social interest according to some embodiments.

User Interface

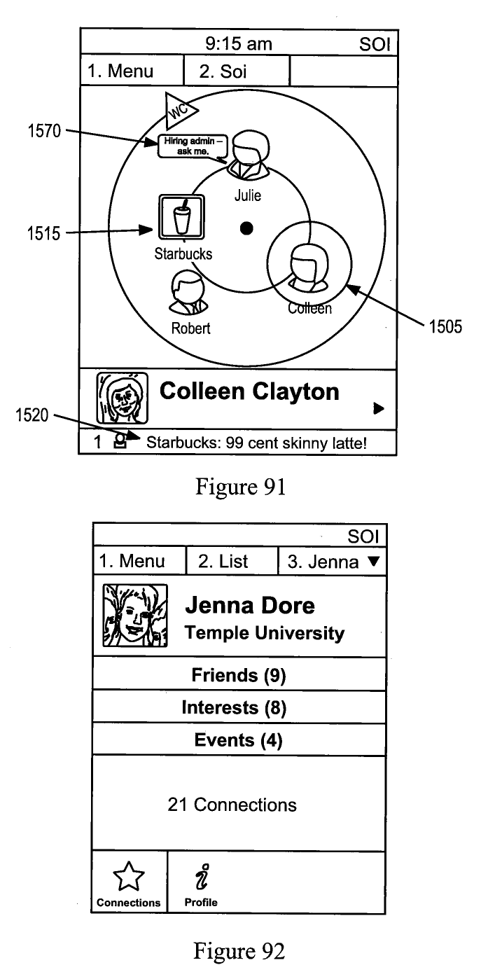

As previously referenced SOI display and profile information, as discussed above with reference to FIG. 27, FIG. 28, and FIG. 29, the connection is initialized by user activating on specific icon and enabled by said information linking operations. For example, FIG. 91 shows a scenario of activating an icon named Jenna Dore (1505), leading to a highlighted profile display of an icon, as illustrated in FIG. 92. The profile, for the embodiment shown in FIG. 92, includes the name with a description of who she. Moreover, the FIG. 92 embodiment lists relationship information such as the number of friends in common, the number and interests in common, and the number of events in common.

Connectivity to Profile Information

Social profiles can be both self generated and integrated, aggregated or synchronized from end users' social networks. This data is downloaded and synchronized to the mobile device periodically, becoming the local internal profile and local social profile. Key profile information is kept locally for sharing, matching and visualization purposes, the full social profile details may not and hence not all original data fields are accessible unless internet service is available.

Accessibility of items in the profile abides by each user's privacy policy and the general hierarchy protocol.

Social Object Behaviors

There are numerous social object behaviors that can be selected on any given object for example: messages, hugs, nudges or giving of other virtual items allows users to touch socially with each other, according to some embodiments. A message could be “interested in coffee?” sent to the object selected. Social Object Behaviors can be sent in real time or at a later time through Temporal Calendar (discussed herein).

Information Service

Navigation

Some embodiments of the invention pertains to using position engines 55, such as a Spotcast, to provide information to assist end users with their desired navigation operations with non-commercial related objectives, such as navigating inside a shopping mall, airport or amusement park, such as discussed above with relation to Directional Spotcast.

Public Object Announcement

As displayed in FIG. 91, a personal note of Katie is attached to her icon (1510) serving as a way to broadcast information to local users. This capability can be utilized for any object in the environment to provide a publicly viewable announcement.

Area Advertisement Announcement

An object can provide a public announcement to inform other objects within its area. For example, applications can (but not limited to) be implemented by information-intensive service providers, such as airport, train/bus station or stock exchanges. Announcement contents are respectively related to flight change/delay/arrival, transportation schedules and stock quotes.

As displayed in FIG. 93, (1503), an area advertisement represented by a graphic on the top corner (non-locatable object) provides information on area around the user location. While the object may not have specific location, the object may provide information with the same capability as other object with location. These objects may be commercial or owned by the facility of which the information is been displayed. The object information announcement may be given to the user as shown in FIG. 93 (1502) Advertisement announcement may general in nature or target specific user based on user publicly available or opt in information.

Object Commercial Announcement

Some embodiments of the invention relates to objects broadcasting information provided and controlled by service provider and commercial who desire to reach their customers, which usually include events, information, advertising and purchasing offered by service provider or commercial. As displayed in FIG. 91, the commercial object identified as Starbucks (1515) has placed a advertisement announcement in the announcement display section (1520). Announcement area information may show information of general interest to the user as well as commercial advertisement as defined by commercial relationships with said companies. Advertisement announcement may general in nature or target specific users based on user publicly available or opt in information.

Based on services types and interactivity they can categorize into the following:

Events, Information, Advertising

Typical examples are streaming movie previews or advertising, visualizing restaurant menu, retail coupons/offers, product advertising, etc for example a position engine, such as a Spotcast, attached to a movie poster inside a movie theater, which provides streaming service about corresponding movie to a mobile handset.

Purchasing, Bidding, Bartering

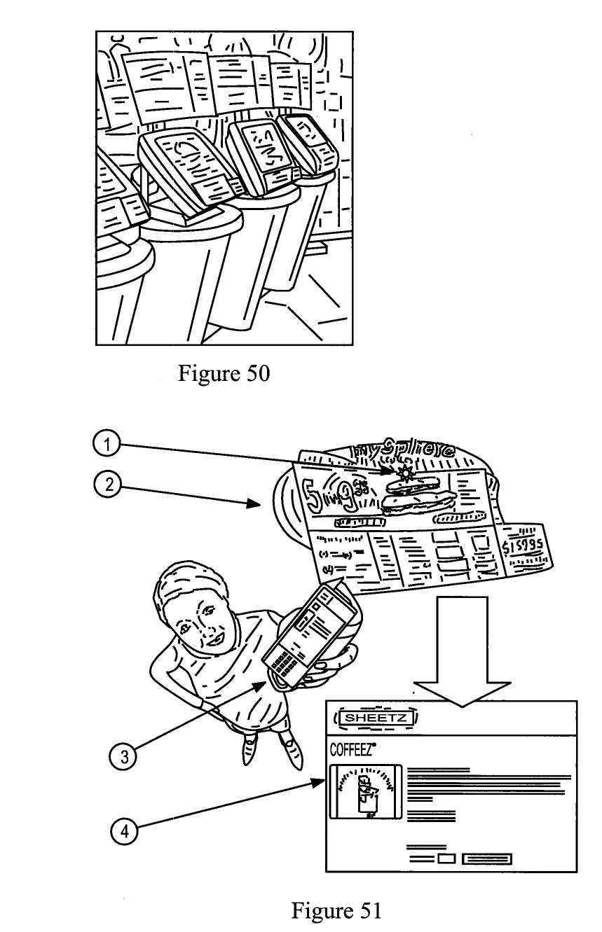

For some embodiments, object linking can provide an interactive approach for to provide purchasing, bidding or bartering of items. FIG. 51 shows a typical example of this application. For example, a traditional kiosk solution, as shown in FIG. 50, is built with specialized hardware platform used usually by retail stores. Along the hardware expense these systems possess a large retail real-estate presence. Ongoing maintenance and upgrading are major difficulties faced by most retailers.

Some embodiments of the invention provide a solution that does not require a significant real-estate present and minimum maintenance. For example, as shown in FIG. 51, a positioning engine, such as a PixieEngine (ID 1) can be integrated into a kiosk or other device which allows a user to interact with the information, such as a store menu (ID 2). The PixieEngine may provide the menu information (ID 4) to the user (ID 3) which can be shown on a mobile display. The user can interact with the object to the extent allowed by the owner of the menu objects which may include browsing information and purchasing.

Targeted Information and Advertising Delivery

Some embodiments of the invention may be integrated within a user device which allows the user to interact with objects within his area. Similarly, some embodiments of the invention may be embedded within information displays which can recognize other objects in their area, thus allowing for display interactivity based on nearby objects. FIG. 49 illustrates an example of a movie poster incorporating a Spotcast provides a streaming advertisement of a movie when a mobile device is detected in the proximity.

Some embodiments of the invention allow the acquisition of unique object which are visible in its area based on security settings. This information is further analyzed to provide the motion of objects as it relates to each other. Hence an object can ascertain direction of movement of other objects such as when an object is moving towards, away or just passing in front. Additionally, objects can share information with each other which may further be used to target information which is of interest to said object.

An example of a commercial application includes a person with positioning engine, such as a PixieEngine, walking in front of an active displayed advertisement. The vector of movement, accessible by the advertisement object through a positioning engine coupled to or near the advertisement, determines that the person is walking in front of the advertisement rather than towards it.

Once the positioning engine of the active display advertisement determines the person vector of movement and that the person is turned towards the displayed advertisement. An embodiment of a positioning system carried by the person has been program to share his location of residence. As he faces the active advertising display the display can target the display information based on his vector movement and the user's available information such as location of residence, interests of the user or other sharable information. The display can then show information specific to the user available information such as his residence.

Resource Sharing

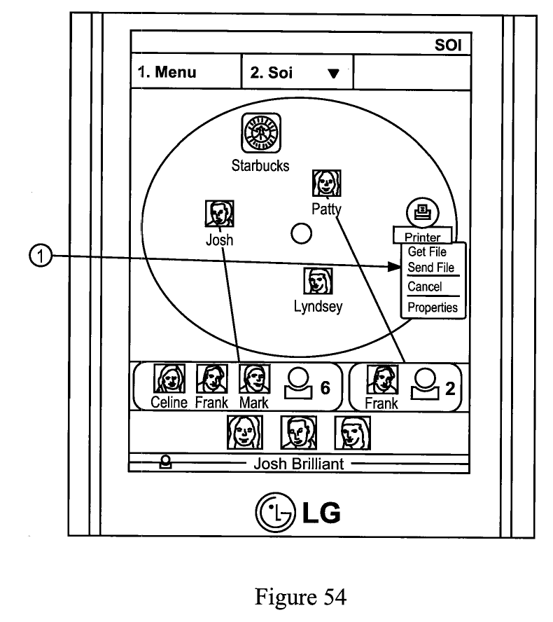

Some embodiments of the invention relate to position engines, such as Spotcasts, attached to objects providing resource sharing to other objects. Example of device objects would include objects that can provide a resource such as printing, projector, media player, or other resource. FIG. 54 illustrates a user interface showing local resources allowed to utilize within AOI according to some embodiments. As illustrated in FIG. 54, a printer resource is available within the AOI of the user of the device and the other objects displayed on the screen of the device.

Resource sharing services allow objects to share commonly used facilities, such as printers, overhead projectors, imaging devices, etc., configured with a positioning engine, such as a Spotcast. Some embodiments of the invention allows for the interaction based on the services each object provides. Services may include activating and controlling devices as resources discussed above. In this example, users submit files to these devices to receive corresponding printing and displaying services. Objects may support a range of general services on whatever data type they support. Example of these data types include:
Office Documents
PDF
Video media
Audio media
Device remote Control such as start, pause, forward or backward.

Local and Wide Area Network

Some embodiments of a positioning engine, such as a PixieEngine, can operate via local or wide area networks. Information can reside locally at each object or object may further reference information accessible via wide area networks. Depending on the location and available resources of each device, the wide area network may be accessed via Wi-Fi, mobile device service provider or other communication technology which operates independently of the PixieEngine. As such, objects with an integrated PixieEngine in a Spotcasts can request access to information locally or via an accessible wide area network.

Different methods of Spotcast communications are shown in FIG. 2, FIG. 3, FIG. 4, FIG. 5, FIG. 6, and FIG. 7. These external network link to services by content/data provider, such as localized information, maps, directions, purchasing processes, item information, nearby individuals, which are not locally available.

A Spotcast can trigger a wide area network request within the object requesting the data. For example, FIG. 55 shows a static Spotcast which does not inherently have access to any wide area network (ID 1). The user may interact with the Spotcast which in turns provides the requested information (ID 2) implemented as a Web page. The user can interact with that page locally in his device which in turn creates a request from his device to access the internet. The user device (ID 3) then establishes a wide area network to his mobile service provider, the Internet (ID 5) which in turns provides the requested Web page (ID 6) and allows the user to request an appointment on-line as displayed (ID 6).

Privacy:

All information linking and routing operations are executed under security protocol discussed as discussed above with regard to Embedded Solutions.

For some embodiments, each object can set up its own privacy policy, under which security of information is correspondingly protected. For example, for a social profile for Sara's, visibility of her photo, name, address, city, state and Country are open to public, while phone and email are disabled from external visualization, and zip code is subject to a “matching” protocol. Such visibility can be additionally customized to adapt to different networks, of which only selected groups can achieve accessibility.

Objects support public access or key encryption. Public access allows objects to openly communicate and become visible to each other. To provide privacy, objects can be encrypted so only users with the public-key can decode that data or location of the device. This allows users to create separated channels of information which are only accessible by those with the correct key. As an example of an object utilizing a PixieEngine tag in FIG. 32, Jennifer's information is viewable only to people within the network “JenTag”, which commonly share the key “A0C1BBD2” to access said information.

Information Overlay:

Some embodiments of the invention relate to input, information overlay and visualization architecture that overlay information within an area which is further provided within the user display. This method enables the placement of information in or around a location of an object. Information may be any data set which is acceptable and viewable by any object in the area. The location of the information in the physical area can be placed via manual input or through programmatic reference to an existing object.

Information Sources and User Input Methods:

Information Sources can include any type which can be graphically displayed or which a graphical representation can be created. Examples of these are text, vector graphics, bitmap graphics, video, self-contain applications which can represent a visible graphic representation of themselves or non-graphical data such as audio which can represent itself via a graphical reference.

Information location may be created as a reference to an object in the area. This location can be programmatically identified, such as 5 meters, 45 degrees from a particular object or by an object moving to the location for which the reference position is to be made.

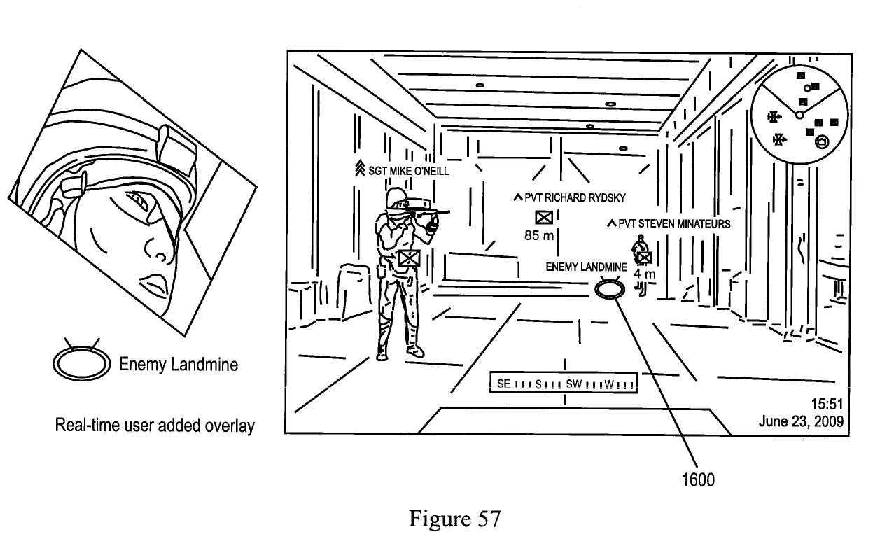

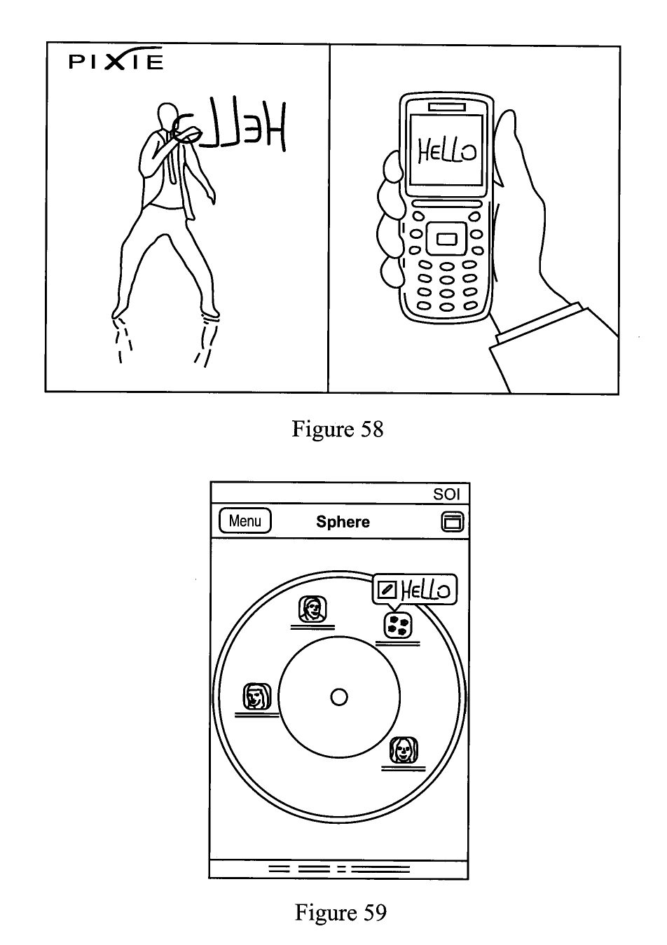

FIG. 57 and FIG. 58 show two different examples of said input methods: as shown in the military urban warfare scenario in FIG. 57, an icon 1600 is chosen from selections to indicate existence of enemy landmine; while in FIG. 58, the end user gestures “Hello” in the air to input the recorded message.

Existing Information Source

The information selected is one from an existing source such as text, vector graphics, bitmap graphics, video, self-contain applications which can represent a visible graphic representation of themselves or non-graphical data such as audio which can represent itself via a graphical reference. The given data set is selected to be placed at a specified location.

Historical Trail

This allows the recording of an object location relative to another object leaving a historical path of positions.

Gesture Input

Through the use of motion sensor a series of device movements are captured into a gesture trails. These gestures are converted into a vector form which can be displayed at a given location.

Information Repeaters

Due to the nature of the limited communication ranges through wireless channels, such those using 2.4 GHz frequency, a positioning system can be susceptible to signal reflections and full obscurity by objects within or around the building. This would create possible areas in which the signal may not reach a given area at all or the signal is evaluated incorrectly giving incorrect location of objects or overlaid information. FIG. 74 shows a scenario where a positioning engine, such as a Spotcast (1650) is installed within a building (1650.) The building has objects which provide full obscurity to the signal (1655, 1660.) The area of obscurity is shown by the darken areas (1670, 1675)

Some embodiments of the system are designed under a cooperative network topology and additional objects in a given area improve areas coverage even the objects in the area has no access to each other's information due to security settings. However in certain circumstances an area will not have additional objects in which case repeaters need to be installed to cover the full area.

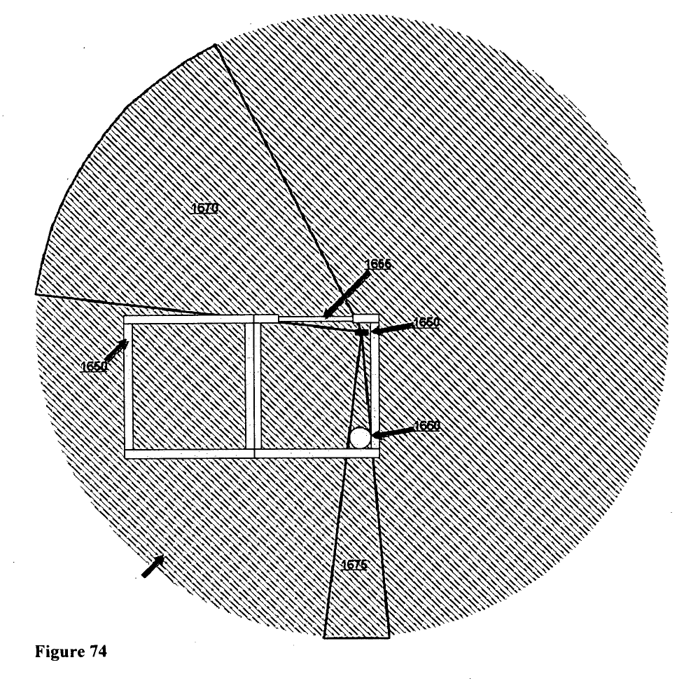

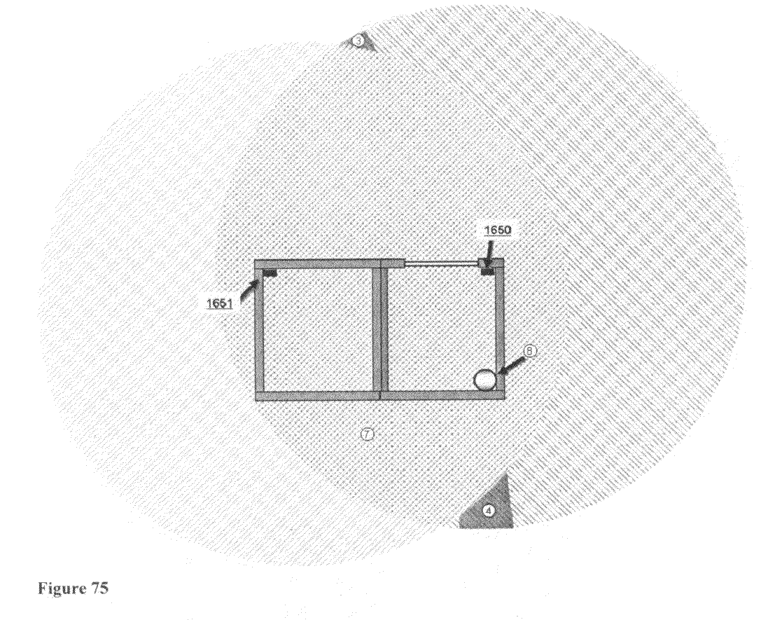

FIG. 75 shows the cooperation between two, positioning engines, such as a Spotcast (1650, 1651). As shown in FIG. 74 Spotcast to the right (1650) was susceptible to large obscurity area (1655) which is now covered by the Spotcast to the left (1651) Under this configuration both Spotcast cooperate to provide full coverage to the area. FIG. 56 shows both the object managed local/remote information and mobile device managed local/remote information according to some embodiments. The mobile devices in FIG. 56 operate as a peer to peer local network to transmit position information and other information from one device to another. Moreover, as shown in FIG. 56, one mobile device may access content and service via another mobile device connected to a network.

Display Information:

After information is selected or created a the information may be shared with other objects in the area which may then overlay the information within their device display, said visualization architecture, according to some embodiments.

Display Effects

Information may be visualized by the user display with static or dynamic effects controlled by end users, according to some embodiments.

Accessibility

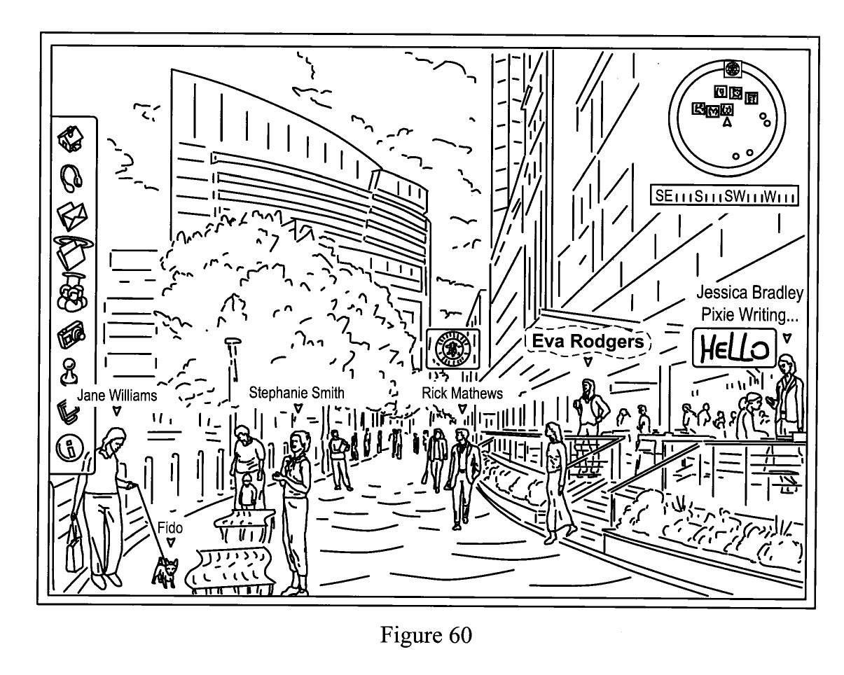

End users are enabled to created information to be viewable to selected groups, or individuals, according to some embodiments. For some embodiments, a positioning engine may required a positioning engine, such as a PixieEngine specially equipped to generate gesture icons, but visualization of those icons are not limited to said version, such as illustrated in FIGS. 59 and 60. In addition, end users control the termination of the display, including time and fading effects.

Information Position Options:

For some embodiments, information is localized relative to existing objects in the area and may have one of the following attributes: static, relative, programmatic. Relative attribute refers to information location with a fixed reference location from a given object. Static attribute allows the information location to be placed at a static location. Programmatic attribute allows the location to be changed.

For some embodiments, a static attribute may be used when information is to be placed at a fixed location independent of the position of the object used as a reference. For objects which are mobile in nature this method allows for the information to be fixed at the static location even if the mobile object moves.

For a mobile object, a relative attribute in information would allow the information to move at a given relative position of the object as the object moves. This allows the information to follow the movement of the object.

A programmatic attribute would allow the location of the information to change dynamically based on some external positioning algorithm.

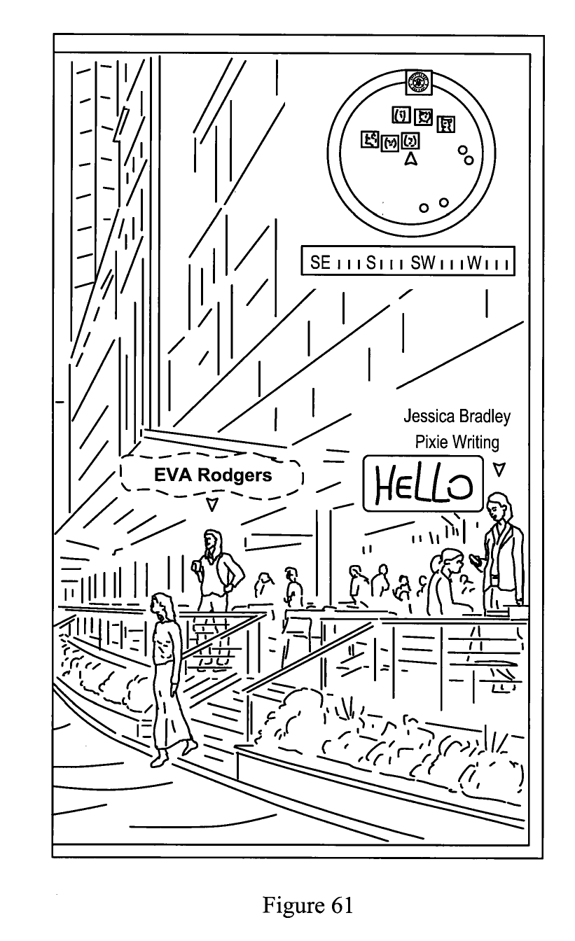

In the example shown in FIG. 57, the icon representing enemy landmine 1600 is attached to certain location as displayed. While in the other example displayed in FIG. 59, FIG. 60 and FIG. 61, an attached gestured “Hello” is shown in the vicinity of the gesturer.

Information Behavior:

For some embodiments, information placed within the area may further be attached to behaviors. These behaviors may be used to trigger events based on particular situations. For example, information may be placed at a given location which generates an event whenever other objects come within a given range of that location. Information may be represented as a line vector in space or a geometric shape which may be utilize to indicate areas which would similarly create events based on the locations of objects within the geometric shapes. For example, an event may be generated when information contains a geometric line of which other object may cross.

Information behaviors can be attached by any object which can visibly see the information. Thus behaviors may be created by those objects who are not the original owner or creator of the information.

Object Entering or Leaving the AOI Activation Event

As the user traverses the path, objects may come into view within the AOI. These objects may be linked to actual physical objects or to other people. FIG. 71 illustrates the user walking from the initial point (1700) and the second point (1710). The SOI displayed is shown to the right indicating the position of the object “me” as shown (1715) The AOI has been filtered to cover a 5 meter area (1720.) This allows events which come into view within the 5 meter area to be processed by the SOI. An object within Starbuck has been hyperlinked as shown (1725) In the initial position (1700) the Starbuck's object is farther than the 5 meter filter, and no events are generated. In the second position (1710) the Starbuck's object comes into view of the SOI and an event can be generated.

Events behaviors can be triggered when objects enter or leave the AOI.

Path Activation Event

For some embodiments, Information overlay can include a path activation event which indicates the deviation from an object trajectory compared with the intended path. Event activation can trigger events based on the object trajectory deviation compared to the intended path. As the object deviation increases beyond the registered parameter events are created at a programmed periodic rate.

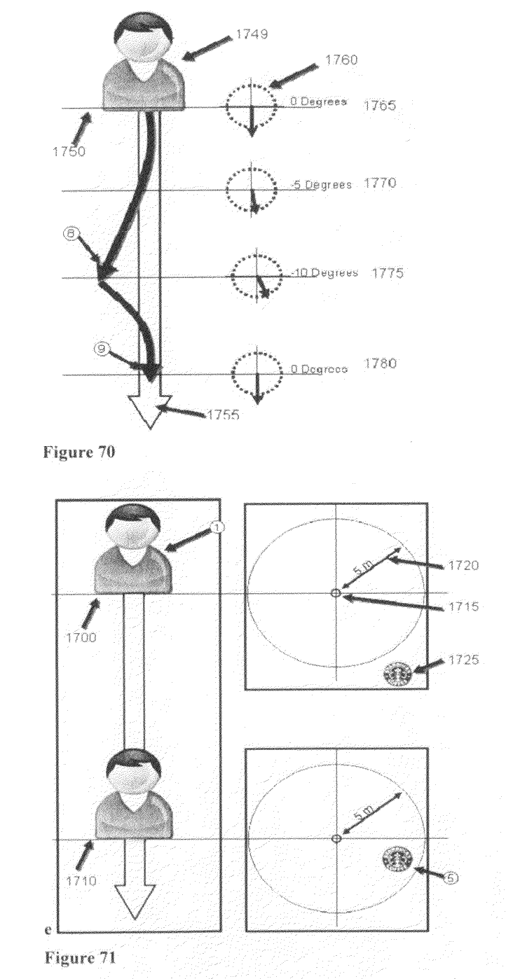

FIG. 70 provides a graphical display of an object (1749) traversing a given path (1755.) The compass diagram is shows (1760) indicating the deviation from intended direction by the object (1749.) The diagram shows the position of the object at 4 different locations (1765, 1770, 1775, 1780). As the object (1749) moves forward to its first position (1770) the object deviates by 5 degrees from its intended path. In the next position (1775) the object deviates by 10 degrees from its intended path. This information creates events indicating the trajectory error to the object (1749). The object can then implement a corrective signaling to the user. By doing so, the user has the ability to correct its position as shown in the last position (1780.)

Path Activation Event Behavior

As an example of a behavior attached to the path activation event is the creation of a periodic tone whose frequency or phase shift is synchronized to the error of the heading direction.

For FIG. 70, an example behavior may provide a tone at 440 Hz when the user traverses the path correctly. As the user error increases the frequency changes. For example for the second position (1770) the error of −5 degrees can trigger a tone of 420 Hz and 400 Hz for a −10 degree error. If the user direction diverges in a positive direction, then the tone may increase to 460 Hz for 5 degrees and 480 Hz for 10 degrees. The error to frequency mapping may vary based on implementations however the example shows how certain embodiments can be utilize to provide feedback based on a deviation from a given path. Other events types may be triggered by certain embodiments which may provide other approaches to provide sensory input.

Fence Overlay and Programmable Behavior

Some embodiments of the invention provides the methodology to create fence areas via geometries, such as polygons and circles which can link to specific behavior to indicate when an object is within an area which can be labeled as allowed or excluded zone.

The behavior which is attached to the fence overlay may trigger local or remote events. This allows the complex shapes to represent areas in which objects are allowed or not allowed to be located.

Fence Overlay Relay

Some embodiments of the invention provides the methodology to copy a given overlay geometry to nearby positioning engine, such as a Spotcast, in order to cover an area which wireless signal may not reach by the original master Spotcast. FIG. 76 shows a scenario in which the master Spotcast (1800) copies the overlay to the Spotcasts nearby (1810) in order to provide a reliable coverage around the building.

Zone Overlay Types

Fence overlay geometry can create user defined polygons or circles, which contain an inside and an outside area that can trigger events, according to some embodiments. These areas can be assigned to specific behavior based on the desired outcomes. For example in FIG. 78 shows a simple rectangle overlay with an allowed area inside marked as 1850. Similarly, FIG. 79 shows a circular version of allowed area inside as 1850. As long as the tracked object is within the inside allowed area marked as 1850, no events are created. When the tracked object moves or remains in the area marked by 1851, then a specific alarm event can be triggered. In this example, the containment area is fixed against the position of the master Spotcast in FIG. 76 which creates an object containment area around a building.

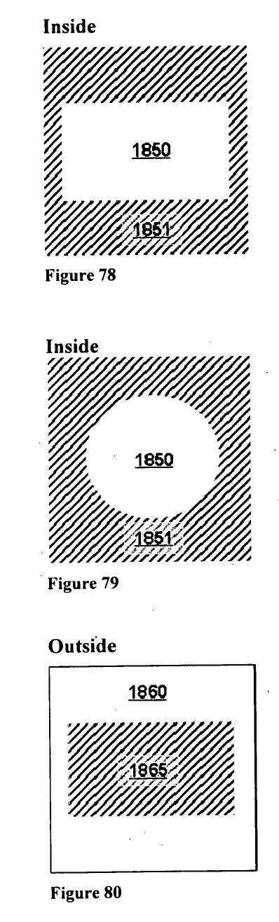

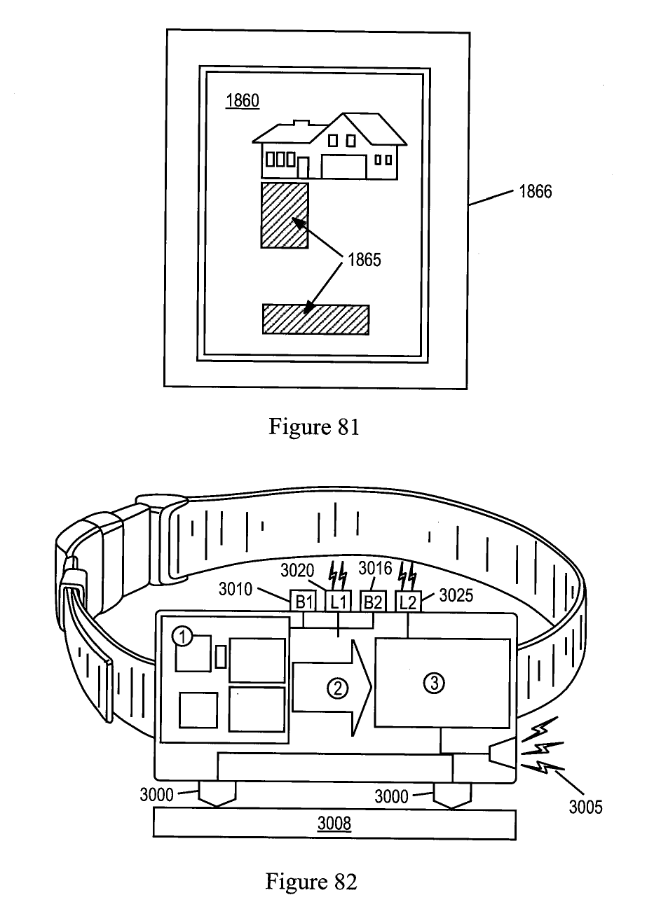

A more complex scenario is shown in FIG. 81 where there are multi-zone environment with excluded zones within an allowed zone area. In this scenario the outer most excluded zone is considered excluded Zone 1 (1860) since it relates to the final boundary area. Each excluded zone within the allowed area is marked as excluded Zone 2 (1865). A third type of excluded zone involves the ability to integrate a height to the zone, as illustrated in FIG. 101. These then become a volume of space which objected detection will be established. Concerning height acquisition has been intensively discussed above, of which both the preprogrammed height method performs and 3-D geometrical positioning based on movement can perform in defining said third type of excluded zone.

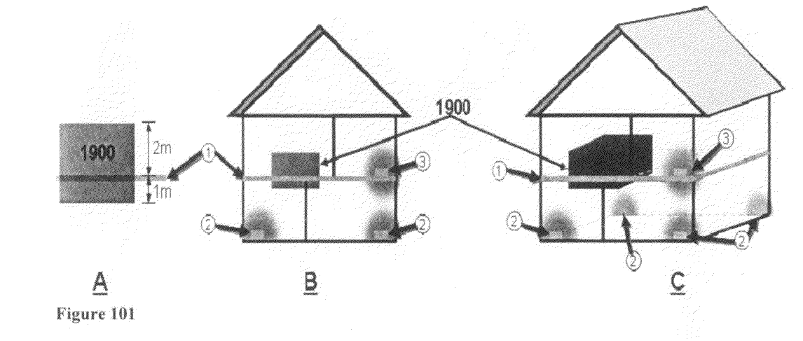

Excluded zone 1 or 2 is automatically attributed to the same functioning height as the signal can reach, illustrated in FIG. 100, while the third one is individually customized by user input subject to 3-D configuration.

In the example shown by FIG. 101, on the second floor, a plane above the initial rest four Spotcast, one additional Spotcast is placed to secure coverage of signaling susceptible to interior blockages. The Spotcast can automatically estimate its height or be programmed to store and broadcast its estimated height by the end user. The same mechanism enables end user to further input a height range of distinguishable value to him/her, such as the estimated distances between two floors. A detected fence overlay geometry which has the same height range with preprogrammed Spotcast thus can be set up to function within this height range, shown in section A indicates the Zone 3 (1900) height which is the height of the volume through out its 2-D geometry. In this example, the height is configured to be a total of 3 meters. To make sure that the Zone can act properly on most application, 1 meter of the Zone 3 is started at the ground level of the second floor (1), so that 1 meter is shifted to be under the floor as shown in section A. This is done to provide adequate coverage and to account for imperfections when the user defines the Zone.

FIG. 101, section B shows the house viewed from the front while Section C shows a perspective view of the house demonstrating the volume which Zone 3 (1900) occupies. In this example, on the second floor, one additional Spotcast (3) above the initial four Spotcast (2) is placed to secure coverage of signaling susceptible to interior blockages. Said Spotcast can automatically estimate its height via 3-D positioning algorithm using the first floor base Spotcast as a reference plane or be pre-programmed to store and broadcast its estimated height by the end user.

Containment may also be triggered based on an object entering an excluded area surrounded by an allowed area. In this scenario the outside area is considered allowed and the specified area should not be entered by the object. For example, in FIG. 84, the swimming pool 1805 is an area within the yard area which should not be entered by an assigned object, such as the young lady.

Creating a Fence Overlay

Numerous methods are available to create the fence overlay geometry. Fence geometry may be designed to be static on a given location, dynamic around a given object or via programmatic method which may dynamically update or change the geometry.

Activating Fence Overlay Behavior

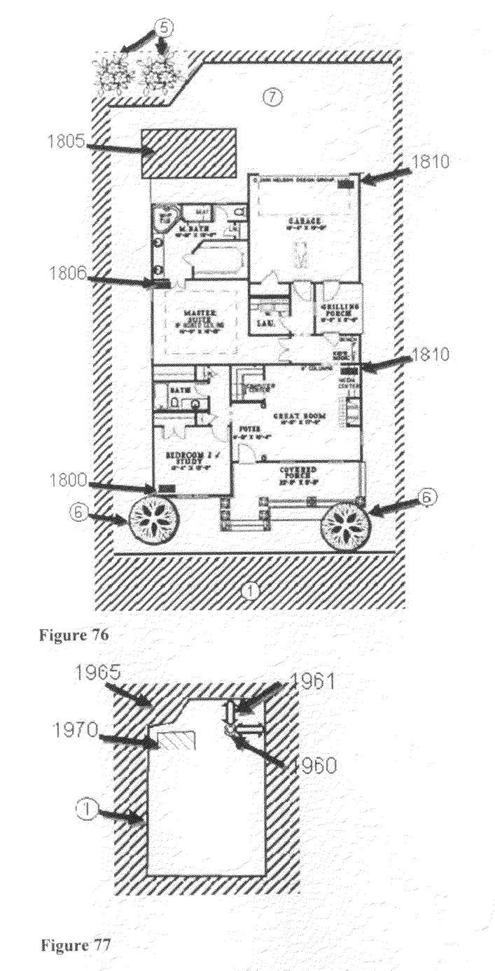

Certain embodiments computes the distances from the fence to an assigned tracked object FIG. 77 (1960) and enables the event behavior associated when the object reaches the fence line or a behavior which relates to the fence geometry. The fence geometry overlay may include irregular areas as those shown in 1965 as well as inner areas which are marked as excluded as shown in 1970.

Static Event Activation

Certain embodiments establish position and proximity of the track object (1960) from fence overlay geometry as shown in FIG. 77 which an associated behavior is established. The behavior triggered can be a simple alarm indicating the object is inside or outside an allowed zone. Additionally the behavior can providing increased levels as object approaches fence overlay. This multi-level event can be associated with local or remote signaling.

Allowed Zone Behavioral Feedback Event Activation

Alarm triggering zone can be programmed utilizing the track object behavioral feedback which can apply when the object is within a given zone, according to some embodiments. Given a particular activity level or movement of the track object can directly affect the events triggered by certain embodiments. Certain embodiments are able to appropriately determine the movement type, velocity and proximity of the object to the fence and trigger the appropriate response.

Excluded Zone 1 Behavioral Feedback Event Activation

Alarm triggering zone may need to meet unique objectives when the object is already inside the zone which represents the outer boundary as represented by 1866 in FIG. 81. In this case, specific object characteristics may be programmed to provide the desired results. Certain embodiments provide the ability to program circumstances inside or outside the zones.

Excluded Zone 2 Behavioral Feedback Event Activation

Alarm triggering zone may need to meet unique objectives when the object is already inside an excluded zone located or surrounded by an allowed zone as represented by 1865 in FIG. 81 and FIG. 80. In this case, specific object characteristics may be programmed to provide the desired results. Certain embodiments provide the ability to program circumstances inside or outside the excluded zones.

Fence Overlay Geometry Modifications

Some embodiments of the invention allows for the fence overlay geometry to be created or edited manually or programmatically. FIG. 90 provides an example on how to create or edit the fence overlay geometry with a device such as a computer (2000) or another user device connected to a positioning engine, such as a Spotcast (2007) which can then access the memory area for the geometry information. The data may be create or edited via a software application (2005) which provides a visual representation of the geometry or programmatically.

Rating Service

Users can rate other objects such as users or service providers and overlay that into the profile stored in their own device, according to some embodiments. Users can select to display rating of other users and objects in their display.

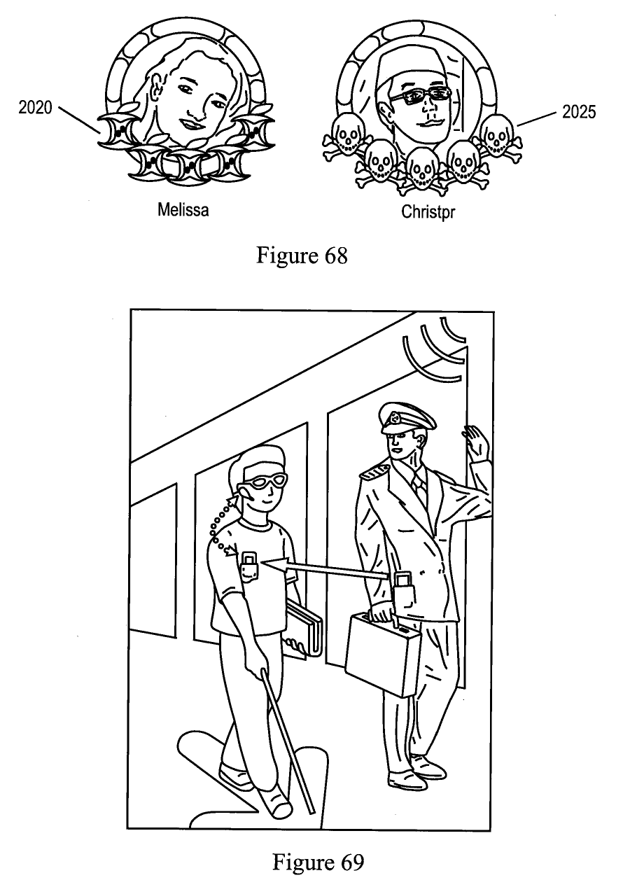

When rating objects publicly, the rated object may be able to accept a rating request. Each object been rated publicly has the capacity to selects the rating icon that others can view and rate which provides an iconized representation of the rating. Examples of icons may be apples, bananas, knives, pirates, etc. FIG. 68 shows an example of the rating display and icons shown as apples (FIG. 68, 2020) and skulls (2025).

The methodology supports a rating system which may be anonymous or provides the rater's identification information based on the rated object configuration. Rating points system is cumulative and may show the average rate given to that object. Users can only rate other users or objects once per given rating icon type.

Object rating results can be further categorized and filtered to be computed based on known sources such as friends rather than on those sources which are not known to the end user. This provides a rating based on sources which the end users can attribute a trust to the information. The rating may be automatically computed based on the end users' activities to the corresponding sources, specified friends on a profile or people which end user communicates often, or may be manually selected individually.

This methodology provides the ability for an end user to see the rating of an object (restaurant) or person based on average of all users' ratings as well as the ratings based on his trusted social network (friends.)

Comment Service

Similar to Rating Services provided, some embodiments of the invention include a methodology to add comments on particular objects privately or publicly. When rating public objects, the commented object may be able to accept comment requests.

The methodology supports comments which may be anonymous or provides the user commenting identification information based on the commented object configuration.

Object results can be further categorized and filtered to be computed based on known sources such as friends rather than on those sources which are not known to the end user. This provides a comments based on sources which the end users can attribute a trust to the information.

This methodology provides the ability for an end user to see the comments of an object (restaurant) or person based on all users' ratings as well as the ratings based on his trusted social network (friends.)

Temporal Calendar:

Some embodiments of the invention provide the means to record events and information which are visible within its environment. The events and information are recorded into a temporal database which includes the time and date of which they occurred. These events can be searched or displayed at any time recreating the environment which occurred at the given time. Further the temporal database may include tags which provide the means to identify specific events of interest.

For user device, the temporal database provides an integral part which records the events and information visible thus becoming a diary of the users' daily activities. The user may select to add tags these events to highlight a specific event of interest. The user may select to play back the temporal database by selecting a particular date and time or search for information such as a contact name and identify when that contact has come within the AOI.

Display and Search

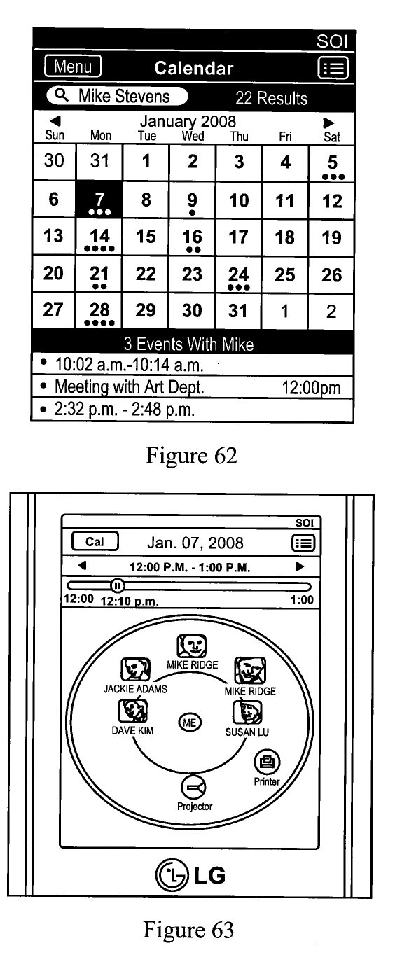

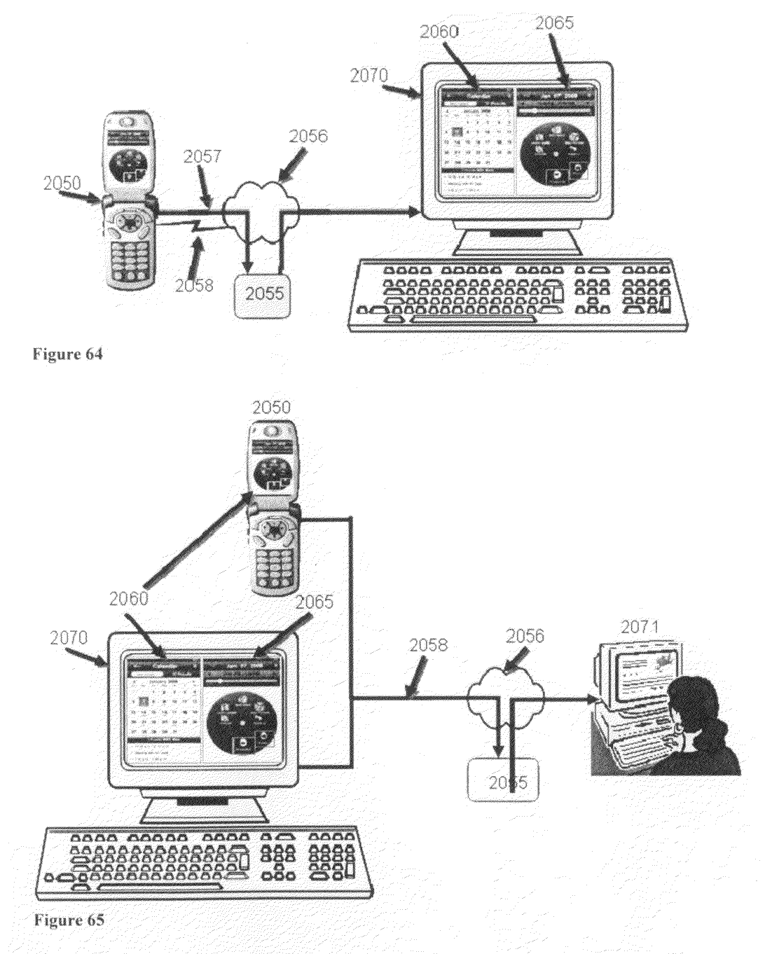

Said database may be displayable in SOI mode, such as illustrated in FIG. 63, which shows the objects date/time mode FIG. 62 search engine mode or through a third party application. As shown in FIG. 62, an example of a date/time mode display of Temporal Calendar, which shows the results on a calendar when the device was in the same AOI as an object, Mike Stevens. Furthermore, events that Mike Stevens had in common with the device are presented on the bottom of the display in FIG. 62. Moreover, FIG. 63 shows a SOI mode display of Temporal Calendar that displays all the objects in the same AOI as the device on particular date and time range. The SOI display provides a way to recreate the scene at the given time recorded. A particular business meeting from 12 pm to 1 pm, Jan. 7, 2008 is recorded into the corresponding date in the Temporal Calendar. When clicking on that date, the exact display (including who were attending, where they were relative to user) is available to be viewed. The reconstructed display records the relationship and information linking as the original one rather than a static representation of the scene. For example, on the business encounter-activating the icon representing Mike will provide the information linked by the icon, thus Mike's profile.

The search engine provides the ability to search any categories which are accessible to the object, such as contact name, event, locations, etc. In the same meeting example, by searching the contact name “Mike” in the temporal database, all encounters matching the contact name “Mike” will be highlighted.

Remote Aggregated Storage

Some embodiments of the invention enable the temporal calendar to be uploaded into a server which allows for additional storage, services and connectivity with other resources including internet and intranet as shown in FIG. 64. The most current events are stored in the temporal calendar found on a positioning engine object, such as a PixieEngine object user device (2050) The database can be uploaded to a server (2055) via a wired or wireless connection (2057, 2058) to a WAN or Internet. The temporal calendar is aggregated into the user's existing calendar. The aggregated calendar (2060, 2065) can be accessed via a user device (2070) web site. The aggregated calendar can further provide integration to other Internet or intranet sources.

Delayed Interaction

Certain embodiments enable end user to interact, contact, communicate or send information to other objects via a delayed interaction which may occur at a later time via the data stored in the temporal calendar. This function allows for end users to send information or activate an object by accessing that object in their temporal calendar database. This functionality requires the object to access a server which acts as a gateway between the object. FIG. 65 provides an overview of the system.

The end user utilizes a device (2050, 2070) to access the data in the temporal calendar database (2060, 2055.) The device is further connected (2058) through a WAN or Internet (2056) to server which acts as the gateway (2055.) This gateway converts the user ID's in the temporal data base (2060) with the registered information (2071) in the server contact data base. This is done without providing the contact data to the requesting user (2050, 2070). Thus this methodology allows for a message to be sent without exposing the contact information of the receiving user (2071)

Hierarchical Visualization:

Visualization

Some embodiments of the invention relates to hierarchically enhanced visualization architecture for display method of people or objects. This method enables end user, which includes both individuals and service providers, to view and filter other people or objects within their sphere of influence area (profiles and relationships) possessing equal or lower hierarchy status. Further, this methodology can be used to provide users privileges offered by service providers at selected hierarchy levels.

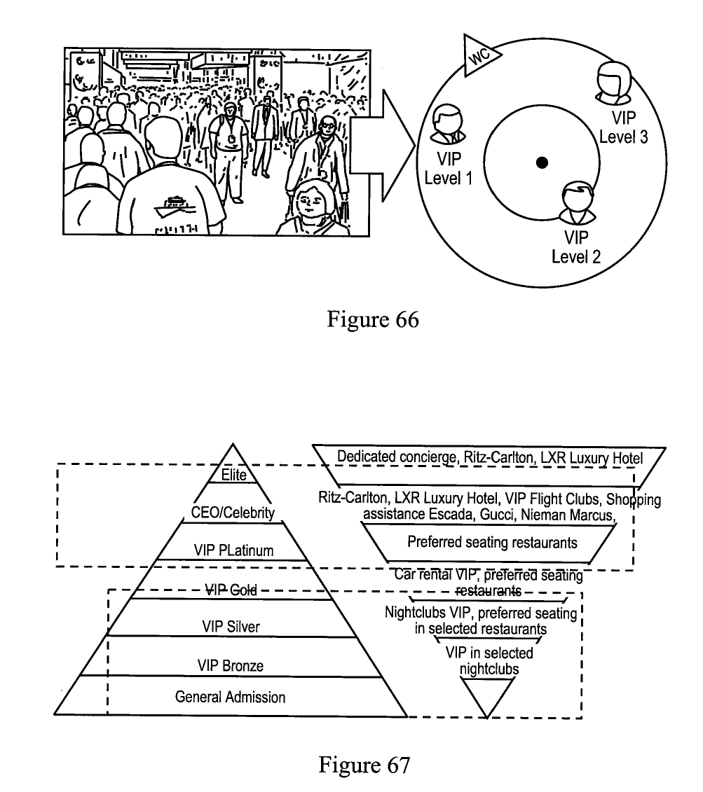

A clear example can be seen in a crowded area shown as FIG. 66. Here the hierarchical levels are shown in the SOI display as “VIP Level X.” The SOI display shows an end user or retailer with a Level 1 hierarchy visualizes users of its own level (level 1) or those of lower levels such as level 2 and 3. This type of filtering provides a way to subcategorized or to pre-qualification and filtering other objects in the AOI.

The hierarchy level may be based on a number of factors and there may be different hierarchy levels for specific categories. Some hierarchy levels may be based on an annual fee or social/business position, and provides the ability for end user hierarchical status to be visualized and acted upon when end user is within close proximity, and allows for discreet sharing of hierarchical status and customer pre-qualification. Using that information, service providers can offer privileges or offers which are exclusive to a given hierarchical, such as jump-in-queue or reserved settings. An example that illustrates how specific privileges can be incorporated with hierarchy, is shown in FIG. 67. Specifically, FIG. 67 illustrates an example of specific privileges package (Elite, CEO/Celebrity, VIP, General Admission) associated with the particular benefits for that level, according to some embodiments.

### Specific Use Examples

Disabilities

Some embodiments of the invention pertain to be used to provide situational awareness to visually impaired, combined with interactive audio via headset, speech recognition and text-to-speech interface, typically when they maneuver in the airport.

The following functions are essential components of said service:
Audio instructions used to query information or other commands
Speech recognition converting spoken words to machine-readable input
Position and relationships output into text description
Text-to-speech interface to conduct speech instructions
Spotcast linking physical objects location to information
Spotcast providing directional information to other known locations

The system is able to use architecture of objects and information overlay to provide direction finding and interim steps for the end user.

Audio Guidance

As an example, FIG. 69 shows a visually impaired navigating himself in an airport. The scenario can be implemented in any language in which the appropriate text-to-speech and speech recognition is available. The device continuously provides information to the user, assisting him in gaining situational awareness. The following are two exemplary audio guidance instructions in English language:
Directions:
User: “Directions Gate A1”
Device: “Turn right 90 degrees, proceed straight 10 meters.”

Based on a directional request, the system can create an information overlay geometry path for the end user to traverse base on the instruction for the user turns 90 degrees and proceeds forward.

As an example of a behavior attached to the information overlay, as the user traverses the path, the device provides a periodic “beep” which frequency is synchronized to the heading direction. For example, if the user walks in the correct heading the beep would be output using a 440 Hz tone. As the user turns away from the direction, the beep tone will increase or decrease based on the difference between the user direction of travel and the intended path.

As the user traverses the path, objects may come into view. These objects may be actual physical objects or to other people. FIG. 71 illustrates the user walking from the initial point (1700) and the second point (1710) The SOI displayed is shown to the right indicating the position of the object “me” as shown (1715) The AOI has been filtered to cover a 5 meter area (1720.) This allows events which come into view within the 5 meter area to be processed by the SOI. An object within Starbuck has been hyperlinked as shown (1725.) In the initial position (1700) the Starbuck's object is farther than the 5 meter filter, and no events are generated. In the second position (1710) the Starbuck's object comes into view of the SOI and an event audio event can be generated to indicate the relative position of the object to the user.

This capability can examine the information of the object and provide relevant information to the user.

Social awareness example the device may provide the following feedback:

Device: “Immediately on your left is Abdul, copilot at United Airlines. 5 meters ahead is Stephen, VP at CISCO. You first met him last Tuesday.”

This example shows the ability to position other users around the visually impaired person. Additionally, it shows the use of the temporal database to search and find relationships between the two objects.

Asset Tracking and Protecting

Asset tracking is a methodology for one object to track the position of another object, according to an embodiment of the invention. The object doing the tracking can setup events or alarms which are triggered based on particular behavior of the object been tracked. Typical tracking applications include child, pet, laptop, keys, wallet, bag and other valuables. Additionally the technology can be combined with fence overlay in order to be used for containment or allowed/excluded zones for children, pets, elderly, mentally impaired and criminals, etc., as a way to protect concerning objects/animals/individuals.

Proximity Alert

Proximity is defined as a relative nearness of an object, animal or person to a designated area or location or to the location of another object or person. Proximity acquisition can be done via positioning with or without static positioning engines, such as Spotcasts.

Using fence overlay geometry, user can create a zone to which specific behavior can be triggered based on location and proximity of tracked objects/animal/person to said zone boundary.

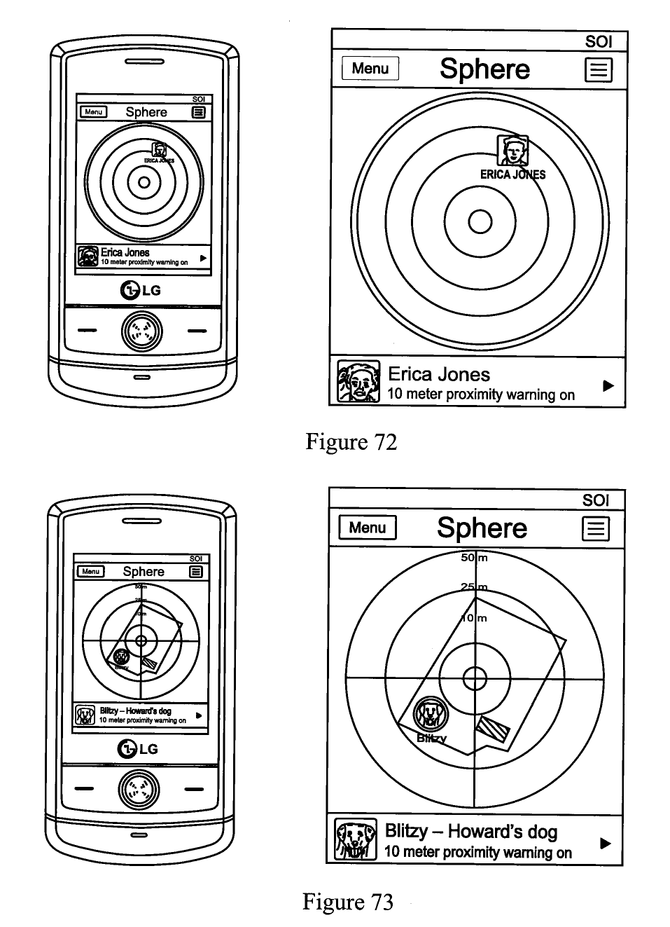

One area of such applications is asset tracking and child tracking: As shown in FIG. 72 a tag has been placed on the child named Erica Jones. Additionally a radial fence perimeter was drawn at a 10 meter range from the user of the device. In this example, Erica's trail has been enabled and overlaid to show her past location relative to the device holder.

In the event that the child moves beyond the perimeter fence, the user device may be set a behavior to alarm of the situation.

This scenario shows a fence perimeter implemented via a circular fence overlay on the display which is relative to the device holder, as shown in FIG. 79. That is to say that the vector moves with and according to the device holder location.

Similar operations can be applied in criminal areas such as restraining abusers/harassers from approaching a victim or to keep unwanted pets from trespassing.

Containment:

This methodology enables the user to create fence areas which can be linked to specific behavior to indicate when the tracked object/animal/person is within an allowed or excluded zone. Some embodiments of the invention provide the ability to visualize the target's location and the actual geometry of the specified fence and zone areas.

The behavior which is attached to the overlay may trigger sensors in a target carried device, such as a pet collar, which can be linked to the specific behavior thus encouraging the target to remain within specific allowed zones, or notify concerned individuals when target enters excluded zones.

One important application is the development of complex shapes which can be used to provide animal containment without structural changes to the property shown in FIG. 73. FIG. 73 illustrates an example of a containment structures, such as a fence overlay, and the position of a dog equipped with a tag in relation to that containment structure.

Pet Sensory Feedback

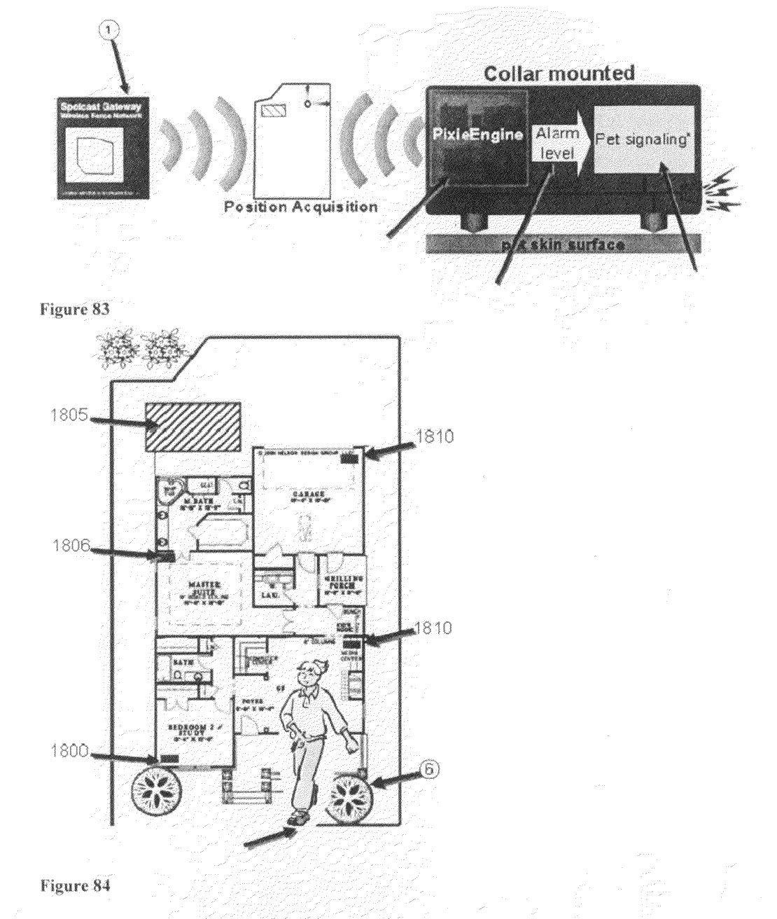

For this example a pet collar, FIG. 82, integrates an embodiment of a positioning engine to provide a translation between the triggered events and a pet sensory feedback mechanism (3000 and 3005) which can be associated with a particular pet behavior. These pet collars have been used for pet containment in the past and certain embodiments provide an innovative method to provide reliable wireless fence containment information. A pet collar may utilize vibration, audio (3005) and electric impulses (3000) to the skin (3008) to associate with specific responses. User feedback for programming, battery status and other indicators are accomplished via buttons (3010, 3015) and lights (3020, 3025). FIG. 83 shows communication between a Fence Spotcast and PixieEngine on pet collar, and process flow for event behavior activation, for an embodiment, that enables a pet behavior of staying within a boundary.

Fence Overlay Behavior

As shown in FIG. 76 Spotcast (1810, 1800) are set up to indicate a static reference position for the fence overlay. Due to the nature of wireless links, such as a 2.4 GHz frequency, used by embodiments of the system can be susceptible to signal reflections and full obscurity by objects within or around the building. This would create possible areas in which the signal may not reach at all or the signal is evaluated incorrectly giving incorrect location of the fence in relations to the object been tracked. Given that the fence overlay geometry is static around a specific Spotcast, this would create areas where the fence would not be visible or activated, or having an improper geometric shape. Hence, for implementations where higher reliability is needed, the innovation allows for a Spotcast to act as a master (1800) and additional Spotcasts which act as repeaters (1806) and overcome the inherent problem associate with reflections and obscurity by objects inside a building.

The master Spotcast (1800) carries within itself a copy of the fence geometry overlaid shown in FIG. 77. The fence overlay geometry is copied to each repeater Spotcast to maintain full coverage around the building.

Creating and Edit User Defined Fence Overlay

Numerous methods are available to create the fence overlay geometry, according to some embodiments. Since the fence geometry is to be static on a given location, the master Spotcast and associated repeaters may be located at their respective location as shown in FIGS. 76 1800 and 1806.

In this example illustrated in FIG. 74, the user creates a fence overlay geometry by first enabling a fence geometry programming mode in the pet collar or other device including a positioning engine. Then while holding the pet collar, the user walks the line which corresponds to the fence geometry to be set around the building.

As discussed above, defined allowed/excluded zones may contain multiple segments allowing for a complex shape. An example is shown in FIG. 81 where excluded zones are within an allowed zone area. In addition, allowed/excluded zones can also have a functioning height which enables applications engaging this positional attribute. As illustrated in FIG. 100, outdoor excluded zones are attributed to functioning height as the signal can reach, while in FIG. 101, an indoor excluded zone functions within a preset height range controlled by the end users. In this pet containment application, such excluded zone can represent a bedroom or baby nursery where pet entry is not desired.

Height acquisition has been discussed in above. For better coverage, a fifth Spotcast is placed on the second floor whose height (such as 3.5 m above ground) is automatically computed or manually input by the end user, hence its relative 3-D position to the initial 4 Spotcasts. Per the 3-D positioning algorithm, user created fence overlay geometries are then computed in the 3-D structured network composed by the 5 Spotcasts. End user is enabled to assign excluded zone types to said detected geometries, each has an attached height attribute.

Excluded zone 1 and 2 are programmed to function from to its fullest vertical height range. Due to the signal absorption, by ground and earth objects in certain embodiments, the lowest height is set as the ground level (Om height) to the maximum vertical reach of signals. Zone 3 1900 type height is programmable by factory or user defined height range. In this example, the Zone 3 1900 height is set to 3 meters in order to adequately cover a pet zone within a single floor. By providing a 1 meter area below the floor marked as 1 adequate coverage can be created with an anticipated error associated by the user creating the fence geometry. The fence geometry is created by the user when he walks the collar at about 1 m height around the perimeter area.

Other methods such as setting up radius encircling a fenced area has been applied in child tracking services discussed in previous section. FIG. 79 shows such defined circular safe area as 1850.

Modification function discussed above allows end user to visualize and edit the returned fence overlay geometry, either manually or programmatically. Said function enables end users to confirm their customized fence geometry and eliminate multi-path or sensor error undetected otherwise.

Activating Fence Overlay Behavior

In this pet containment example, the pet wearing a collar similar to the one shown in FIG. 82 is activated based on events associated with the fence overlay geometry created as shown in FIG. 77. In this example, the pet is shown in the location marked by 1960. Some embodiments compute the distances from the fence as shown in 1961 and enable the associated event behavior. The fence geometry overlay includes irregular areas as those shown in 1965 as well as inner areas which are marked as unsafe as shown in 1970.

Static Event Activation

Certain embodiments involving a pet collar establishes position and proximity from fence overlay geometry as shown in FIG. 77 and by which an associated behavior is established. A simple alarm indicating the pet is inside or outside a safe zone can be triggered, with increased alarm levels as the pet approaches fence overlay. This multi-level alarm can be associated to audio signaling, vibration and multi-level electric stimulation.

This association can provide a static response based on a given distance. For example:

| Object Distance to | |
|---|---|
| Fence Overlay Line | Event Generated |
| 5 meters | audio signal is generated |
| 4 meters | audio signal + collar vibration |
| 3 meters | audio signal + light electric stimulation |
| 2 meters | audio signal + medium electric stimulation |
| 1 meters | audio signal + strong electric stimulation |
| unsafe zone | audio signal + strong electric stimulation |

When an event is activated, an object can be configured to send an alert or message to a remote device. For example in FIG. 89, a Spotcast (1300) is installed in a building room (1301) is connected to a computer or Internet gateway (1305) which provides connectivity to the Internet (1310). When pet crosses the allowed boundary, a message is sent from the Spotcast to a gateway server (1315) which transmits the message over communication link (60) to the appropriate remote party (1320) or parties utilizing the programmed communication protocols.

The system can also be implemented to monitor restrained criminals, the elderly or mentally impaired at their residences, whose entry upon excluded zone will automatically stimulate alert messages sent to the police or care providers. Similarly, amusement parks equipped with adequate system would help notify parents or guardian when their monitored children wander away from the allowed area.

Behavioral Feedback Event Activation

Pet containment is a practical example where the pet activity level directly affects the events triggered as described herein in certain embodiments. When pet is within the allowed zone and different types of excluded zones, alarm triggering zone can be programmed utilize the behavioral feedback provided by the pet worn collar. Said behavioral feedback is appropriately determined based on the movement type, location and velocity of the pet which triggers the appropriate response

Allowed Zone Event Activation

FIG. 86 displays four scenarios of a dog in the allowed zone:
Scenario 1: 4001, resting dog away from the excluded zone (4010)
Scenario 2: 4005, dog-walking towards the excluded zone marked by line (4012)
Scenario 3: 4006, dog running towards the excluded zone marked by line (4012)
Scenario 4: 4008, dog sprinting towards the excluded zone marked by line (4012)

Each of these scenarios trigger a different response which can appropriately provide the right signal timing for the pet in order to keep the pet within the allowed zone.

For this example, FIG. 86 shows 4 alarm levels: “A” indicates audio and three electric stimulation levels from low to high marked as L1 through L3 respectively. A relative distance mark is shown for each scenario marked by 4030. For this example, these represent programmable distances where each segment may represent 5 meter or 2 meter distances.

Based on each scenario, a specific behavior may be programmed and activated such as:
Scenario 1: unit enters battery saving mode;
Scenario 2: alarm trigger is set to normal range mode and events will only be trigger within the last distance segment closest to the excluded zone marked by line (4012);
Scenario 3: alarm trigger is set to medium range mode where the triggering range is increased to twice the original size; and
Scenario 4: alarm trigger is set to long range mode where the triggering range is increased to three times the original size.

Utilizing this behavioral feedback technique the appropriate feedback is given to the pet with enough time to reinforce the expected behavior which in this case is not to enter the excluded zone.

Certain embodiments monitor the balance and mobility disordered group, such as the elderly population, to whom incidence of falls are associated with serious health problems. Detection of “falls” is accomplished either through the motion sensor or positioning, which triggers alarm or notification to care providers so as to secure availability of immediate health aid.

Excluded Zone 1 Event Activation

When the object is already inside the excluded zone which represents the outer boundary as represented by 1866 in FIG. 81, alarm triggering zone may need to meet unique objectives such as helping the dog navigate back to allowed zone. In this case, specific object characteristics may be programmed to provide the desired results. Certain embodiments provide the ability to program circumstances inside or outside the excluded zones.

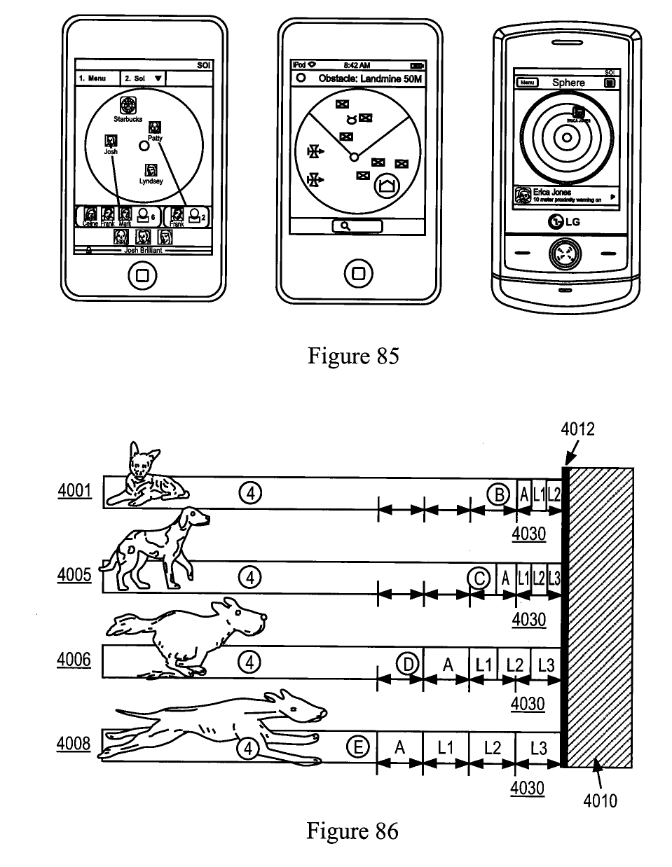

FIG. 87 displays three scenarios of a dog in the excluded zone:
Scenario 1: 5001, resting dog in the excluded zone (5002)
Scenario 2: 5005, dog moving in the excluded zone towards the allowed zone marked by line (ID 3)
Scenario 3: 5010, dog moving in the excluded zone away from the allowed zone marked by line (5015)

Each of these scenarios trigger a different response which can appropriately provide the right signal to the pet in order to encourage the pet back to the allowed zone (5020).

For this example, FIG. 87 shows 4 alarm levels: “A” indicates audio (5021) and three electric stimulation levels from low to high marked as L1 through L3 respectively. In addition, the events may pause for a period of time to allow a rest period for the pet as indicated by the “P” in 5023. Since the pet is already inside the excluded zone, the relative distance to the allowed zone is not considered in this particular behavioral feedback event activation. However if appropriate, other factors including distance could be integrated into the process. Based on each scenario, a specific behavior may be programmed and activated such as:

Scenario 1: audio alarm (5021)+medium level electric stimulation level (5022)

Scenario 2: audio alarm (5021)+low level electric stimulation level (5025)

Scenario 3: audio alarm (5021)+high level electric stimulation level (5028)

This process may be applied through periodic intervals which may then pause for a period of time “P” to allow the pet to rest while not attaining the desired behavior.

Excluded Zone 2 and 3 Event Activation

When the pet is already inside an excluded zone surrounded by an allowed zone as represented by ID 3 in FIG. 81 and FIG. 80 or indicated in FIG. 101, different events from the previous section are designed to achieve the same goal, which is encourage the dog navigate back to the allowed zone surrounding it.

FIG. 88 displays two scenarios of a dog in the excluded zone:
Scenario 1: 6000, resting dog in the excluded zone (6010)
Scenario 2: 6015, dog moving in the excluded zone towards the allowed zone (6020)

Each of these scenarios trigger a different response which can appropriately provide the right signal to the pet in order to encourage the pet back to the allowed zone (ID 1).

For this example, FIG. 88 shows 3 alarm levels: “A” indicates audio (6025) and two electric stimulation levels from low to high marked as L1, L2 respectively. In addition, the events may pause for a period of time to allow a rest period for the pet as indicated by the “P” in 6030. As discussed in previous section, the relative distance to the allowed zone is not considered considering pet is already in excluded zone, but such factor will be taken into account when appropriate.

Based on each scenario, a specific behavior may be programmed and activated such as:

Scenario 1: audio alarm (6025)+medium level electric stimulation level (6035)

Scenario 2: audio alarm (6025)+low level electric stimulation level (6040)

Pause for a period of time “P” is set for the same reason as discussed previous section.

Fence Overlay Geometry Modifications

Certain embodiments allow for the fence overlay geometry to be created or edited manually or programmatically. FIG. 90 provides an example on how to create or edit the fence overlay geometry with a device such as a computer (2000) or another user device connected to the Spotcast (2007) which can then access the memory area for the geometry information. The data may be create or edited via a software application (2005) which provides a visual representation of the geometry or programmatically.

Certain embodiments of the invention provides a method to create complex geometric fences using an all wireless solution, visualize said fence and track a pet, and remedies false positives by creating an architecture which minimizes multi-path reflections, obscured areas and measurement of errors. The system is easy to set up and reprogram to the extent which allows the system to be used in portable situations when a containment area needs to be created at a different location which brings increased user convenience.

Summary of Benefits:
multiple transmitters can auto configure in and around the building area eliminating signal errors from building objects
sensors within the pet collar provide movement indications which help in improving battery life and remove error caused by multi-path effect, reflections or erroneous data.
event alarms set with pet activity feedback can provide a consistent message to the pet of the fence boundaries
pet activity feedback event alarms operating within the excluded zone encourages the pet to return to the designated allowed zone
the ability to provide messages to the user via text messaging or email provides an assurance that pet is within the confined area
the ability to visualize the zone areas provides the user a positive way to confirm the fence overlay geometry allowed zones and gives the ability edit to meet current and future needs
simple set up process enables users to easily access and upgrade their containment area
portability allows users to carry the system and recreate the fencing service when they travel, for example in a vacation home.

Active Information Display

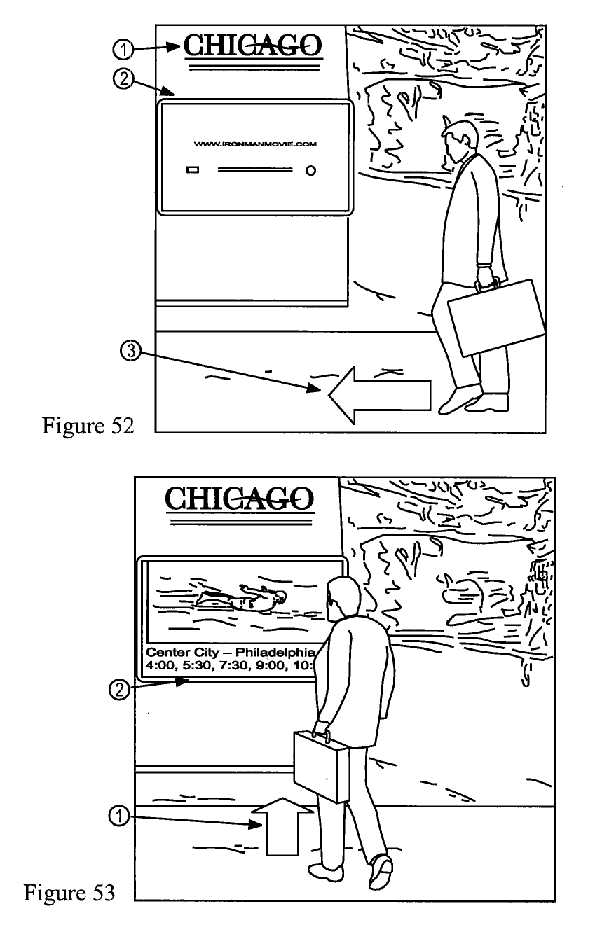

This example in FIG. 52 shows an active display changing its contents as it senses another object approaching. In this example, the person walking is using certain embodiments that have integrated social profile information. The display object can access the information the user has selected to provide publicly or specifically accessible to the display object. The display object can use this information to create a custom view of the information provided to the user.

Initially the person walking is not moving towards the particular active display. However in FIG. 53 it shows the person attention directed towards the display. The PixieEngine in the active display can detect direction and orientation of the incoming object to determine the field of attention from the user. The active display can then show the targeted information at that time. In this example, the display provides movie time information for the end user's home location of Philadelphia.

When multiple users are present, the display may utilize a queue and sorting algorithm to provide the information utilizing a priority algorithm. Such algorithm may be first come first serve or may be connected to the hierarchical or social profile information embedded in the user's positioning engine, such as a PixieEngine.

The active display can access the following data items:

User unique ID

User approaching

Direction of attention

Public profile information

User opt-in applications

User opt-in applications are applications which provide additional information above the social profile. In this particular example, an opt-in example would be the user having a movie preference data base within his PixieEngine of which the active display can access the information. By doing so the active display can further provide information which is of direct interest to the user.

What is claimed:

1. A method comprising:
receiving a wireless signal from at least one object of a plurality of objects in an area of influence;
determining relative position information associated with the at least one object based on the received wireless signal, wherein the relative position information includes object information attributes.

2. The method of claim 1, further comprising integrating sensor data associated with the at least one object or with of the plurality of objects in the area of influence.

3. The method of claim 1, further comprising using the object information attributes to access either embedded information or remote information associated with at least one of:
the at least one object; and
one or more of the plurality of objects.

4. The method of claim 2, wherein sensor data comprises: range, orientation, and vector of movement, corresponding to the at least one object or to one or more of the plurality of objects.

5. The method of claim 1, further comprising capturing events and event information associated with the plurality of objects in response to receiving the wireless signal.

6. The method of claim 1, further comprising linking respective object information corresponding to at least a subset of the plurality of objects.

7. The method of claim 1, further comprising attaching a reference link to at least a subset of the plurality of objects, wherein the reference link is operable for accessing object information comprising: text, image data, web pages, applications, audio information, video information, and social information.

8. The method of claim 1, further comprising determining relationships amongst objects of at least a subset of the plurality of objects and virtual objects that are outside the area of influence by searching and matching such objects that satisfy a predetermined set of criteria.

9. A positioning engine comprising:
a plurality of sensors to monitor position information of a first device;
a filter to receive position information from at least a second device; and
a position filter to determine a position relative to said second device based on the position information of the first device and a reference signal from the second device.

10. The positioning engine of claim 9 wherein the plurality of sensors includes one or more of a range sensor, an acceleration sensor, and a magnetic sensor.

11. A device to obtain local topology comprising:
a sensor to provide position information;
a position acquisition component to determine a position relative to an object based on the position information from the sensor; and
a track file database to store position information relative to the object.

12. The device to obtain local topology of claim 11, wherein the track file database stores relationship information.

13. The device to obtain local topology of claim 11, further comprising a sensor migration bridge to receive position information from the object.

14. A method comprising:
receiving, at a first object, a wireless signal from a second object of plurality of objects in an area of influence; and
determining relative position information associated with the second object, wherein the relative position information includes at least one of:
first information that is directly related to attributes of the second object;
second information that is directly related to attributes of a third object, wherein the third object is outside the area of influence;
third information that is directly related to a first environment surrounding the second object;
fourth information that is directly related to a second environment surrounding the third object; and
fifth information that illustrates the relationship between the first object and the second object.

15. The method of claim 14, further comprising displaying interactive graphical representations of the relative position information, the first object, the second object, and the third object through an interactive user interface associated with the first object.

16. The method of claim 14, wherein relative position information includes at least one of:
sixth information having a static attribute, wherein the sixth information is information placed at a static location;
seventh information having a relative attribute, wherein the seventh information moves with a corresponding object; and
eighth information having a programmatic attribute, wherein the eighth information is dynamically changeable based on an external positioning methodology;

17. The method of claim 14, further comprising sharing information between the plurality of objects and displaying the shared information as an information overlay on corresponding displays of the respective devices.

18. The method of claim 14, wherein at least one of the first object, the second object, and the third object is static relative to the other objects.

19. A method comprising:
determining relative position information at a first device relative to a plurality of objects in an area of interest based on at least one of:
respective object information attributes corresponding to the plurality of objects; and
respective sensor data corresponding to the plurality of objects;

20. The method of claim 19, further comprising defining one or more excluded zones and indicating when the device enters any one of the one or more excluded zones.

21. The method of claim 19, further comprising receiving advertisements from one or more objects of the plurality of objects.

22. The method of claim 19, further comprising receiving reference links associated with the advertisements, wherein the reference links to enable a user of the device to participate in activities including purchasing, bidding and bartering of products and services associated with the advertisements.
